(19) United States
(12) Patent Application Publication
(10) Pub. No.: US 2009/0138714 A1
(43) Pub. Date: May 28, 2009

(54) COMMUNICATION APPARATUS, KEY SERVER, MANAGEMENT SERVER, COMMUNICATION SERVER, CONTENT DISTRIBUTION SYSTEM, COMMUNICATION METHOD, AND RECORDING MEDIUM

(75) Inventors: Tatsuyuki MATSUSHITA, Tokyo (JP); Ryuiti Koike, Tokyo (JP); Hideki Matsumoto, Kanagawa (JP); Kentaro Umesawa, Kanagawa (JP); Taku Kato, Kanagawa (JP); Haruhiko Toyama, Kanagawa (JP); Hideaki Sato, Kanagawa (JP); Toru Kambayashi, Kanagawa (JP); Satoshi Ito, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/276,835

(22) Filed: Nov. 24, 2008

(30) Foreign Application Priority Data
Nov. 26, 2007 (JP) 2007-305141
Jul. 11, 2008 (JP) 2008-181884

(51) Int. Cl. H04L 9/00

(52) U.S. Cl. 713/171

(57) ABSTRACT

A plurality of first encrypted pieces is generated by encrypting the pieces with a first encryption key. The second encrypted piece is generated by encrypting at least one of the pieces with a second encryption key. The first encryption key and the second encryption key for encrypting the same piece are different from each other. A communication apparatus receives a first encrypted piece or a second encrypted piece from other communication apparatus for each piece, transmits a request message for requesting a decryption key for decrypting the encrypted piece to a key server, and receives the decryption key from the key server in response to the request message.

### CROSS-REFERENCE TO RELATED APPLICATIONS

This application is based upon and claims the benefit of priority from the prior Japanese Patent Application No. 2007-305141, filed on Nov. 26, 2007; and Japanese Patent Application No. 2008-181884, filed on Jul. 11, 2008, the entire contents of both of which are incorporated herein by reference.

### BACKGROUND OF THE INVENTION

1. Field of the Invention

The present invention relates to a communication apparatus that receives an encrypted content encrypted with an encryption key from other communication apparatus, a key server that transmits a decryption key for decrypting the encrypted content, a management server that stores therein information used when the communication apparatus accesses other communication apparatus, a communication server, a content distribution system, a communication method, and a computer-readable recording medium.

2. Description of the Related Art

Generally speaking, systems used for distributing contents include “single server” systems and “distributed server” systems. In a single-server system, for example, one content server is connected to a license server and clients via a network so that content is distributed from the content server to each of the clients. The distributed content is encrypted, and key information related to the encryption process is stored in the license server. The content server stores the content therein as E(KT)[C]. In this expression, “KT” is a key called a title key, whereas “C” is content in plaintext. E(KT)[C] means that “C” is encrypted with “KT”. The key information contains “KT”. A client B obtains the key information from the license server, encrypts the key information with a key KB that is unique to the client (i.e., the client B), and stores therein the encrypted key information in correspondence with the content E(KT)[C] that has been received from the content server. After that, the client B decrypts the key information with the key KB, takes out the title key KT, and decrypts the content E(KT)[C] with the title key KT. Thus, the client B is able to use the content.

In this configuration, when the client B downloads the content E(KT)[C] from the content server, the client B and the content server perform an authentication process and a key exchange process with each other. As a result, the client B shares a temporary key KtmpB with the content server. The content server encrypts the content E(KT)[C] with the temporary key KtmpB and transmits content E(KtmpB)[E(KT)[C]] to the client B. The client B decrypts the content E(KtmpB)[E(KT)[C]] with the temporary key KtmpB that the client B shares with the content server as a result of the authentication and the key exchange processes described above and takes out E(KT)[C]. In this configuration, even if the encrypted content E(KtmpB)[E(KT)[C]] is illegitimately read on a path in the network, it is not possible to decrypt the illegitimately read content unless the temporary key KtmpB is available. In other words, the content is encrypted with the temporary key that is different for each of the clients, so that the content is individualized for each of the clients. As a result, it is possible to inhibit illegitimate use of the content. For example, by configuring a temporary key KtmpA for a client A and the temporary key KtmpB for the client B so as to be different from each other, content E(KtmpA)[E(KT)[C]] distributed to the client A and the content E(KtmpB)[E(KT)[C]] distributed to the client B are mutually different individual pieces of data. By individualizing the content with the mutually different encryption keys in this manner, it is possible to inhibit illegitimate use of the content.

In a single-server system, however, because the communication is performed between each of the clients and the content server in a one-to-one manner, when a large number of clients try to receive the distribution of content from the content server, a problem arises where the level of distribution efficiency is lowered.

On the other hand, examples of the distributed-server systems include a content distribution system called BitTorrent that uses a peer-to-peer (P2P) network (see, for example, BitTorrent Protocol Specification v. 1.0). In this system, a tracker that is different for each of the contents, a seeder, and a leecher are connect to one another by using the P2P network. Also, each of the distributed contents is divided into a plurality of pieces. The seeder is a node that distributes the pieces constituting content for distributing (i.e., uploading) the content. The leecher is a node that receives the pieces constituting the content and distributes the pieces constituting the content for the purpose of receiving (i.e., downloading) the content. In other words, a leecher may become a seeder when the leecher has obtained a certain number of pieces that constitute the content. Thus, some of the seeders have become a seeder after they, as a leecher, have received a part or all of the pieces that constitute content, and other seeders are each a seeder (from the beginning) that is provided on the system side (in advance or during a distribution). The latter type of seeders will be referred to as initial seeders. An initial seeder stores therein a part or all of the pieces that constitute one content. In the explanation below, a “seeder” denotes either a seeder or an initial seeder, unless stated otherwise. A node denotes one of a leecher, a seeder, and an initial seeder. A tracker stores therein node information related to each of the nodes. When a leecher has accessed the tracker, the tracker provides the node information for the leecher.

In this configuration, when a leecher is to receive a distribution of content, the leecher first obtains information called a Torrent File. The Torrent File is, for example, given from a server (hereinafter, a “sales server”) offering a service of selling contents to content providers or users, to another node or another sales server, and is further given by the other node or the other sales server to a leecher. Alternatively, another arrangement is acceptable in which the Torrent File is recorded on a recording medium like a Compact Disk Read-Only Memory (CD-ROM) and distributed offline to a leecher. The Torrent File stores therein tracker information related to the content and file information of the content. The tracker information contains a connection destination of the tracker. The file information contains, for example, hash information of the pieces that constitute the content. The hash information is used for checking the completeness of the pieces. In other words, the hash information is used for calculating hash values of the pieces downloaded by the leecher, comparing the calculated hash values with hash values of the pieces in the hash information, and checking to see if the received pieces have not been tampered.

When having obtained the Torrent File, the leecher connects to the tracker based on the tracker information. The tracker transmits the node information described above to the leecher. The node information contains a list of connection destinations of one or more nodes. The leecher connects to a plurality of nodes, based on the node information. As for the pieces distributed by the nodes, it is often the case that the pieces are mutually different for each of the nodes. Because the leecher is able to receive the mutually different pieces from the plurality of nodes, the leecher is able to receive the content at a high speed.

As explained above, in such a content distribution system that uses a P2P network, the content is stored as being distributed in the plurality of nodes. Thus, in such a system, even if a large number of nodes try to receive the content, each of the nodes is able to receive the content from the plurality of other nodes via the P2P network. Thus, P2P content distribution systems have a higher level of distribution efficiency than single-server systems.

Japanese Patent No. 3917395 discloses a content distributing method by which content is divided into a plurality of pieces and, for each of the pieces, a plurality of encrypted pieces are generated by encrypting the piece with a plurality of encryption keys.

In a content distribution system like the one described in the BitTorrent Protocol Specification v. 1.0 where it is possible to distribute content through a plurality of nodes, it is also desirable to protect the distributed content with an encryption process so that it is possible to inhibit illegitimate use of the content. In such a content distribution system, however, encrypted contents that are received by mutually different leechers must be the same for all the leechers, unlike in a single-server system. Thus, it is difficult to distribute an individually encrypted content to each of the leechers. Consequently, if one key that is used for decrypting the encrypted content is disclosed, there is a possibility that it may become possible to decrypt all of the large number of the same encrypted contents that are present in the network.

The content distributing method disclosed in Japanese Patent No. 3917395 requires that each of the users who are to receive the distribution of the content should obtain all the encrypted pieces. Thus, when this content distributing method is applied to a P2P content distribution system without any modification, there is a possibility that the level of distribution efficiency may be lowered. Further, even if there is a plurality of keys used for decrypting the encrypted content, if the keys are disclosed, there is a possibility that it may become possible to decrypt the content without having to legitimately obtain the decryption keys.

### SUMMARY OF THE INVENTION

According to one aspect of the present invention, there is provided a communication apparatus that receives a plurality of pieces constituting a part of content. A plurality of first encrypted pieces is generated by encrypting the pieces with a first encryption key. A second encrypted piece is generated by encrypting at least one of the pieces with a second encryption key. The first encryption key and the second encryption key for encrypting a same piece are different from each other. The communication apparatus includes a content receiving unit that receives either one of the first encrypted piece and the second encrypted piece from other communication apparatus for each of the pieces; a key request transmitting unit that transmits a request message for requesting a decryption key for decrypting the either one of the first encrypted piece and the second encrypted piece to a key server; and a key receiving unit that receives the decryption key from the key server in response to the request message.

Furthermore, according to another aspect of the present invention, there is provided a communication apparatus that receives a plurality of pieces constituting a part of content. A plurality of first encrypted pieces is generated by encrypting the pieces with a first encryption key. A second encrypted piece is generated by encrypting at least one of the pieces with a second encryption key. The first encryption key and the second encryption key for encrypting a same piece are different from each other. The communication apparatus includes a storage unit that stores therein either one of the first encrypted piece and the second encrypted piece for each of the pieces; a request receiving unit that receives a piece request for requesting all or a part of data of the either one of the first encrypted piece and the second encrypted piece from other communication apparatus; and a transmitting unit that transmits the all or the part of the data requested in the piece request to the other communication apparatus.

Moreover, according to still another aspect of the present invention, there is provided a key server that communicates with a communication apparatus that receives a plurality of pieces constituting a part of content. A plurality of first encrypted pieces is generated by encrypting the pieces with a first encryption key. A second encrypted piece is generated by encrypting at least one of the pieces with a second encryption key. The first encryption key and the second encryption key for encrypting a same piece are different from each other. The communication apparatus receives either one of the first encrypted piece and the second encrypted piece from other communication apparatus for each of the pieces. The key server includes a receiving unit that receives a request message for requesting a decryption key for decrypting the either one of the first encrypted piece and the second encrypted piece for each of the pieces from the communication apparatus; a first storage unit that stores therein the decryption key; a determining unit that determines whether to transmit the decryption key based on a combination of decryption keys requested in the request message; and a key transmitting unit that, when the determining unit determines to transmit the decryption key, reads decryption keys in the combination requested in the request message from the first storage unit, and transmits the decryption keys to the communication apparatus.

Furthermore, according to still another aspect of the present invention, there is provided a management server that communicates with a communication apparatus that receives a plurality of pieces constituting a part of content. A plurality of first encrypted pieces is generated by encrypting the pieces with a first encryption key. A second encrypted piece is generated by encrypting at least one of the pieces with a second encryption key. The first encryption key and the second encryption key for encrypting a same piece are different from each other. The communication apparatus receives either one of the first encrypted piece and the second encrypted piece from other communication apparatus for each of the pieces. The management server includes a first storage unit that stores therein connection destination information for accessing the other communication apparatus; a selecting unit that selects the either one of the first encrypted piece and the second encrypted piece obtained by encrypting at least one of the pieces; and a transmitting unit that reads the connection destination information from the first storage unit, and transmits the connection destination information and seeder information specifying selected either one of the first encrypted piece and the second encrypted piece to the communication apparatus.

Moreover, according to still another aspect of the present invention, there is provided a communication apparatus that receives a plurality of pieces constituting a part of content. A plurality of first encrypted pieces is generated by encrypting the pieces with a first encryption key. A second encrypted piece is generated by encrypting at least one of the pieces with a second encryption key. A third encrypted piece is generated by encrypting at least one of the pieces with a third encryption key. The first encryption key, the second encryption key, and the third encryption key for encrypting a same piece are different from one another. The communication apparatus receives either one of the first encrypted piece and the second encrypted piece from other communication apparatus for each of the pieces. The communication server includes a first storage unit that stores therein the third encrypted piece; a second storage unit that, when the third encrypted piece is transmitted to the communication apparatus, stores therein identification information for identifying the communication apparatus; a first receiving unit that receives a special piece request for requesting the third encrypted piece and contains the identification information for identifying the communication apparatus from the communication apparatus; and a first transmitting unit that, when the identification information contained in the special piece request is not stored in the second storage unit, reads the third encrypted piece from the first storage unit, and transmits the third encrypted piece to the communication apparatus.

Furthermore, according to still another aspect of the present invention, there is provided a computer-readable recording medium that stores therein a computer program for a communication apparatus that receives a plurality of pieces constituting a part of content. A plurality of first encrypted pieces is generated by encrypting the pieces with a first encryption key. A second encrypted piece is generated by encrypting at least one of the pieces with a second encryption key. The first encryption key and the second encryption key for encrypting a same piece are different from each other. The computer program when executed causes a computer to execute receiving either one of a first encrypted piece and a second encrypted piece from other communication apparatus for each of the pieces; transmitting a request message for requesting a decryption key for decrypting the either one of the first encrypted piece and the second encrypted piece to a key server; and receiving the decryption key from the key server in response to the request message.

### BRIEF DESCRIPTION OF THE DRAWINGS

FIG. 1 is a block diagram of a content distribution system according to a first embodiment of the present invention;

FIG. 2 is a schematic drawing for explaining how content is divided into a plurality of pieces;

FIG. 3 is a schematic drawing of encrypted pieces;

FIG. 4 is a drawing of an example of encrypted pieces stored in a seeder;

FIG. 5 is a drawing of another example of the encrypted pieces stored in the seeder;

FIG. 6 is a drawing of yet another example of the encrypted pieces stored in the seeder;

FIG. 7 is a drawing of an example of a data structure of piece information;

FIG. 8 is an exemplary functional diagram of a leecher;

FIG. 9 is a drawing of an example of a Torrent File;

FIG. 10 is an exemplary functional diagram of a key server;

FIG. 11 is a drawing of an example of a data structure of node information;

FIG. 12 is a flowchart of a procedure in a content distributing process;

FIG. 13 is a flowchart of a procedure in a comparing process;

FIG. 14 is a drawing of an example of a data structure of a Torrent File according to a modification example of the first embodiment;

FIG. 15 is a drawing of an example of index information that contains hash values, according to another modification example of the first embodiment;

FIG. 16 is a flowchart of a procedure in a comparing process according to another modification example of the first embodiment;

FIG. 17 is a functional block diagram of a tracker according to a second embodiment of the present invention;

FIG. 18 is a drawing of an example of a data structure of a seeder database;

FIG. 19 is a drawing of an example of seeder information;

FIG. 20 is a flowchart of a content distributing process;

FIG. 21 is a flowchart of a procedure in an index generating process;

FIG. 22 is a drawing of an example of seeder information;

FIG. 23 is a drawing of an example of seeder information according to a modification example of the second embodiment;

FIG. 24 is a drawing of an example of seeder information according to another modification example of the second embodiment;

FIG. 25 is a drawing of an example of seeder information that contains hash values but does not contain connection destination information, according to another modification example of the second embodiment;

FIG. 26 is a flowchart of a procedure in an index generating process according to another modification example of the second embodiment;

FIG. 27 is a flowchart of a procedure in a comparing process according to a third embodiment of the present invention;

FIG. 28 is an exemplary diagram of a key server according to a modification example of the third embodiment;

FIG. 29 is a drawing of an example of a data structure of piece information according to a fourth embodiment of the present invention;

FIG. 30 is a flowchart of a procedure in a content distributing process according to the fourth embodiment;

FIG. 31 is a drawing of an example of a data structure of piece information according to a modification example of the fourth embodiment;

FIG. 32 is a drawing of an example of a data structure of the piece information according to another modification example of the fourth embodiment;

FIG. 33 is a flowchart of a procedure in a content distributing process according to yet another modification example of the fourth embodiment;

FIG. 34 is a flowchart of a procedure in a content distributing process according to yet another modification example of the fourth embodiment;

FIG. 35 is a flowchart of a procedure in a content distributing process according to yet another modification example of the fourth embodiment;

FIG. 36 is a flowchart of a procedure in a content distributing process according to yet another modification example of the fourth embodiment;

FIG. 37 is an exemplary functional diagram of the leecher according to a fifth embodiment of the present invention;

FIG. 38 is a drawing of an example of a data structure of a piece request according to the fifth embodiment;

FIG. 39 is a flowchart of a procedure in a content distributing process according to the fifth embodiment;

FIG. 40 is a flowchart of a detailed procedure in a downloading process and an uploading process according to the fifth embodiment;

FIG. 41 is an exemplary functional diagram of a seeder according to a modification example of the fifth embodiment;

FIG. 42 is a diagram of a content distribution system according to a sixth embodiment of the present invention;

FIG. 43 is a drawing of an example of circulated encrypted pieces and uncirculated encrypted pieces according to the sixth embodiment;

FIG. 44 is an exemplary functional diagram of a residual server according to the sixth embodiment;

FIG. 45 is a flowchart of a procedure in a content distributing process according to the sixth embodiment; and

FIG. 46 is flowchart of a procedure in a comparing process performed by the residual server according to the sixth embodiment.

### DETAILED DESCRIPTION OF THE INVENTION

Exemplary embodiments of the present invention will be explained in detail below with reference to the accompanying drawings.

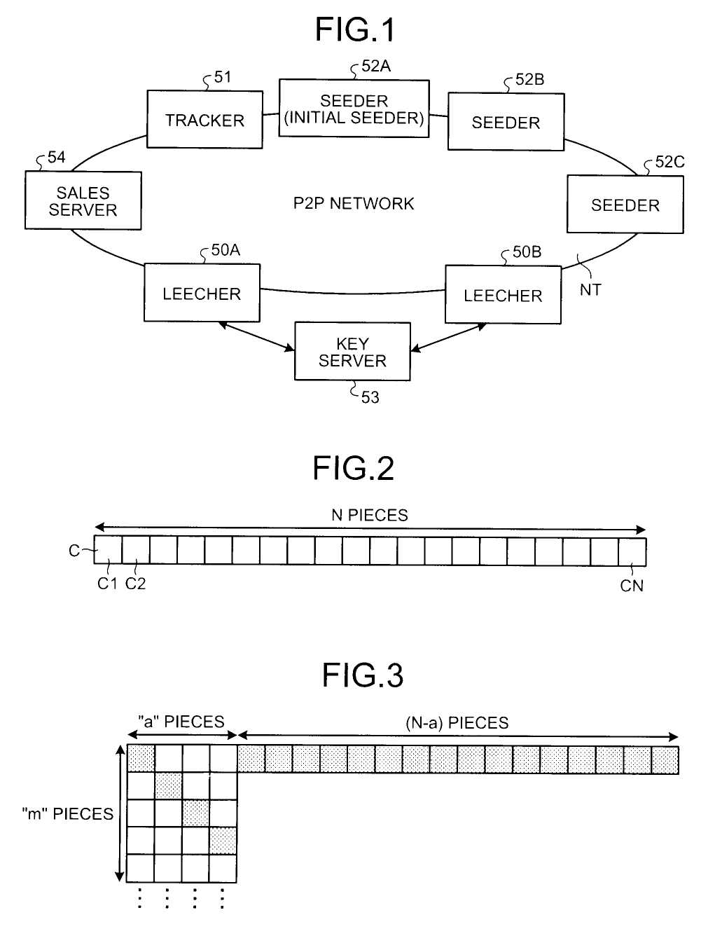

FIG. 1 is a block diagram of a content distribution system according to a first embodiment of the present invention. In the content distribution system according to the first embodiment, leechers 50A, 50B, a tracker 51, seeders 52A, 52B, 52C, and a sales server 54 are connected together via a P2P network NT. Each of the leechers 50A and 50B is connected to a key server 53 via a network like the Internet (not shown). In this situation, each of the leechers 50A and 50B and the seeders 52A, 52B, and 52C is a node. Each of the seeders 52A, 52B, and 52C stores therein encrypted pieces obtained by encrypting a plurality of pieces into which content has been divided, with mutually different encryption keys. In the following explanation, content that is constituted with such encrypted pieces will be referred to as an encrypted content. The details of such an encrypted content will be explained later. Of the seeders 52A, 52B, and 52C, the seeder 52A functions as an initial seeder, which is explained above. The seeder 52A stores therein all of the encrypted pieces that have been generated by encrypting each of the pieces constituting the one content by using a plurality of encryption keys per piece. The tracker 51 store therein node information used for accessing each of the nodes. It is assumed that a piece of node identification information is assigned to each of the nodes. Each piece of node identification information is information that uniquely identifies the node and may be, for example, an IP address of the node. The key server 53 stores therein decryption keys used for decrypting the encrypted pieces. The sales server 54 stores therein a Torrent File.

The leecher 50A receives the Torrent File from the sales server 54, obtains the node information by accessing the tracker 51 based on the Torrent File, receives the decrypted pieces by accessing at least one of the seeders 52A, 52B, 52C, and the leecher SOB based on the obtained node information, obtains all the encrypted pieces corresponding to the pieces, and receives a key ring containing the decryption keys that are respectively used for decrypting the encrypted pieces from the key server 53. The leecher 50B also performs the same processes. In the following explanation, in the case where the leechers 50A and 50B do not need to be distinguished from each other, each of them will be simply referred to as the leecher 50. Similarly, in the case where the seeders 52A, 52B, and 52C do not need to be distinguished from one another, each of them will be simply referred to as the seeder 52.

Next, a configuration of the content will be explained. The content is any of various types of digital data such as moving-picture data and audio data like Moving Picture Experts Group (MPEG) 2 and MPEG 4 as well as text data and still image data. Also, data that is obtained by encrypting such digital data will be also referred to as content. For example, data that is obtained by encrypting a High Definition Digital Versatile Disk (HD DVD) prepared video content according to the Advanced Access Content System (AACS) specifications can also serve as content. In the following explanation, the entire content will be identified as “C”. The content “C” may be in plaintext or encrypted. FIG. 2 is a schematic drawing for explaining how the content is divided into a plurality of pieces. For example, one content (i.e., the content C in the present example) is divided into as many pieces as N (N>1), the pieces being identified as C1 to CN. The data lengths of the pieces C1, C2, . . . , CN may all be equal or may be different from one another. The pieces C1 to CN, the quantity of which is equal to “N”, are encrypted with mutually different encryption keys. In this situation, of the N pieces, each of as many pieces as “a” is encrypted by using as many mutually different encryption keys as “m” (e.g., a first encryption key and a second encryption key) per piece. Each of the remaining pieces, the quantity of which is equal to “N−a”, is encrypted by using one encryption key (i.e., the first encryption key) per piece. In other words, as for each of some of the pieces the quantity of which is equal to “a”, the piece is encrypted with the mutually different encryption keys the quantity of which is equal to “m”, so that the mutually different pieces (i.e., the encrypted pieces) the quantity of which is equal to “m” are generated. As for each of the other pieces the quantity of which is equal to “N−a”, the piece is encrypted with the one encryption key so that the one encrypted piece is generated for the one piece. FIG. 3 is a schematic drawing of the encrypted pieces. It is possible to individualize the entire encrypted content that is constituted with as many encrypted pieces as “N”, by differentiating the combination of encrypted pieces that is obtained by selecting one out of as many encrypted pieces as “m” for each of the pieces the quantity of which is equal to “a”.

Next, a hardware configuration of each of the apparatuses such as the leecher 50, the tracker 51, the seeder 52, and the key server 53 will be explained. Each of the apparatuses includes: a controlling device such as a Central Processing Unit (CPU) that exercises the overall control of the apparatus; storage devices such as a Read-Only Memory (ROM) and Random Access Memory (RAM) that store therein various types of data and various types of computer programs (hereinafter, “programs”); external storage devices such as a Hard Disk Drive (HDD) and a Compact Disk (CD) drive device that store therein various types of data and various types of programs; and a bus that connects these constituent elements to one another. Each of the apparatuses has a hardware configuration to which a commonly-used computer can be applied. In addition, a display device that displays information, input devices such as a keyboard and a mouse that receive inputs of instructions from the user, and a communication interface (I/F) that controls communication with external apparatuses are connected to each of the apparatuses in a wired or wireless manner.

Next, various types of functions that are realized in the hardware configuration described above when the CPU of the seeder 52 executes the various types of programs stored in the storage devices and the external storage devices will be explained. The seeder 52 stores therein the encrypted pieces that have been obtained by encrypting the plurality of pieces C1 to CN constituting the content C, in correspondence with indexes (i.e., suffixes) of the decryption keys that are used for decrypting the pieces C1 to CN, respectively. The decryption keys may be the same as the encryption keys or may be different from the encryption keys. In either situation, because the pieces C1 to CN have been encrypted with the encryption keys respectively, it is possible to identify each of the encrypted pieces by using the index of the corresponding one of the decryption keys used for decrypting the encrypted piece. These encrypted pieces are stored in, for example, an external storage device.

To simplify the explanation in the following sections, it is assumed that the encryption keys are identical to the decryption keys, respectively. In the case where the index of each decryption key is expressed as (i,j), and the decryption key is expressed as K(i,j), each encrypted piece can be expressed as below, for example:

### E(K(i,j))[Cj]

where i and j are each an integer that satisfy 1≦i≦m and 1≦j≦N (m>1); With regard to mutually different indexes (i,j) and (i′,j′) where (i,j)≠(i′,j′), K(i,j)=K(i′,j′) may be satisfied.

The encrypted content that is constituted with the encrypted pieces can be expressed as below, for example:

### {E(K(i1,1))[C1], E(K(i2,2))[C2], . . . , E(K(iN,N))[CN]}

where 1≦i1, . . . , iN≦m is satisfied.

The sequence of the encrypted pieces in the encrypted content is expressed with the combination of the indexes of the encrypted pieces and can be expressed as below, for example (In the example below, the indexes corresponding to the pieces C1 to CN are arranged in a row from the left side):

{(i1,1), (i2,2), . . . , (iN,N)}
where 1≦i1, . . . , iN≦m is satisfied.

Accordingly, what is stored in the seeder 52 while keeping the encrypted pieces in correspondence with the indexes can be expressed as below, for example:

{(E(K(i1,1))[C1],(i1,1)), E(K(i2,2))[C2],(i2,2)), . . . , E(K(iN,N))[CN],(iN,N))}
where 1≦i1, . . . , iN≦m is satisfied.

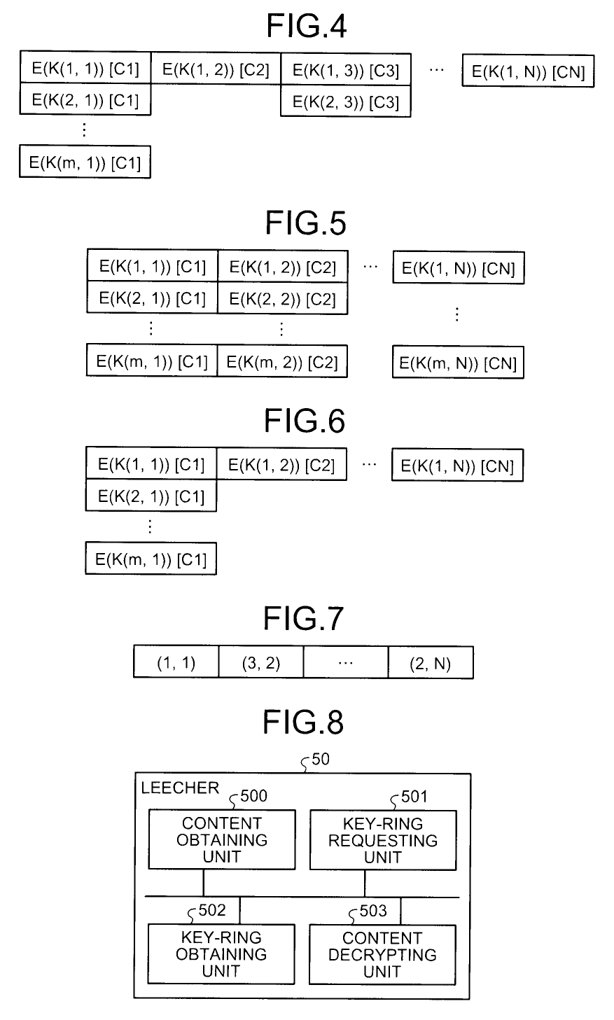

Further, the seeder 52A, which is an initial seeder, stores therein all the encrypted pieces that have been generated by encrypting each of the encrypted pieces that respectively correspond to the pieces constituting the content, by using the plurality of encryption keys per piece. FIG. 4 is a drawing of an example of the encrypted pieces stored in the seeder 52A. In FIG. 4, it is indicated that, of the N pieces, each of as many pieces as “a” (where 1<a<N) is encrypted by using the plurality of mutually different encryption keys per piece. In the example shown in FIG. 4, the number of encryption keys used for encrypting each piece is different for the different pieces. The number of encryption keys used for encrypting the piece C1 is m, whereas the number of encryption keys used for encrypting the piece C3 is two. According to the first embodiment, however, another arrangement is acceptable in which the number of encryption keys used for encrypting each piece is the same for all of the pieces. In a piece processing apparatus, with this arrangement where, of the N pieces, each of as many pieces as “a” (where 1<a<N) is encrypted by using the plurality of mutually different encryption keys per piece, it is possible to have a configuration so that, for example, the higher the level of importance is, the larger the number of encryption keys is.

The first embodiment is not limited to the example described above. For example, another arrangement is acceptable in which “a=N” is satisfied as shown in FIG. 5, so that each of all the N pieces is encrypted by using as many mutually different encryption keys as “m” per piece. With this arrangement, it is possible to increase the number of variations of the sequence of the encrypted pieces. Further, yet another arrangement is acceptable in which “a=1” is satisfied as shown in FIG. 6, so that only one of the N pieces is encrypted with as many mutually different encryption keys as “m”. With this arrangement, it is possible to improve the level of distribution efficiency.

In the configuration as described above, when being accessed by the leecher 50, the seeder 52 transmits piece information to the leecher 50, the piece information indicating the sequence of the encrypted pieces stored in the seeder 52. FIG. 7 is a drawing of an example of a data structure of the piece information. In FIG. 7, it is indicated that the encrypted piece corresponding to the piece C1 is to be decrypted with a decryption key K(1,1), whereas the encrypted piece corresponding to the piece C2 is to be decrypted with a decryption key K(3,2). In other words, the piece information indicates the correspondence relationship between the encrypted pieces and the decryption keys each of which is used for decrypting a different one of the encrypted pieces. When having received a piece request from the leecher 50 requesting an encrypted piece based on the piece information, the seeder 52 judges whether the requested encrypted piece is stored therein. In the case where the result of the judging process is in the affirmative, the seeder 52 transmits the requested encrypted piece to the leecher 50.

Next, various types of functions that are realized in the hardware configuration described above when the CPU of the leecher 50 executes the various types of programs stored in the storage devices and the external storage devices will be explained. FIG. 8 is an exemplary functional diagram of the leecher 50. The leecher 50 includes a content obtaining unit 500, a key ring requesting unit 501, a key ring obtaining unit 502, and a content decrypting unit 503. The actual substance of each of these constituent elements is generated in a storage device (e.g., the RAM) when the CPU executes the programs.

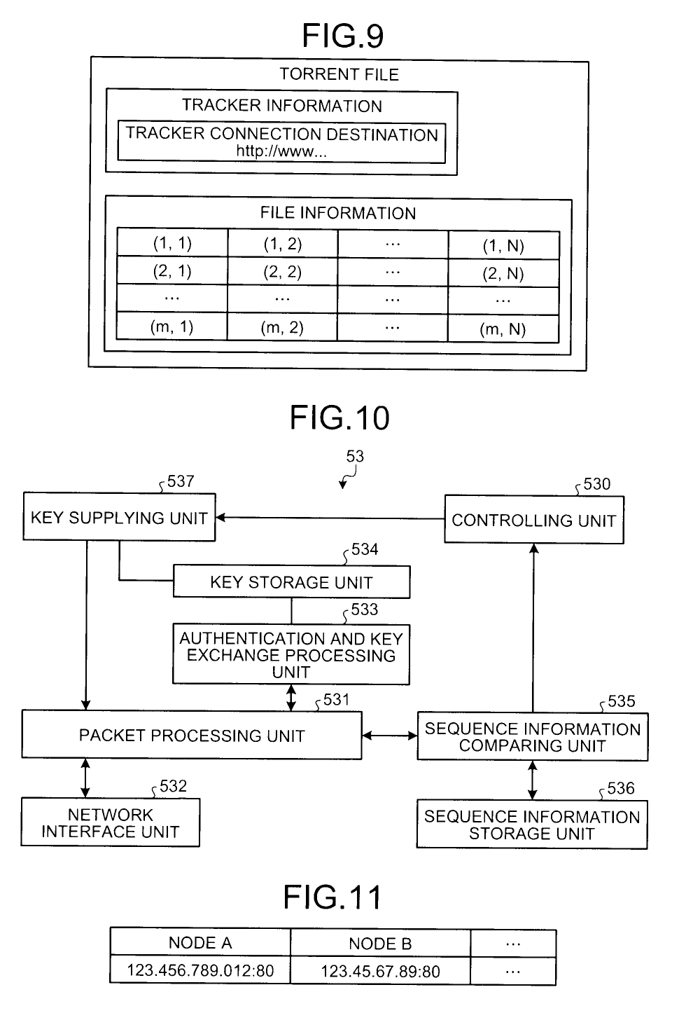

The content obtaining unit 500 receives the encrypted pieces that constitute the encrypted content from at least one of the seeders 52, via the P2P network NT. More specifically, the content obtaining unit 500 first receives a Torrent File from the sales server 54. The Torrent File contains tracker information including tracker connection destination information used for connecting to the tracker 51 and file information indicating what encrypted pieces constitute the encrypted content. FIG. 9 is a drawing of an example of the Torrent File. In FIG. 9, as for the file information, the indexes corresponding to the encrypted pieces are shown as the information used for identifying each of the encrypted pieces. The tracker connection destination information may be, for example, an IP address or a Uniform Resource Locator (URL) of the tracker 51.

Based on the Torrent File, the content obtaining unit 500 accesses the tracker 51 via the P2P network NT and receives, from the tracker 51, node information used for accessing the other nodes (e.g., the seeders 52 and other leechers 50) connected to the P2P network NT. (The node information will be explained in detail later.) After that, based on the node information, the content obtaining unit 500 accesses at least one of the nodes and obtains piece information indicating the sequence of encrypted pieces stored in the node. Based on the piece information, the content obtaining unit 500 then transmits a piece request to at least one of the nodes to request one or more of the encrypted pieces that constitute the encrypted content. By receiving the encrypted pieces that are transmitted in response to the piece request, the content obtaining unit 500 obtains all the encrypted pieces (hereinafter, the “piece sequence”) that constitute the encrypted content. For example, of the encrypted pieces shown in FIG. 3, the content obtaining unit 500 obtains all the encrypted pieces that are shown with hatching as the piece sequence.

The key ring requesting unit 501 transmits a request message to the key server 53 to request a key ring used for decrypting the piece sequence. The key ring contains the decryption keys used for decrypting the encrypted pieces in the piece sequence in correspondence with the sequence of the encrypted pieces. The key ring and the decryption keys will be explained in detail later. The request message contains index information as information that specifies the sequence of the decryption keys contained in the key ring, the index information indicating the combination (i.e., the sequence) of the indexes of the encrypted pieces in the piece sequence.

For example, the sequence can be expressed as below:

{(i1,1), (i2,2), . . . , (iN,N)}
where 1≦i1, . . . , iN≦m is satisfied.

The key ring obtaining unit 502 receives the key ring that has been transmitted from the key server 53 in response to the request message. The content decrypting unit 503 decrypts the encrypted pieces that have been obtained by the content obtaining unit 500, with the decryption keys that are contained in the key ring obtained by the key ring obtaining unit 502 and that correspond to the encrypted pieces respectively. The content decrypting unit 503 thus obtains the content that is constituted with the pieces resulting from the decryption process.

There is a situation in which the leecher 50 functions as a seeder, as explained above; however, because the functional configuration of a seeder has already been explained in the description of the seeder 52, the explanation thereof will be omitted.

Next, various types of functions that are realized when the CPU of the key server 53 executes the various types of programs stored in the storage devices and the external storage devices will be explained. FIG. 10 is an exemplary functional diagram of the key server 53. The key server 53 includes a controlling unit 530, a packet processing unit 531, a network interface unit 532, an authentication and key exchange processing unit 533, a key storage unit 534, a sequence information storage unit 536, a sequence information comparing unit 535, and a key supplying unit 537. The actual substance of each of the units such as the controlling unit 530, the sequence information comparing unit 535, the network interface unit 532, the packet processing unit 531, the authentication and key exchange processing unit 533, and the key supplying unit 537 is generated in a storage device (e.g., the RAM) when the CPU executes the programs. The key storage unit 534 is, for example, stored in an external storage device.

The controlling unit 530 controls the entirety of the key server 53 and also intermediates instructions from the sequence information comparing unit 535 to the key supplying unit 537. The packet processing unit 531 packetizes various types of data to be transmitted to external apparatuses such as a leecher 50 and forwards the packet to the network interface unit 532. The packet processing unit 531 also obtains data, based on packets forwarded from the network interface unit 532. The network interface unit 532 controls communication with external apparatuses, transmits the packetized data forwarded from the packet processing unit 531 to the external apparatuses, and forwards the packets received from the external apparatuses to the packet processing unit 531.

The authentication and key exchange processing unit 533 receives the request message from the leecher 50 via the network interface unit 532, performs a mutual authentication process with the leecher 50, and, after the authentication process has been finished, transmits an acceptance message to the leecher 50 so as to indicate that the request has been accepted.

The key storage unit 534 is provided in, for example, an external storage device such as an HDD and stores therein the decryption keys used for decrypting the encrypted pieces. Each of the decryption keys is expressed as, for example, K(i,j), as explained above.

The sequence information storage unit 536 is provided in, for example, an external storage device such as an HDD and stores therein sequence information indicating the sequences that respectively correspond to all the key rings that were transmitted to the leechers 50 in the past. For example, the sequences that respectively correspond to the key rings can be expressed as below, like the sequences indicated in the index information described above:

{(i1,1), (i2, 2), . . . , (iN,N)}
where 1≦i1, . . . , iN≦m is satisfied.

The sequence information comparing unit 535 compares the sequence information stored in the sequence information storage unit 536 with the index information received from the leecher 50 and determines whether the key ring corresponding to the sequence indicated in the index information should be transmitted. More specifically, in the case where the sequence information storage unit 536 stores therein no sequence information indicating the same sequence as the sequence indicated in the index information, the sequence information comparing unit 535 determines that the key ring corresponding to the sequence indicated in the index information should be transmitted. For example, the key ring can be expressed as below (In the example below, the decryption keys that respectively correspond to the pieces C1 to CN are arranged in a row from the left side):

### {K(i1,1), K(i2,2), . . . , K(iN,N)}

where 1≦i1, . . . , iN≦m is satisfied.

In the case where the sequence information comparing unit 535 has determined that the key ring should be transmitted, the sequence information comparing unit 535 instructs, via the controlling unit 530, the key supplying unit 537 to transmit the key ring to the leecher 50. On the contrary, in the case where the sequence information comparing unit 535 has determined that the key ring should not be transmitted, the sequence information comparing unit 535 instructs, via the controlling unit 530, the key supplying unit 537 that the transmission of the key ring to the leecher 50 is prohibited.

According to the instruction received from the sequence information comparing unit 535 via the controlling unit 530 instructing that the key ring should be transmitted, the key supplying unit 537 reads the decryption keys that correspond to the sequence of the key ring out of the key storage unit 534 and transmits the key ring that contains the read decryption keys to the leecher 50 via the network interface unit 532.

Next, a configuration of the tracker 51 will be explained. When being accessed by the leecher 50, the tracker 51 transmits the node information to the leecher 50, the node information being used for accessing the nodes connected to the P2P network NT. The node information contains sets each made up of an IP address and a port number of a different one of the nodes. FIG. 11 is a drawing of an example of a data structure of the node information. In FIG. 11, each of the nodes A and B is any one of the leechers 50A and 50B and the seeders 52A, 52B, and 52C, and a set made up of the IP address and the port number is shown for each of the nodes.

Next, how the tracker 51 generates the node information will be explained. It is assumed that a node stores therein a Torrent File containing the tracker connection destination information used for connecting to the tracker 51 and also stores therein encrypted pieces. The node refers to the tracker connection destination information contained in the Torrent File, accesses the tracker 51, and transmits the IP address and the port number for identifying the node itself to the tracker 51. The tracker 51 generates the node information by using the piece information, the IP address, and the port number that have been received.

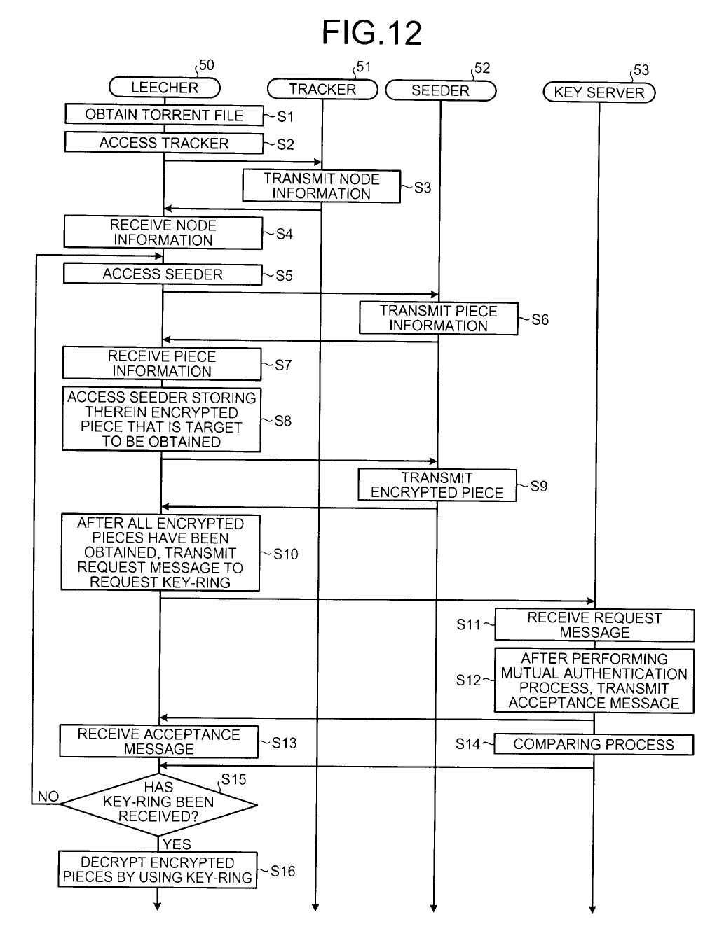

Next, a procedure in a content distributing process performed in the content distribution system according to the first embodiment will be explained, with reference to FIG. 12. The leecher 50 is able to receive encrypted pieces from any of the other leechers 50; in the following explanation, however, for the sake of convenience of the explanation, it is assumed that the leecher 50 receives the encrypted pieces from at least one of the seeders 52A, 52B, and 52C.

First, the leecher 50 accesses the sales server 54 and obtains the Torrent File (Step S1). After that, the leecher 50 accesses the tracker 51 by using the tracker connection destination information included in the tracker information contained in the Torrent File (Step S2). The tracker 51 then transmits the node information to the leecher 50 (Step S3).

When the leecher 50 has received the node information (Step S4), the leecher 50 accesses, for example, at least one of the seeders 52A, 52B, and 52C by using the node information (Step S5). When the seeder 52 is accessed by the leecher 50, the seeder 52 transmits the piece information to the leecher 50 to indicate the sequence of the encrypted pieces stored therein (Step S6).

When the leecher 50 has received the piece information (Step S7), the leecher 50 accesses at least one of the seeders 52 by using the piece information (Step S8). The leecher 50 transmits a piece request to the seeder 52 to request, for each of the pieces C1 to CN, at least one of the plurality of encrypted pieces that can possibly exist in correspondence with the piece, so that the leecher 50 is able to receive the encrypted pieces. In response to the piece request from the leecher 50, the seeder 52 transmits the encrypted piece stored therein to the leecher 50 (Step S9). More specifically, for example, by using the piece information that has been received by accessing the seeder 52B, the leecher 50 judges whether the seeder 52B stores therein the encrypted piece corresponding to “i1=1” among the encrypted pieces E(K(i1,1))[C1] (where i1 is an integer that satisfies 1≦i1≦m) obtained by encrypting the piece C1. In the case where the result of the judging process is in the affirmative, the leecher 50 accesses the seeder 52B and obtains the encrypted piece E(K(1,1)) [C1] by receiving it from the seeder 52B. In the case where the seeder 52B actually does not store therein the encrypted piece E(K(1,1))[C1], the leecher 50 subsequently accesses another seeder 52 (e.g., the seeder 52C) and obtains piece information from the other seeder (e.g., the seeder 52C). In the same manner as described above, by using the piece information, the leecher 50 judges whether the seeder 52C stores therein the encrypted piece. In the case where the result of the judging process is in the affirmative, the leecher 50 accesses the seeder 52C and attempts to obtain the encrypted piece. By repeating the process described above, the leecher 50 obtains the encrypted content {E(K(i1,1))[C1], E(K(i2,2))[C2], . . . , E(K(iN,N))[CN]}

that is constituted with the encrypted pieces.

As the target to be obtained, the leecher 50 is able to arbitrarily select any one of the plurality of encrypted pieces that can possibly exist in correspondence with a piece Cj (where 1≦j≦N). In other words, with regard to E(K(i1,j))[Cj] (where i1 is an integer that satisfies 1≦i1≦m), the leecher 50 is able to arbitrarily set “i1” to any one of the values from “1” to “m”. Accordingly, the sequence of the encrypted pieces {(i1,1), (i2,2), . . . , (iN,N)} that have been obtained by the leecher 50 in correspondence with the pieces C1 to CN is arbitrary.

When the leecher 50 has obtained all the encrypted pieces that respectively correspond to the pieces constituting the content and that constitute the encrypted content, the leecher 50 transmits the request message to the key server 53 to request the key ring that contains the decryption keys used for decrypting the encrypted pieces (Step S10). The request message contains the index information {(i1,1), . . . , (iN,N)} indicating the sequence corresponding to the decryption keys.

When the authentication and key exchange processing unit 533 included in the key server 53 has received the request message via the network interface unit 532 (Step S11), the authentication and key exchange processing unit 533 performs a mutually authentication process with the leecher 50. In the case where the authentication process has been performed successfully, the authentication and key exchange processing unit 533 transmits an acceptance message to the leecher 50 to indicate that the request has been accepted (Step S12). When the leecher 50 has received the acceptance message from the key server 53 (Step S13), the leecher 50 waits for the key ring to be transmitted from the key server 53.

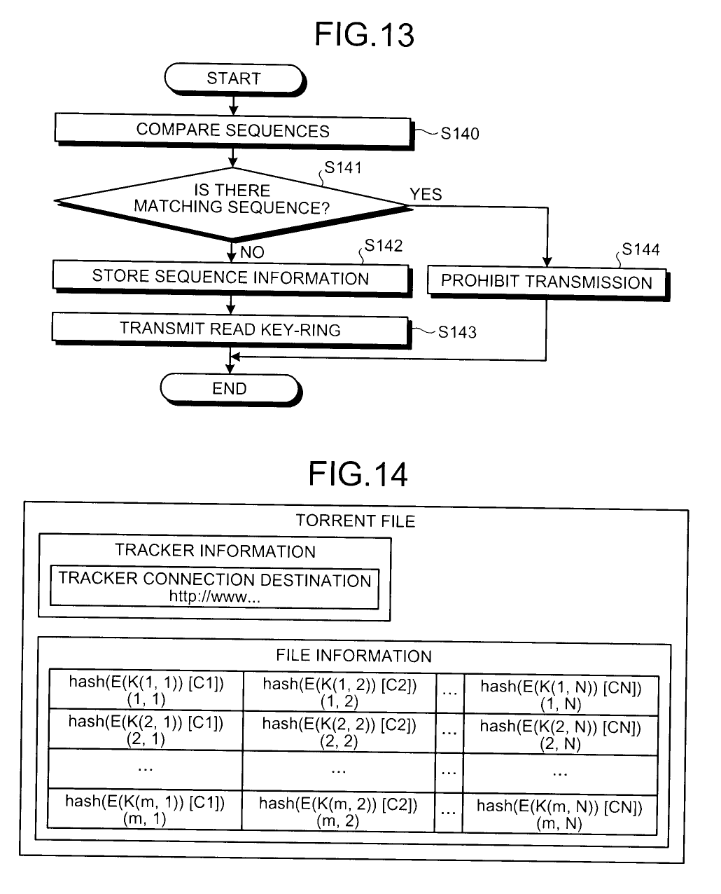

On the other hand, the sequence information comparing unit 535 included in the key server 53 performs a comparing process by using the index information contained in the request message that has been received at Step S11 (Step S14). FIG. 13 is a flowchart of a procedure in the comparing process. In the comparing process, the sequence information comparing unit 535 compares the index information contained in the request message that has been received at Step S11 with the sequence information stored in the sequence information storage unit 536 (Step S140) and judges whether the sequence information storage unit 536 stores therein sequence information indicating the same sequence as the sequence indicated in the index information (Step S141). In other words, the sequence information comparing unit 535 judges whether the key ring requested by the leecher 50 was transmitted to any of the leechers 50 in the past.

In the case where the result of the judging process is in the negative (Step S141: No), the sequence information comparing unit 535 determines that the key ring {K(i1,1), K(i2,2), . . . , K(iN,N)} corresponding to the sequence indicated in the index information should be transmitted. Thus, the sequence information comparing unit 535 instructs, via the controlling unit 530, the key supplying unit 537 to transmit the key ring to the leecher 50. In addition, the sequence information comparing unit 535 stores sequence information indicating the sequence into the sequence information storage unit 536 (Step S142). The key supplying unit 537 reads the key ring of which the transmission has been instructed by the sequence information comparing unit 535 via the controlling unit 530 out of the key storage unit 534 and transmits the read key ring to the leecher 50 via the network interface unit 532 (Step S143). On the contrary, in the case where the result of the judging process at Step S141 is in the affirmative, the sequence information comparing unit 535 determines that the key ring should not be transmitted and instructs, via the controlling unit 530, the key supplying unit 537 that the transmission of the key ring to the leecher 50 is prohibited (Step S144).

Returning to the description of FIG. 12, in the case where the leecher 50 has received the key ring {K(i1,1), K(i2,2), . . . , K(iN,N)} from the key server 53 (Step S15: Yes), the leecher 50 decrypts the encrypted pieces E(K(i1,1))[C1], E(K(i2,2))[C2], . . . , E(K(iN,N))[CN] by using the decryption keys contained in the key ring to obtain the decrypted pieces C1 to CN and obtain the content C constituted with the pieces C1 to CN (Step S16). In other words, the leecher 50 decrypts E(K(i1,1))[C1] by using the decryption key K(i1,1) and obtains the piece C1, decrypts E(K(i2,2))[C2] by using the decryption key K(i2,2) and obtains the piece C2, and decrypts E(K(iN,N))[CN] by using the decryption key K(iN,N) and obtains the piece CN. The leecher 50 obtains the other pieces in the same manner. Thus, the leecher 50 has obtained the content C that is constituted with the pieces C1 to CN.

On the contrary, in the case where the leecher 50 does not receive the key ring at Step S15 and has received an error message transmitted from the key server 53 at Step S143 shown in FIG. 13, the leecher 50 is not able to decrypt the pieces that have been obtained at Step S10 and is therefore not able to use the content. In this situation, the process returns to Step S5, so that the leecher 50 obtains encrypted pieces in a sequence that is different from the sequence obtained at Step S10 and performs the processes at Step S10 and thereafter again.

As explained above, in the case where the one content is distributed to the plurality of leechers 50 via the P2P network, the key server 53 determines whether the key rings should be transmitted by using the sequences of the encrypted pieces. In this situation, because the key server 53 avoids re-using the sequences that have already been used, it is possible to individualize the content for each of the leechers 50. Accordingly, for example, even if one key ring is leaked, it is possible to decrypt only the encrypted content that corresponds to the leaked key ring. Thus, it is possible to inhibit illegitimate use of the content. In addition, by using, instead of a predetermined sequence, the sequence defined by the encrypted pieces that are arbitrarily obtained by the leecher 50, it is possible to realize a flexible content distributing process that is compliant with the environment of the P2P network.

According to the first embodiment, the Torrent File is not limited to the example described above. For example, another arrangement is acceptable in which the file information contains hash values that are calculated through a hash calculation process by using the encrypted pieces.

For example, the hash values of the encrypted pieces can be expressed as below:

{hash(E(K(i,j))[Cj])}
where 1≦i≦m and 1≦j≦N are satisfied.

FIG. 14 is a drawing of an example of a data structure of such a Torrent File. In FIG. 14, the correspondence relationships between the hash values of the encrypted pieces and the indexes are shown. The leecher 50 is able to check the completeness of the received encrypted pieces, by using the hash values of which there are as many as m×n. Further, yet another arrangement is acceptable in which the creator of the Torrent File or a reliable third party (e.g., a content creator) attaches a digital signature to the Torrent File. In this situation, the leecher 50 is able to check authenticity of the received encrypted pieces, in addition to the completeness thereof.

Also, by referring to such a Torrent File, it is possible to identify the index based on the hash value of each of the encrypted pieces. As a result, it is also possible to identify the decryption key for decrypting the encrypted piece.

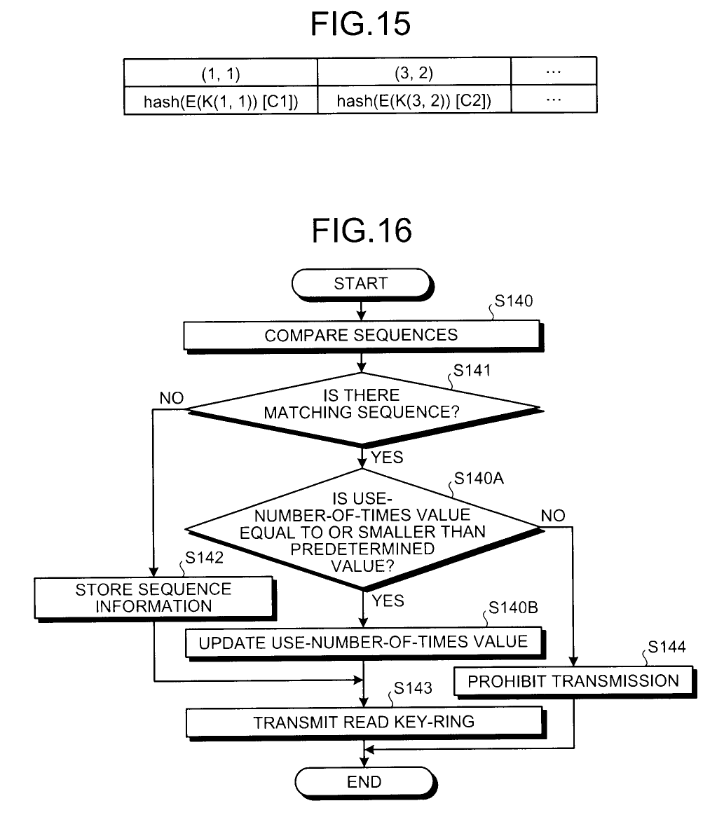

In this configuration, yet another arrangement is acceptable in which the seeder 52 further transmits piece information containing hash values to the leecher 50. FIG. 15 is a drawing of an example of index information containing the hash values. In this situation also, the leecher 50 is able to check the completeness of the received encrypted pieces by using the hash values.

The file information does not need to show all the indexes. (In the example described above, the file information shows all combinations of (i,j) that satisfy 1≦i≦m and 1≦j≦N). It is acceptable if the file information shows only a part of the indexes.

Yet another arrangement is acceptable in which the Torrent File contains a version number thereof and/or information related to the validity period thereof. In this situation, the leecher 50 is able to find out whether the obtained Torrent File is valid at the time of the obtainment. For example, an arrangement is acceptable in which, in the case where the obtained Torrent File is not valid at a certain point in time, the leecher 50 obtains a newer Torrent File. Alternatively, another arrangement is acceptable in which the leecher 50 starts obtaining the encrypted pieces by using the Torrent File obtained at the certain point in time and, if the seeder 52 stores therein the encrypted piece that corresponds to an index that is unknown (to the leecher 50), the leecher 50 receives the encrypted piece corresponding to the unknown index from the seeder 52, and after the encrypted piece has been received, the leecher 50 obtains a newer Torrent File and checks the completeness and the authenticity of the received encrypted pieces.

According to the first embodiment described above, the leecher 50 puts the index information into the request message and transmits the request message to the key server 53 at Step S10; however, the present invention is not limited to this example. Another arrangement is acceptable in which the leecher 50 transmits the index information to the key server 53 after having received the acceptance message.

At Step S6 described above, the seeder 52 transmits the piece information indicating the sequence of the pieces stored therein when the leecher 50 has accessed the seeder 52; however, another arrangement is acceptable in which the seeder 52 transmits the piece information to the leecher 50, without waiting for the access from the leecher 50.

At Step S9 described above, the seeder 52 transmits the encrypted piece to the leecher 50. In addition, it is also acceptable for the seeder 52 to transmit the corresponding index to the leecher 50. For example, an arrangement is acceptable in which, if the transmitted encrypted piece is E(K(1,1))[C1], the seeder 52 transmits the corresponding index (1,1) to the leecher 50, in addition to the encrypted piece.

In the first embodiment described above, the leecher 50 receives the encrypted pieces from the seeder 52; however, the present invention is not limited to this example. Another arrangement is acceptable in which the leecher 50 obtains the encrypted pieces from any of the other leechers 50.

Yet another arrangement is acceptable in which, with respect to each of the encrypted pieces that respectively correspond to the pieces C1 to CN, the leecher 50 obtains a plurality of mutually different encrypted pieces for the piece. For example, with respect to the piece C1, it is acceptable for the leecher 50 to obtain the encrypted pieces E(K(i1,1)) [C1] and E(K(i1′,1))[C1] (where i1≠i1′, 1≦i1≦m, and 1≦i1′≦m are satisfied). With this arrangement, when the leecher 50 requests the key ring from the key server 53, if the sequence containing the index (i1,1) has already been used, the leecher 50 is not able to obtain the key ring corresponding to the sequence, but if the sequence containing the index (i1′,1) is usable, the leecher 50 is able to obtain the key ring corresponding to this sequence from the key server 53 without having to access the seeder 52 again. With this arrangement in which the leecher 50 obtains the extra encrypted piece in advance, the leecher 50 is able to prepare the plurality of sequence candidates in advance. Thus, the leecher 50 is able to avoid the trouble of having to access the seeder 52 again.

In the first embodiment described above, in the case where the sequence information storage unit 536 already stores therein the sequence that corresponds to the key ring being requested by the leecher 50, the sequence information comparing unit 535 included in the key server 53 instructs, via the controlling unit 530, the key supplying unit 537 that the transmission of the key ring to the leecher 50 is prohibited, at Step S144; however, the present invention is not limited to this example. Another arrangement is acceptable in which, for example, in the case where the leecher 50 has obtained the encrypted contents E(K(i1,1))[C1], E(K(i2,2))[C2], . . . , E(K(iN,N))[CN] and requests the corresponding key ring from the key server 53, if the sequence information storage unit 536 has already stored therein the sequence {(i1,1), (i2,2), . . . , (iN,N)} that corresponds to the key ring requested by the leecher 50, the key server 53 generates another sequence {(i1′,1), (i2,2), . . . , (iN,N)} that is not stored in the sequence information storage unit 536 and transmits, to the leecher 50, the encrypted piece E(K(i1′1))[C1] with which the leecher 50 should replace the other encrypted piece and information related to the index thereof ((i1′,1) in the present example). In addition, the key server 53 transmits a key ring containing the decryption keys that respectively correspond to the other sequence {(i1′,1), (i2,2), . . . , (iN,N)} to the leecher 50. With this arrangement, the leecher 50 is able to avoid the trouble of having to access the tracker 51 again for the purpose of obtaining the encrypted pieces that correspond to the sequence for which the transmission of the key ring is permitted in the comparing process performed by the sequence information comparing unit 535 included in the key server 53. In this situation, the key server 53 needs to store therein, in advance, the encrypted piece that can be transmitted to the leecher 50. The number of stored encrypted pieces may be one or may be more than one. In the case where the key server 53 stores therein more than one encrypted piece, it is acceptable for the key server 53 to transmit, to the leecher 50, the plurality of encrypted pieces each as the encrypted piece with which the leecher 50 should replace the other encrypted piece (together with the information related to the indexes thereof). In the case where the sequence information storage unit 536 has not yet stored therein the sequence {(i1,1), (i2,2), . . . , (iN,N)} that corresponds to the key ring requested by the leecher 50, the key server 53 may or may not perform the replacement process described above.

According to the first embodiment described above, during the comparing process, the sequence information comparing unit 535 instructs that the key ring should not be transmitted if the key ring requested by the leecher 50 was transmitted in the past at least once to any of the leechers 50; however, the present invention is not limited to this example. Another arrangement is acceptable in which the key server 53 is allowed to transmit one key ring up to a predetermined number of times such as twice or more. In this situation, the authentication and key exchange processing unit 533 included in the key server 53 obtains, from the leecher 50, leecher identification information for identifying the leecher 50, during the mutual authentication process performed with the leecher 50. The leecher identification information may be, for example, the IP address of the leecher 50, the port number of the leecher 50, a Media Access Control (MAC) address of the leecher 50, or a subscriber's ID, or a combination of any of these. The sequence information comparing unit 535 stores, into the sequence information storage unit 536, the sequence information that indicates the sequence of the key ring, the leecher identification information, and a use-number-of-times value that indicates how many times the leecher 50 identified with the leecher identification information has requested a transmission of the key ring, while keeping these pieces of information in correspondence with one another. FIG. 16 is a flowchart of a procedure in the comparing process according to the present modification example. The processes performed at Steps S140 through S141 are the same as those according to the first embodiment. In the case where the result of the judging process at Step S141 is in the affirmative, that is, in the case where the sequence information storage unit 536 has already stored therein the sequence information indicating the same sequence as the sequence of the key ring requested by the leecher 50, the sequence information comparing unit 535 refers to the use-number-of-times value that is stored in the sequence information storage unit 536 in correspondence with the sequence information and the leecher identification information of the leecher 50 and judges whether the use-number-of-times value is equal to or smaller than a predetermined value (Step S140A). In the case where the result of the judging process is in the affirmative, the sequence information comparing unit 535 updates the use-number-of-times value by incrementing, by one, the use-number-of-times value stored in the sequence information storage unit 536 in correspondence with the sequence information and the leecher identification information (Step S140B) and performs the process at Step S143 as described above. On the contrary, in the case where the result of the judging process at Step S141 is in the negative, the sequence information comparing unit 535 performs the processes at Step S142 and thereafter as described above. In the case where the result of the judging process at Step S140A is in the negative, the sequence information comparing unit 535 performs the same process as at Step S144 described above.

With this arrangement, it is permitted to use the same sequence of encrypted pieces a plurality of times, instead of only once. Thus, it is possible to realize a more flexible content distributing process.

In the first embodiment described above, the node information indicates the IP addresses and the port numbers of the nodes; however, the present invention is not limited to this example. Another arrangement is acceptable in which the node information indicates the MAC addresses of the nodes. Yet another arrangement is acceptable in which the node information indicates subscribers' IDs that are assigned to the subscribers when they subscribe to the content distribution service. In this situation, it is sufficient if each of the nodes transmits, to the tracker 51, at least one of the IP addresses of the node, the MAC address of the node, the subscriber's ID, and the URL, as the node identification information.

Further, in the first embodiment described above, when the tracker 51 generates the node information, each of the nodes transmits the received piece information, the IP address, and the port number, to the tracker 51; however, the present invention is not limited to this example. Another arrangement is acceptable in which the each of the nodes transmits Torrent File identification information to the tracker 51, in addition to the piece information, the IP address, and the port number. The Torrent File identification information may be, for example, a hash value of a part or all of the Torrent File or the file name of the Torrent File. Alternatively, in the case where the Torrent File has a field showing the ID thereof, it is acceptable if the Torrent File identification information is the value of the shown ID. In this situation, an arrangement is acceptable in which, when the tracker 51 has received pieces of Torrent File identification information in addition to the piece information, the IP addresses, and the port numbers that have been received, the tracker 51 generates node information for each of the received pieces of Torrent File identification information. In other words, an arrangement is acceptable in which the tracker 51 generates node information corresponding to the piece of Torrent File identification information transmitted by a node that has made an access to the tracker 51 and transmits the generated node information to the node.

Yet another arrangement is acceptable in which the tracker 51 divides the nodes into groups based on the IP addresses and the port numbers thereof and generates node information for each of the groups. In other words, an arrangement is acceptable in which the tracker 51 generates node information corresponding to the group to which the IP address and the port number transmitted by the node that has made an access to the tracker 51 belong and transmits the generated node information to the node. In this arrangement, it is acceptable for the tracker 51 to divide the nodes into groups in such a manner that each of the nodes belongs to two or more of the groups. In that situation, the tracker 51 generates node information corresponding to a part or all of the groups to which the IP address and the port number transmitted by the node that has made an access to the tracker 51 belong and transmits the generated node information to the node.

In the first embodiment described above, another arrangement is acceptable in which, in the case where the leecher 50 has successfully obtained an encrypted piece at Step S9, the leecher 50 informs the seeder 52 from which the encrypted piece has been transmitted that the encrypted piece has successfully been obtained. For example, it is acceptable to judge whether the encrypted piece has successfully been obtained in the following manner: The seeder 52 transmits the encrypted piece after attaching a mark indicating the end of the encrypted piece to the end of the data. When the leecher 50 has received the encrypted piece, the leecher 50 judges that the entirety of the data corresponding to the encrypted piece has been received by detecting the mark.

In the case where the file information contained in the Torrent File includes hash values calculated through a hash calculation process by using the encrypted pieces as explained in one of the modification examples of the first embodiment above, an arrangement is acceptable in which the leecher 50 calculates a hash value of the encrypted piece received from the seeder 52 and compares the calculated hash value with the hash value of the encrypted piece contained in the Torrent File, so that the leecher 50 judges that the encrypted piece has successfully been obtained if these hash values match. Another arrangement is acceptable in which, when the leecher 50 transmits a notification message to the seeder 52 to notify the seeder 52 that the encrypted piece has successfully been obtained, the leecher 50 puts any of the following types of information into the notification message: the hash values of the encrypted piece, the index of the encrypted piece indicated in the Torrent File, the time at which the encrypted piece was successfully obtained, and the node information of the leecher 50.

In the first embodiment described above, another arrangement is acceptable in which a maximum limit is set to the number of encrypted pieces that the leecher 50 is able to request from the seeder 52 at one time. In this situation, if the seeder 52 has received a piece request requesting a larger number of encrypted pieces than the maximum limit, it is acceptable for the seeder 52 to reject the request. Yet another arrangement is acceptable in which the seeder 52 does not reject the request, but transmits a number of encrypted pieces that are equal to or fewer than the maximum limit to the leecher 50 that has transmitted the piece request. After the seeder 52 has confirmed that the transmission of at least one of the encrypted pieces has been completed, it is acceptable for the seeder 52 to transmit, to the leecher 50, a number of encrypted pieces that are equal to or fewer than the maximum limit and that are among the remaining encrypted pieces that have been requested in the piece request but have not yet been transmitted.

In the first embodiment described above, another arrangement is acceptable in which, in the case where the seeder 52 is not able to transmit the encrypted piece requested in the piece request transmitted by the leecher 50 because, for example, the seeder 52 does not store therein the requested encrypted piece, the seeder 52 transmits a message to the leecher 50 to inform the leecher 50 of the situation.

Next, a second embodiment of the content distribution system according to the present invention will be explained. Parts of the second embodiment that are the same as the first embodiment will be explained by using the same reference characters or will be omitted from the explanation.

The configuration of the content distribution system according to the second embodiment is different from the configuration of the content distribution system according to the first embodiment in the following: According to the second embodiment, the tracker 51 determines a part or all of the sequence of the encrypted pieces that correspond to the pieces C1 to CN.

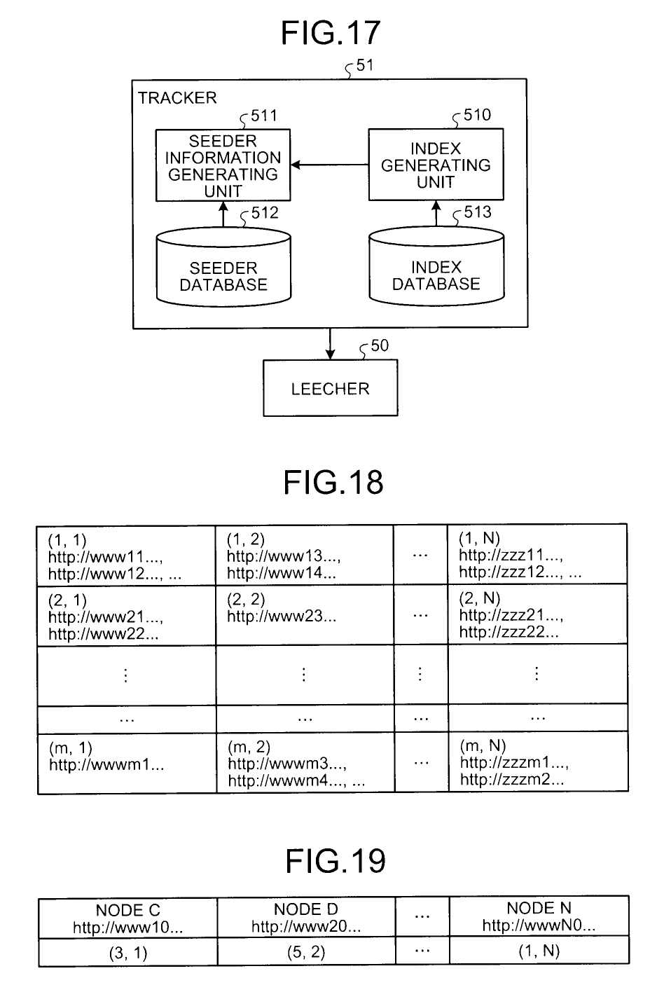

FIG. 17 is a functional block diagram of the tracker 51 according to the second embodiment. The tracker 51 includes an index generating unit 510, a seeder information generating unit 511, a seeder database 512, and an index database 513.

The seeder database 512 stores therein, with respect to the pieces C1 to CN, the indexes of the decryption keys used for decrypting the encrypted pieces and seeder connection destination information used for accessing the nodes storing therein the encrypted pieces corresponding to the indexes, while keeping these types of information in correspondence with one another. In the present example, it is assumed that the seeder connection destination information is URLs. FIG. 18 is a drawing of an example of a data structure of the seeder database 512. In FIG. 18, pieces of information respectively corresponding to the pieces C1 to CN are arranged in a row from the left side. For example, it is shown that the encrypted piece that corresponds to the piece C1 and corresponds to the index (1,1) is stored in the node whose URL is “http://www11 . . . ” and the node whose URL is “http://www12 . . . ”. It is also shown that the encrypted piece that corresponds to the piece C2 and corresponds to the index (2,2) is stored in the node whose URL is “http://www23 . . . ”. The nodes that are kept into correspondence with the indexes of the pieces C1 to CN may be all the same or may be different from one another.

The tracker 51 generates seeder connection destination information as described below and stores the generated seeder connection destination information into the seeder database 512, while keeping the seeder connection destination information in correspondence with the indexes. As explained in the description of the first embodiment above, the tracker 51 obtains the node identification information from each of the nodes. According to the second embodiment, in addition to the node identification information, the tracker 51 also obtains piece information of the encrypted pieces stored in each of the node. After that, that tracker 51 generates the seeder connection destination information based on the node identification information, like the node information explained in the description of the first embodiment. The tracker 51 stores the generated seeder connection destination information into the seeder database 512, while keeping the seeder connection destination information in correspondence with the indexes in the sequence indicated in the piece information.

When being accessed by the leecher 50, the index generating unit 510 first obtains Torrent File identification information from the leecher 50. After that, the index generating unit 510 defines a range of indexes from which indexes can be selected for each of the encrypted pieces, based on the Torrent File identification information to determine the indexes for the encrypted pieces that respectively correspond to the pieces and to generate a combination of indexes (i.e., a sequence). Subsequently, the index generating unit 510 inquires whether the generated sequence has already been stored in the index database 513. The index generating unit 510 judges whether the sequence is usable according to the result of the inquiry. Sequence information indicating the sequence that has been judged to be usable by the index generating unit 510 is stored into the index database 513.

For each of the encrypted pieces corresponding to the sequence, the seeder information generating unit 511 identifies a node that stores therein the encrypted piece, by referring to the seeder database 512 based on the sequence that has been judged to be usable by the index generating unit 510. In the case where two or more nodes each store therein the targeted encrypted piece, it is acceptable for the seeder information generating unit 511 to identify one of the nodes by arbitrarily selecting one out of the two or more nodes. After that, the seeder information generating unit 511 generates seeder information indicating the node that has been identified for each of the encrypted pieces and transmits the generated seeder information to the leecher 50. The seeder information contains index information that indicates the indexes in the sequence that has been judged to be usable by the index generating unit 510 and connection destination information used for accessing the nodes storing therein the encrypted pieces that correspond to the indexes.

FIG. 19 is a drawing of an example of the seeder information. In FIG. 19, an example is shown in which the tracker 51 determines the sequence of all the encrypted pieces. In FIG. 19, pieces of information that correspond to the pieces C1 to CN are arranged in a row from the left side. The URLs of the nodes are shown as the connection destination information. It is also shown that the sequence determined for the pieces C1 to CN is {(3,1), (5,2), . . . , (1,N)}. In addition, it is also shown that the encrypted piece corresponding to the index (3,1) is stored in the node whose URL is “http://www10 . . . ”; the encrypted piece corresponding to the index (5,2) is stored in the node whose URL is “http://www20 . . . ”; and the encrypted piece corresponding to the index (1,N) is stored in the node whose URL is “http://wwwN0 . . . ”. Alternatively, it is acceptable if only one node stores therein the encrypted pieces.

The index database 513 stores therein sequence information that indicates the sequence of the indexes that has been generated by the index generating unit 510. When the index database 513 stores therein a piece of sequence information, it means that the sequence indicated in the piece of sequence information has already been used. The index database 513 has a controller on the outside or the inside thereof and conducts a search in the sequence information in response to an inquiry from the index generating unit 510. According to the result of the search, the index database 513 returns a result of the inquiry to the index generating unit 510 or stores sequence information therein.

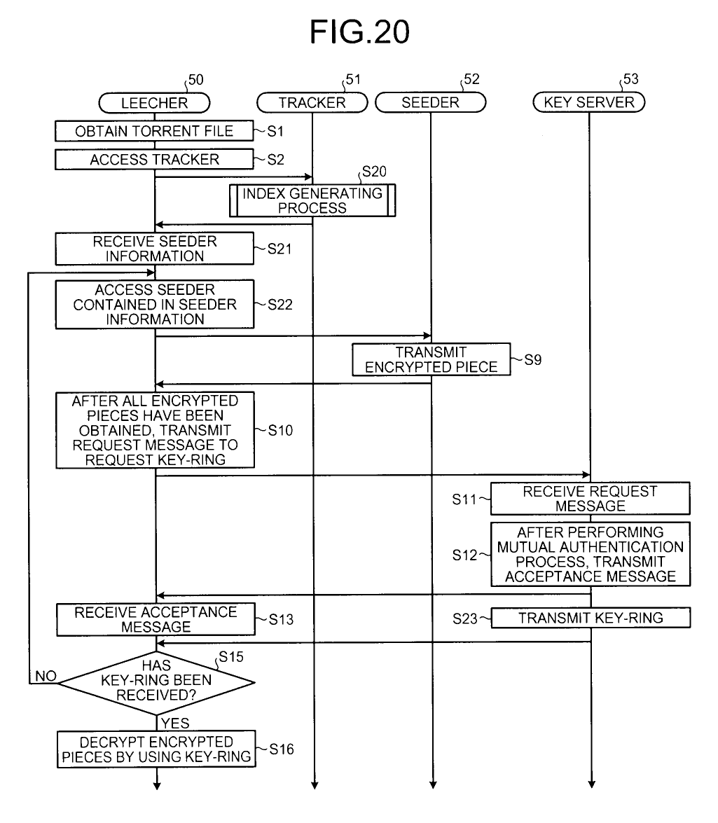

Next, a procedure in a content distributing process performed in the content distribution system according to the second embodiment will be explained, with reference to FIG. 20. In the following sections also, for the sake of convenience of the explanation, it is assumed that the leecher 50 receives the encrypted pieces from at least one of the seeders 52A, 52B, and 52C.

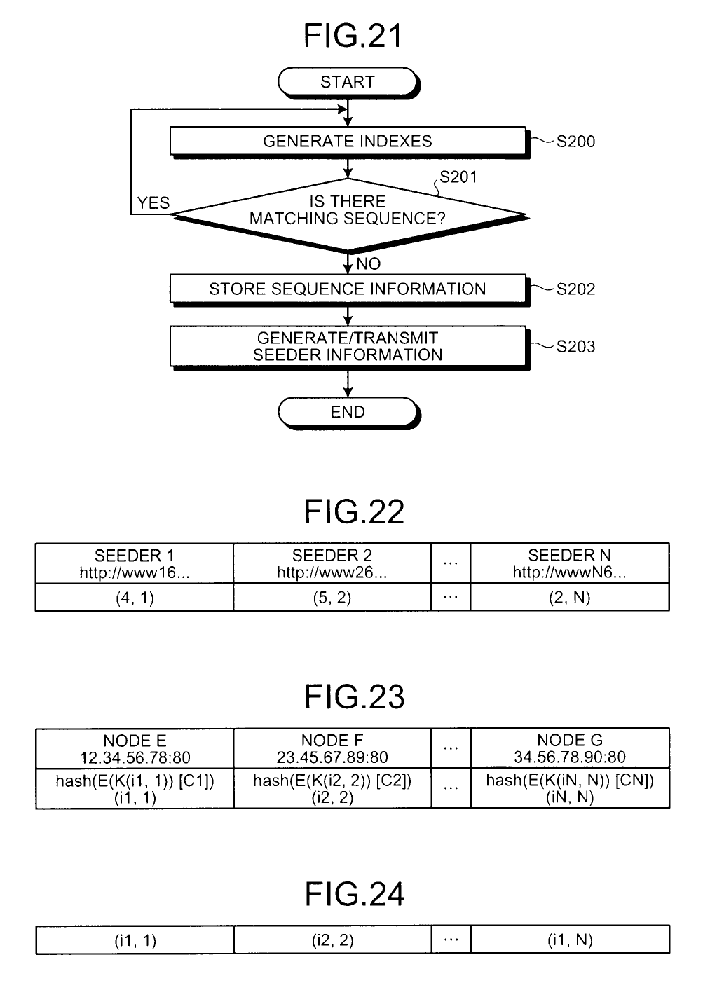

The processes performed at Steps S1 and S2 are the same as those according to the first embodiment. When being accessed by the leecher 50, the tracker 51 obtains Torrent File identification information from the leecher 50 and performs an index generating process based on the Torrent File identification information (Step S20). In the following section, an example in which the tracker 51 determines a sequence of all the encrypted pieces will be explained. FIG. 21 is a flowchart of a procedure in the index generating process. In the index generating process, for example, the index generating unit 510 generates a sequence of indexes {(i1,1), (i2,2), . . . , (i3,N)} by arbitrarily determining the values of “i1”, “i2”, . . . , and “i3” that satisfy “1≦i1, i2, . . . , i3≦m” with respect to the indexes (i1,1), (i2,2), . . . , and (i3,N) (Step S200). Subsequently, the index generating unit 510 inquires of the index database 513 whether sequence information indicating the sequence {(i1,1), (i2,2), . . . , (i3,N)} has already been stored therein. The index database 513 conducts a search in the sequence information stored therein. In the case where the index database 513 has already stored therein the sequence information that indicates the same sequence as the sequence in the inquiry (Step S201: Yes), it means that the sequence in the inquiry has already been used. In that situation, the index database 513 returns “1” to the index generating unit 510. When having received “1” from the index database 513, the index generating unit 510 generates a new sequence and inquires of the index database 513 again whether sequence information indicating the new sequence has already been stored therein.

On the contrary, in the case where the index database 513 has not stored therein any sequence information indicating the same sequence as the sequence in the inquiry (Step S201: No), the index database 513 stores therein the sequence information indicating the sequence in the inquiry and returns “0” to the index generating unit 510 (Step S202). When the index generating unit 510 has received “0” from the index database 513, the seeder information generating unit 511 refers to the seeder database 512 and identifies, for each of the encrypted pieces corresponding to the sequence, a seeder 52 that stores therein the encrypted piece. The seeder information generating unit 511 then generates seeder information indicating the seeders that have been identified for the encrypted pieces and transmits the generated seeder information to the leecher 50 (Step S203). The seeder information contains the index information and the connection destination information described above.

Returning to the description of FIG. 20, when the leecher 50 has received the seeder information from the tracker 51 (Step S21), the leecher 50 accesses the seeders 52 by using the connection destination information contained in the seeder information (Step S22) and obtains the encrypted pieces corresponding to the sequence indicated in the index information contained in the seeder information. The processes performed at Steps S10 through S13 are the same as those according to the first embodiment. At Step S23, the key server 53 does not perform the comparing process described above, but transmits the key ring that corresponds to the request message to the leecher 50. The processes at Step S15 and thereafter are the same as those according to the first embodiment.

In the configuration described above, the tracker 51 is able to provide the leecher 50 with a sequence of encrypted pieces that constitute the encrypted content, while avoiding the sequences that have already been used. For example, let us discuss a situation where the tracker 51 has transmitted the seeder information as shown in FIG. 19 to the leecher 50. The sequence indicated in the seeder information shown in FIG. 19 is {(3,1), (5,2), . . . , (1,N)}. After that, when another leecher 50 has accessed the tracker 51, the tracker 51 transmits, for example, seeder information as shown in FIG. 22. The sequence indicated in the seeder information shown in FIG. 22 is {(4,1), (5,2), . . . , (2,N)} and is different from the sequence shown in FIG. 19. In this manner, for the leechers 50, the tracker 51 is able to provide the mutually different sequences of encrypted pieces that constitute an encrypted content.

Because the tracker 51 determines the sequences in this manner, it is possible to inhibit illegitimate use of the content corresponding to mutually the same sequence. For example, in the case where all of the decryption keys used for decrypting the encrypted pieces is leaked, it is possible to identify the source from which the decryption keys are leaked.

In other words, to cope with the illegitimate action of leaking key rings, the tracker 51 is able to assign the sequences to the nodes, not only for the purpose of avoiding the sequences that have already been used, but also for the purpose of identifying the source from which a key ring has been leaked. To achieve the latter purpose, it is possible to use a traceability (TA) code described in a reference document by J. Staddon, D. R. Stinson, and R. Wei, “Combinatorial properties of frameproof and traceability codes”, the Institute of Electrical and Electronics Engineers (IEEE) Transactions on Information Theory 47(3): pp. 1042-1049 (2001). For example, in the case where a code word in the TA code assigned to a node is expressed as w=(i1 i2 . . . iN′) (where i1, i2, . . . , and iN′ are each a symbol constituting the code word), an encrypted piece E(K(i1,1))[C1], E(K(i2,2))[C2], . . . , E(K(iN′,N′))[CN′] is stored into the node.

If a key ring is leaked, by identifying the sequence that corresponds to the key ring, (i.e., the corresponding code word), it is possible to identify the node to which the sequence has been assigned by the tracker 51. Thus, as a result, it is possible to inhibit legitimate use of the content.

In the second embodiment described above, the connection destination information is not limited to the example described above. Another arrangement is acceptable in which the connection destination information contains the IP addresses and the port numbers of the seeders, instead of the URLs of the seeders. Yet another arrangement is acceptable in which the connection destination information contains sets each made up of an IP address and a port number of a seeder, in addition to the URLs of the seeders.

In the second embodiment described above, another arrangement is acceptable in which the seeder information contains the indexes of the encrypted pieces and hash values of the encrypted pieces. FIG. 23 is a drawing of an example of the seeder information according to the present modification example. In FIG. 23, sets each made up of an IP address and a port number of a different one of the nodes are shown as the connection destination information. The indexes and the hash values of the encrypted pieces are shown as hash(E(K(i1,1))[C1]), hash(E(K(i2,2))[C2]), and hash(E(K(iN,N))[CN]).

In the second embodiment described above, in the case where the Torrent File contains the hash information of the encrypted pieces as explained in one of the modification examples of the first embodiment, the tracker 51 does not have to obtain the Torrent File identification information from the leecher 50.

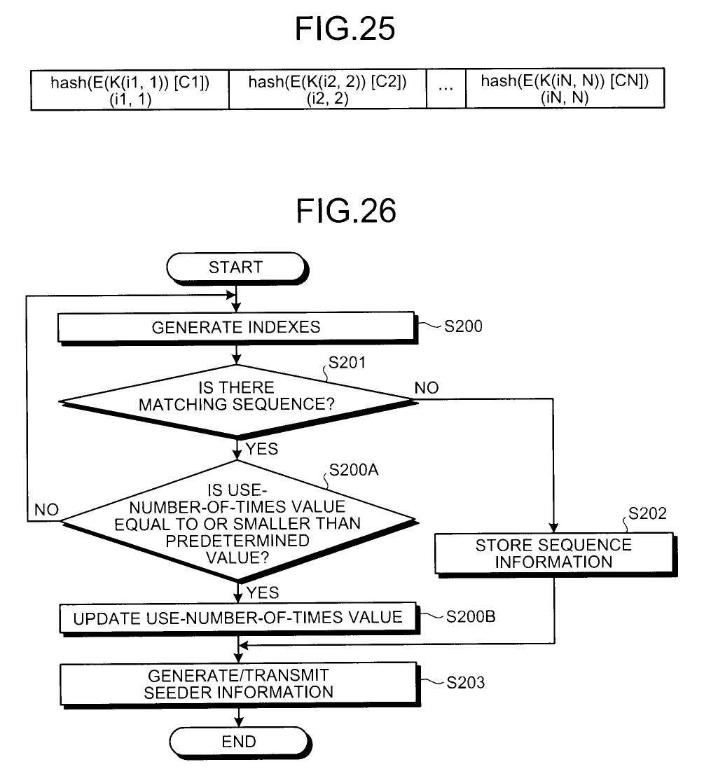

Further, in the second embodiment described above, the seeder information generated by the tracker 51 contains the connection destination information used for accessing the nodes; however, the seeder information does not necessarily have to contain the connection destination information. FIG. 24 is a drawing of an example of the seeder information according to the present modification example. In FIG. 24, only the indexes corresponding to the encrypted pieces are shown. In this configuration, it is sufficient if the leecher 50 obtains the node information as explained in the first embodiment from the tracker 51 and obtains the encrypted pieces based on the obtained node information. In this situation also, it is acceptable if the seeder information contains hash values. FIG. 25 is a drawing of an example of the seeder information that contains hash values but does not contain connection destination information.

Further, in the second embodiment described above, the tracker 51 stores, in the seeder database 512, the connection destination information in correspondence with the indexes of the decryption keys used for decrypting the encrypted pieces; however, the present invention is not limited to this example. The connection destination information itself does not necessarily have to be stored. The operation performed by the leecher 50 in this situation is the same as the one described above.

In the second embodiment described above, during the index generating process, it is not possible to use again the sequences that have already been used once; however, another arrangement is acceptable in which it is possible to use each of the sequences up to a predetermined number of times such as twice or more. In that situation, the authentication and key exchange processing unit 533 included in the key server 53 obtains, from the leecher 50, leecher identification information for identifying the leecher 50, during the mutual authentication process performed with the leecher 50. The sequence information comparing unit 535 stores, into the seeder database 512, the sequence information, the leecher identification information, and a use-number-of-times value that indicates how many times the sequence information indicating the generated sequence has been transmitted to the leecher 50 identified with the leecher identification information, while keeping these types of information in correspondence with one another. FIG. 26 is a flowchart of a procedure in the index generating process according to the present modification example. It is assumed that when the tracker 51 is accessed by the leecher 50 at Step S2 shown in FIG. 20, the tracker 51 has already obtained the leecher identification information from the leecher 50. The processes performed at Steps S200 through S201 are the same as those described above. In the case where the result of the judging process at Step S201 is in the affirmative, that is, in the case where the index database 513 has already stored therein sequence information indicating the sequence of the indexes generated at Step S200, the index database 513 refers to the use-number-of-times value that is stored in correspondence with the sequence information and the obtained leecher identification information and judges whether the use-number-of-times value is equal to or smaller than a predetermined value (Step S200A). In the case where the result of the judging process is in the affirmative, the index database 513 returns “0” to the index generating unit 510 and also updates the use-number-of-times value by incrementing, by one, the use-number-of-times value stored in correspondence with the sequence information and the leecher identification information (Step S200B). On the contrary, in the case where the result of the judging process at Step S201 is in the negative, the processes at Step S202 and thereafter are performed as described above. In the case where the result of the judging process at Step S200A is in the negative, the process returns to Step S200 so that a new sequence of indexes is generated.

With this arrangement, it is permitted to use the same sequence of encrypted pieces a plurality of times, instead of only once. Thus, it is possible to realize a more flexible content distributing process.

In the explanation above, the tracker 51 itself judges whether the sequence that has been generated by the index generating unit 510 has already been used; however, another arrangement is acceptable in which the tracker 51 does not perform this judging process. In that situation, in the same manner as described in the first embodiment, the key server 53 performs the comparing process at Step S14 after the process at Step S12 has been performed, so that it is possible to avoid using the same sequence again.

For example, in that situation, another arrangement is acceptable in which, with respect to each of the encrypted pieces of which the sequence is determined by the tracker 51, the leecher 50 obtains a plurality of mutually different encrypted pieces for the piece. For example, with respect to the piece C1, it is acceptable for the leecher 50 to obtain the encrypted pieces E(K(i1,1))[C1] and E(K(i1′,1))[C1] (where i1≠i1′, 1≦i1≦m, and 1≦i1′≦m are satisfied). With this arrangement, when the leecher 50 requests the key ring from the key server 53, if the sequence containing the index (i1,1) has already been used, the leecher 50 is not able to obtain the key ring corresponding to the sequence, but if the sequence containing the index (i1′,1) is usable, the leecher 50 is able to obtain the key ring corresponding to this sequence from the key server 53 without having to access the tracker 51 again. With this arrangement in which the leecher 50 obtains the extra encrypted piece in advance, the leecher 50 is able to prepare the plurality of sequence candidates in advance. Thus, the leecher 50 is able to avoid the trouble of having to access the tracker 51 again.

Further, in the description above, the tracker 51 determines the sequence of the encrypted pieces that correspond to all of the pieces C1 to CN that constitute the content; however, the present invention is not limited to this example. Another arrangement is acceptable in which the tracker 51 determines a sequence of only a part of the encrypted pieces. In that situation, it is sufficient if the remaining encrypted pieces of which the sequence is not determined by the tracker 51 are arbitrarily obtained by the leecher 50 from any of the other nodes, as described in the first embodiment. In that situation, it is acceptable for the key server 53 to perform the comparing process on the sequence as described above.

In that situation, during the comparing process, an arrangement is acceptable in which the key server 53 performs the comparing process only on such a part of the sequence other than the sequence corresponding to the part of encrypted pieces that has been determined by the tracker 51. In this situation, the sequence information storage unit 536 stores therein sequence information indicating such a part of the sequence other than the part of the sequence determined by the tracker 51. It is assumed that, for example, the Torrent File defines in advance which ones of the encrypted pieces corresponding to the pieces C1 to CN are included in the part of the sequence determined by the tracker 51. During the comparing process, the sequence information comparing unit 535 included in the key server 53 compares the index information contained in the request message with the sequence information stored in the sequence information storage unit 536, with regard to such a part of the sequence other than the part of the sequence determined by the tracker 51.

With this arrangement, it is possible to reduce the amount of information stored in the sequence information storage unit 536. Also, it is possible to reduce the amount of information used in the comparing process. Thus, it is possible to reduce the processing load of the key server 53.

Further, in the second embodiment described above, the index database 513 is included in the tracker 51; however, the present invention is not limited to this example. Another arrangement is acceptable in which the index database 513 is included in a database server connected to the tracker 51. In this configuration, the index generating unit 510 included in the tracker 51 refers to the sequence stored in the index database 513 via the database server.

Next, a third embodiment of the content distribution system according to the present invention will be explained. Parts of the third embodiment that are the same as the first embodiment or the second embodiment will be explained by using the same reference characters or will be omitted from the explanation.

The configuration of the content distribution system according to the third embodiment is different from the configuration of the content distribution system according to the first embodiment or the second embodiment in the following: In the content distribution system according to the third embodiment, an example will be explained in which a specific encrypted piece (e.g., an encrypted piece corresponding to the piece C1) is distributed from the key server 53 to the leecher 50. In the present example, let us assume that the encrypted pieces are generated as shown in FIG. 6. The file information contained in the Torrent File according to the third embodiment includes no information indicating what encrypted pieces correspond to the piece C1.

In this configuration, when the leecher 50 transmits the request message to the key server 53 to request the key ring, the leecher 50 puts the leecher identification information for identifying the leecher 50 into the request message and transmits the request message. The request message does not necessarily have to contain the index information. Alternatively, it is also acceptable if the request message indicates a sequence of the indexes of all the pieces except for the specific encrypted piece (e.g., a sequence of the indexes of the pieces C2 to CN, if the specific encrypted piece is the encrypted piece corresponding to the piece C1).

The key storage unit 534 included in the key server 53 stores therein the encrypted piece corresponding to the piece C1, in addition to the decryption keys. The sequence information storage unit 536 stores therein leecher identification information of the leechers 50 to which key rings have been transmitted from the key server 53 in the past, in correspondence with the sequence information. The sequence information comparing unit 535 judges whether the leecher identification information transmitted from the leecher 50 is stored in the sequence information storage unit 536 and determines whether the key ring and the specific encrypted piece should be transmitted according to the result of the judging process. The key supplying unit 537 transmits the key ring and the encrypted piece to the leecher 50, according to the result of the determining process performed by the sequence information comparing unit 535.

Next, a procedure in a content distributing process performed in the content distribution system according to the third embodiment will be explained, with reference to FIG. 12. The processes performed at Steps S1 through S13 are the same as those according to the first embodiment. However, because the Torrent File obtained by the leecher 50 at Step S1 contains no information related to the encrypted piece corresponding to the piece C1, the leecher 50 has obtained the encrypted pieces that correspond to the pieces C1 to CN, respectively. At Step S10, the leecher 50 puts the leecher identification information for identifying the leecher 50 into the request message for requesting the key ring and transmits the request message to the key server 53. At Step S14, the key server 53 performs a comparing process described below:

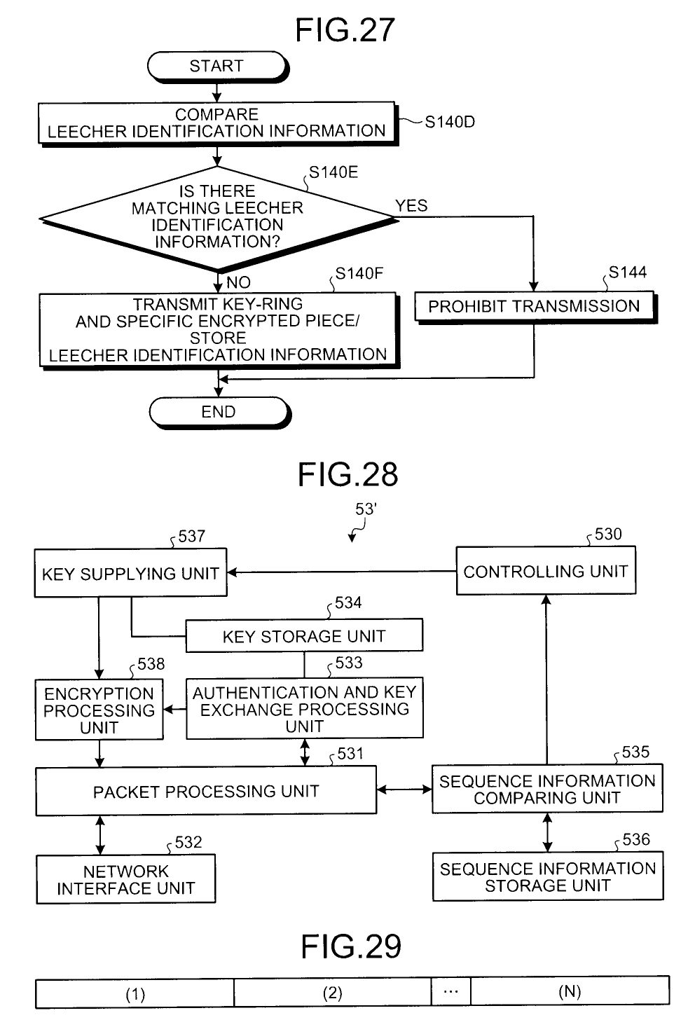

FIG. 27 is a flowchart of a procedure in the comparing process according to the third embodiment. The sequence information comparing unit 535 included in the key server 53 compares the leecher identification information contained in the request message with the leecher identification information stored in the sequence information storage unit 536 (Step S140D) and judges whether the sequence information storage unit 536 has already stored therein the same leecher identification information (Step S140E). In the case where the result of the judging process is in the negative, the sequence information comparing unit 535 determines that the key ring {K(i1,1), K(1,2), . . . , K(1,N)} that corresponds to the leecher identification information and the encrypted piece E(K(i1,1))[C1] that corresponds to the piece C1 should be transmitted. After that, the sequence information comparing unit 535 instructs, via the controlling unit 530, the key supplying unit 537 to transmit the key ring and the encrypted piece to the leecher 50. Also, the sequence information comparing unit 535 stores the leecher identification information into the sequence information storage unit 536. The key supplying unit 537 reads, out of the key storage unit 534, the key ring and the encrypted piece of which the transmission has been instructed by the sequence information comparing unit 535 via the controlling unit 530 and transmits the key ring and the encrypted piece that have been read to the leecher 50 via the network interface unit 532 (Step S140F). On the contrary, in the case where the result of the judging process at Step S140E is in the affirmative, that is, in the case where the key ring was transmitted from the key server 53 to the leecher 50 in the past, the sequence information comparing unit 535 determines that the key ring and the encrypted piece should not be transmitted and instructs, via the controlling unit 530, the key supplying unit 537 that the transmission of the key ring to the leecher 50 is prohibited (Step S144). The processes at Step S15 and thereafter are the same as those according to the first embodiment.

With this arrangement in which the specific encrypted piece is distributed from the key server 53, it is possible to allow the leechers 50 to obtain the encrypted pieces that are arranged in mutually different sequences, without causing the leechers 50 to access the tracker 51 again. Thus, the leechers 50 are able to avoid the trouble of accessing the tracker 51 again.

At Step S140F above, it is acceptable to perform the process of replacing the encrypted piece as explained in one of the modification examples of the first embodiment above. For example, let us discuss a situation in which the leecher 50 has obtained the encrypted content E(K(i2,2))[C2], E(K(i3,3))[C3], . . . , E(K(iN,N))[CN] and has requested the corresponding key ring from the key server 53. In the case where the sequence information storage unit 536 has already stored therein the sequence {(i2,2), (i3,3), . . . , (iN,N)} corresponding to the key ring requested by the leecher 50 (i.e., the result of the judging process performed by the sequence information comparing unit 535 is in the affirmative), the key server 53 generates another sequence {(i2′,2), (i3,3), . . . , (iN,N)} that is not stored in the sequence information storage unit 536 and transmits, to the leecher 50, an encrypted piece E(K(i2′,2))[C2] with which the leecher 50 should replace the other encrypted piece and information related to the index (i.e., in the present example, (i2′,2)). In addition, the key server 53 transmits, to the leecher 50, a key ring that contains the decryption keys that corresponds to the sequence {(i1,1), (i2′,2), (iN,N)} and the encrypted piece E(K(i1,1))[C1] that corresponds to the piece C1. On the contrary, in the case where the sequence information storage unit 536 has not yet stored therein the sequence {(i2,2), (i3,3), . . . , (iN,N)} corresponding to the key ring requested by the leecher 50 (i.e., the result of the judging process performed by the sequence information comparing unit 535 is in the negative), the key server 53 may or may not perform the replacing process explained above.

In the third embodiment described above, the specific encrypted piece does not necessarily have to be the encrypted piece corresponding to the piece C1. The number of specific encrypted pieces does not necessarily have to be one, either. For example, it is acceptable to use, as the specific encrypted piece, an encrypted piece defined by using the TA code disclosed in the reference document cited in the second embodiment. For example, in the case where a code word in the TA code assigned to a node is expressed as w=(i1 i2 . . . iN′), it is acceptable if an encrypted piece E(K(i1,1))[C1], E(K(i2,2))[C2], . . . , E(K(iN′,N′))[CN′] is transmitted from the key server 53 to the node, as the specific encrypted piece.

Further, the specific encrypted piece does not necessarily have to be distributed to the leecher 50 by the key server 53. It is also acceptable if the specific encrypted piece is distributed by the tracker 51, the sales server 54, or a reliable third-party server. In that situation, the key server 53 transmits only the key ring to the leecher 50 at Step S140F.

In the third embodiment described above, the encrypted piece and the leecher identification information do not necessarily have to be stored in the key storage unit 534 and the sequence information storage unit 536, respectively. For example, another arrangement is acceptable in which the key server 53 further includes mutually different storage units so that the encrypted piece and the leecher identification information can be stored in these storage units, respectively.

In the third embodiment described above, the specific encrypted piece is transmitted from the key server 53 to the leecher 50. However, the present invention is not limited to this example. Another arrangement is acceptable in which the key server 53 specifies the index of the specific encrypted piece (e.g., the value of i1 in the index (i1,1) corresponding to the piece C1, in the example above) and causes another node, the sales server 54, or a separately-provided dedicated server to transmit the encrypted piece E(K(i1,1))[C1] that corresponds to the index to the leecher 50. Yet another arrangement is acceptable in which the key server 53 does not specify the index, but another node, the sales server 54, or a separately-provided dedicated server specifies the index of the specific encrypted piece so that the dedicated server transmits the encrypted piece corresponding to the specified index to the leecher 50.

Next, a fourth embodiment of the content distribution system according to the present invention will be explained. Parts of the fourth embodiment that are the same as any of the first through the third embodiments will be explained by using the same reference characters or will be omitted from the explanation.

In the fourth embodiment, it is assumed that the file information contained in the Torrent File includes hash values {hash(E(K(i,j))[Cj]} (where 1≦i≦m and 1≦j≦N are satisfied) that are calculated through a hash calculation process by using the encrypted pieces, as explained in one of the modification examples of the first embodiment (see FIG. 14). In the first through the third embodiments, the piece information transmitted from the seeder 52 to the leecher 50 indicates the sequence of the encrypted pieces stored in the seeder 52, as shown in FIG. 7. According to the fourth embodiment, however, of the indexes (i,j) of the encrypted pieces stored in the seeder 52, the piece information indicates only the indexes j used for distinguishing the pieces C1 to CN from one another, as shown in FIG. 29.

In the following section, each of the indexes j used for distinguishing the pieces C1 to CN from one another will be referred to as a “piece index”. Each of the indexes i that offer variations according to the number of decryption keys will be referred to as a “variation index”. A set (i,j) made up of a piece index and a variation index will be simply referred to as an “index”. With regard to a piece that corresponds to a piece index j, in the case where there are two or more encrypted pieces that are obtained by encrypting the piece with mutually different two or more encryption keys, a set including these encrypted pieces will be referred to as an “encrypted piece string j”, as necessary.

In this configuration, when the content obtaining unit 500 included in the leecher 50 has obtained an encrypted piece, based on the piece information as described above, the content obtaining unit 500 performs a process to identify the variation index i with respect to the encrypted piece. More specifically, the content obtaining unit 500 calculates a hash value through a hash calculation process by using the encrypted piece, refers to the file information contained in the Torrent File, and identifies the variation index i that corresponds to the piece index j of the encrypted piece, within the index (i,j) that corresponds to the hash value.

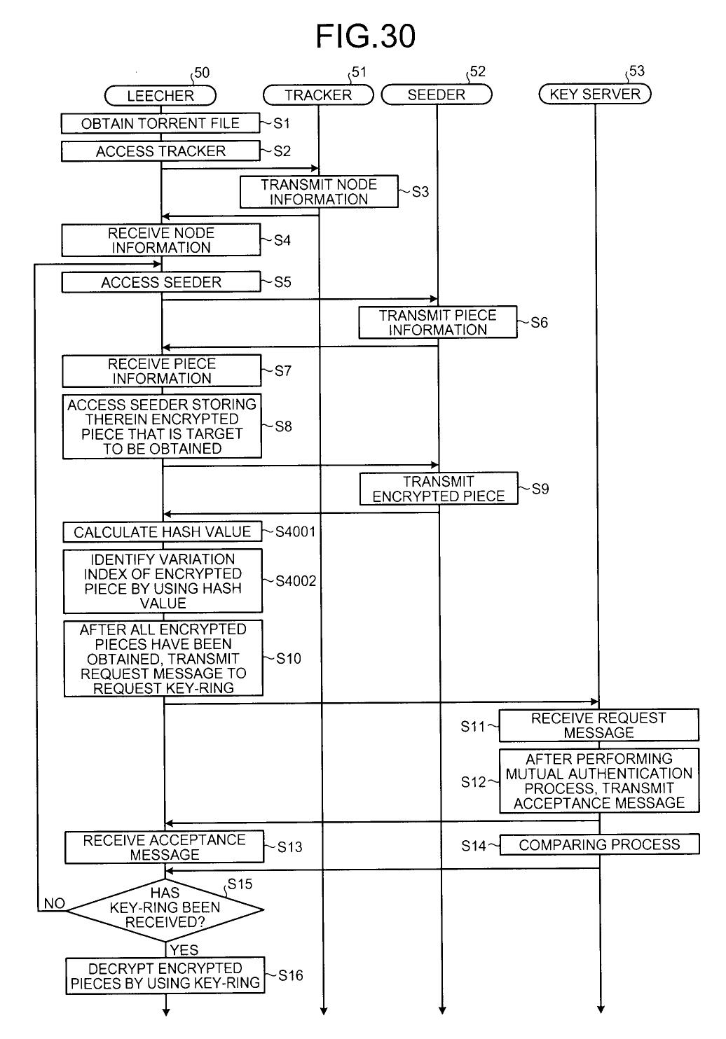

Next, a procedure in a content distributing process performed in the content distribution system according to the fourth embodiment will be explained, with reference to FIG. 30. The processes performed at Steps S1 through S5 are the same as those according to the first embodiment. At Step S6, when being accessed by the leecher 50, the seeder 52 transmits piece information that indicates the piece indexes of the encrypted pieces stored therein to the leecher 50, as shown in FIG. 29. At Step S7, the leecher 50 receives the piece information. At Step S8, the leecher accesses at least one seeder 52 by using the piece information, transmits a piece request to the seeder 52 to request, for each of the pieces C1 to CN, at least one of the plurality of encrypted pieces that can possibly exist, and receives the encrypted pieces. In response to the piece request from the leecher 50, the seeder 52 transmits the encrypted piece stored therein to the leecher 50 (Step S9). In this situation, the indexes indicated in the piece information that the leecher 50 has received by accessing the seeder 52B contains no variation index. Thus, by using the piece information that the leecher 50 has received by accessing the seeder 52B, the leecher 50 judges, for example, whether the seeder 52B stores therein any of the encrypted pieces E(K(i1,1))[C1] (where i1 is an integer that satisfies 1≦i1≦m) that are obtained by encrypting the piece C1. In the case where the result of the judging process is in the affirmative, the leecher 50 accesses the seeder 52B and obtains one of the encrypted pieces that are obtained by encrypting the piece C1, by receiving it from the seeder 52B. On the contrary, in the case where the seeder 52B actually does not store therein any of the encrypted pieces obtained by encrypting the piece C1, the leecher 50 further accesses another seeder 52 (e.g., the seeder 52C) and obtains piece information from the other seeder (e.g., the seeder 52C). After that, in the same manner as described above by using the piece information the leecher 50 judges whether the seeder 52C stores therein the encrypted piece. In the case where the result of the judging process is in the affirmative, the leecher 50 accesses the seeder 52C and attempts to obtain the encrypted piece.

After that, at Step S4001, the leecher 50 calculates a hash value of the received encrypted piece. Subsequently at Step S4002, the leecher 50 refers to the Torrent File as shown in FIG. 14 and identifies a variation index i corresponding to the piece index j of the encrypted piece, out of the index (i,j) corresponding to the hash value. The process performed at Step S10 is the same as the one in the first embodiment. Like in the first embodiment, the request message transmitted by the leecher 50 to the key server 53 contains the index information {(i1,1), . . . , (iN,N)} that indicates the sequence corresponding to the decryption keys.

Each of the variation indexes i1, . . . , iN in the indexes (i1,1), . . . , (iN,N) corresponding to the decryption keys is identified every time the process at Step S4001 is performed. The processes performed at Steps S11 through S16 are the same as those according to the first embodiment.

In this configuration described above, it is not possible to identify the variation index i of each of the encrypted pieces stored in the seeder 52 before the leecher 50 receives each of the encrypted pieces. With this arrangement, for example, it is possible to inhibit the leecher 50 from attempting to obtain the encrypted piece corresponding to a certain index (i,j) for which the decryption key has been leaked. In addition, as for each of the obtained encrypted pieces, it is possible to identify the variation index thereof, based on the hash value and the Torrent File. Thus, the leecher 50 is able to obtain, like in the first embodiment, the key ring containing the decryption keys used for decrypting the obtained encrypted pieces from the key server 53.

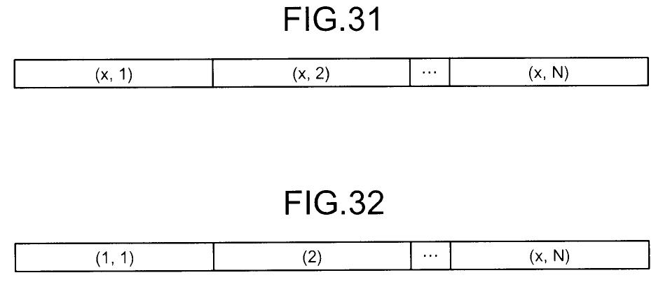

In the fourth embodiment described above, the indexes indicated in the piece information are not limited to the example shown in FIG. 29. For example, another arrangement is acceptable in which the indexes include variation indexes as shown in FIG. 31. In that situation, it is acceptable to use an index of which the value is not identifiable (e.g., an “x” in the present example) as each of the variation indexes i. Alternatively, as shown in FIG. 32, another arrangement is acceptable in which each of some of the indexes indicated in the piece information contains a variation index i, while each of the other indexes does not contain a variation index i.

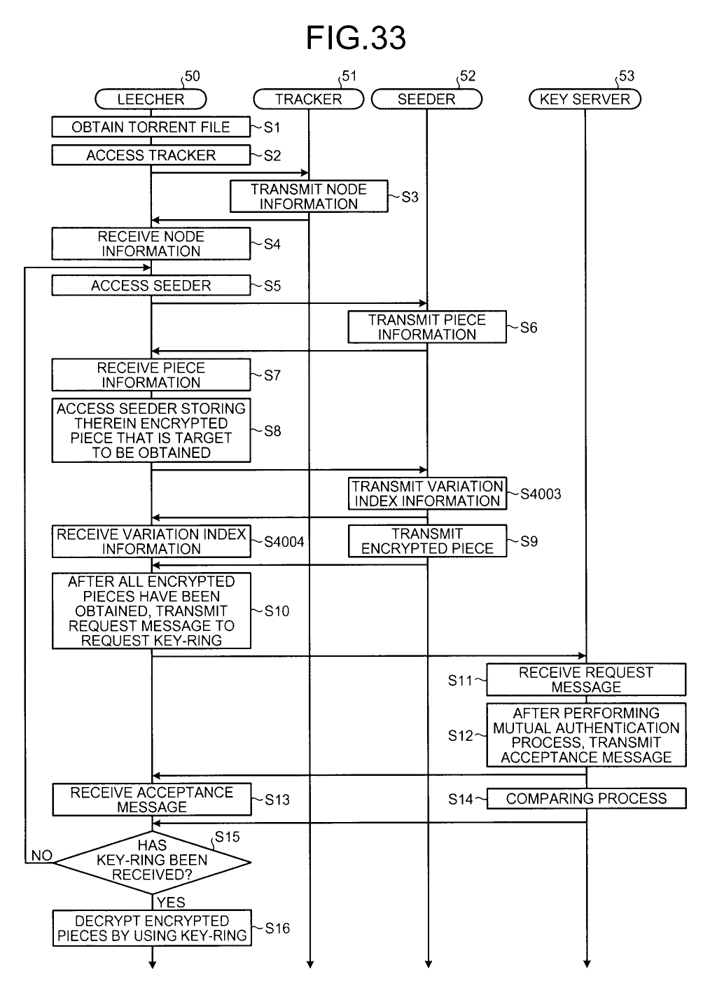

In the fourth embodiment described above, another arrangement is acceptable in which, when transmitting the encrypted piece to the leecher 50, the seeder 52 transmits, to the leecher 50, variation index information indicating the variation index of the encrypted piece, separately from the piece information. In that situation, the leecher 50 does not need to calculate the hash value of the encrypted piece, unlike the example described above Thus, the file information contained in the Torrent File does not need to include the hash value of each of the encrypted pieces. FIG. 33 is a flowchart of a procedure in the content distributing process according to the present modification example. The processes performed at Steps S1 through S8 are the same as those according to the first embodiment. At Step S4003, the seeder 52 transmits, to the leecher 50, variation index information indicating the variation index of the encrypted piece that is the target to be transmitted to the leecher 50. At Step S4004, the leecher 50 receives the variation index information. After that, the processes performed at Steps S9 through S16 are the same as those according to the first embodiment. Another arrangement is acceptable in which the processes at Steps S4003 through S4004 are performed after the process at Step S9 has been performed.

In this configuration described above, it is possible to make it easy for the leecher 50 to identify the variation indexes of the encrypted pieces and also to inhibit the leecher 50 from attempting to obtain the encrypted piece corresponding to, for example, an index (i,j) for which the decryption key has been leaked.

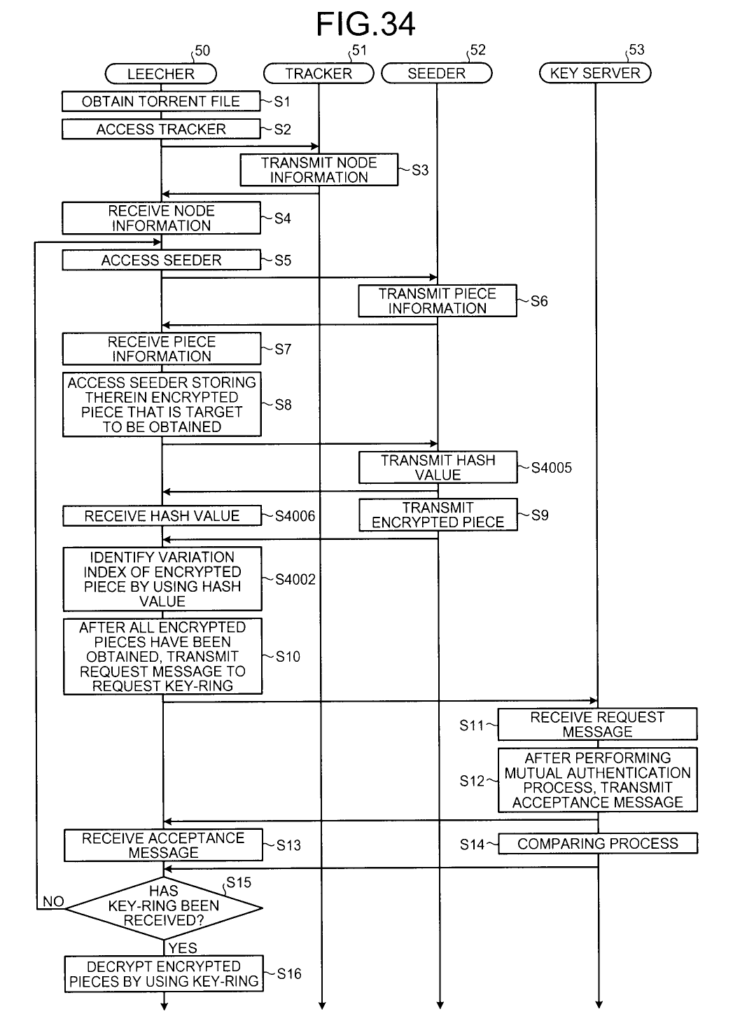

In the fourth embodiment described above, another arrangement is acceptable in which, when transmitting the encrypted piece to the leecher 50, the seeder 52 transmits the hash value of the encrypted piece to the leecher 50. In that situation also, the leecher 50 does not need to calculate the hash value of the encrypted piece, unlike the example described above. The file information contained in the Torrent File includes the hash values of the encrypted pieces, like in the fourth embodiment described above. FIG. 34 is a flowchart of a procedure in the content distributing process according to the present modification example. The processes performed at Steps S1 through S8 are the same as those according to the first embodiment. At Step S4005, the seeder 52 transmits, to the leecher 50, the hash value of the encrypted piece that is the target to be transmitted to the leecher 50. At Step S4006, the leecher 50 receives the hash value. After that, the processes performed at Steps S9, S4002, and S10 through S16 are the same as those according to the fourth embodiment. Another arrangement is acceptable in which the processes at Steps S4005 through S4006 are performed after the process at Step S9 has been performed.

In this configuration as described above, instead of directly informing the leecher 50 of the variation index of the encrypted piece, the seeder 52 informs the leecher 50 of the hash value. Thus, it is possible to allow the leecher 50 to identify the variation index of the encrypted piece without increasing the processing load on the leecher 50.

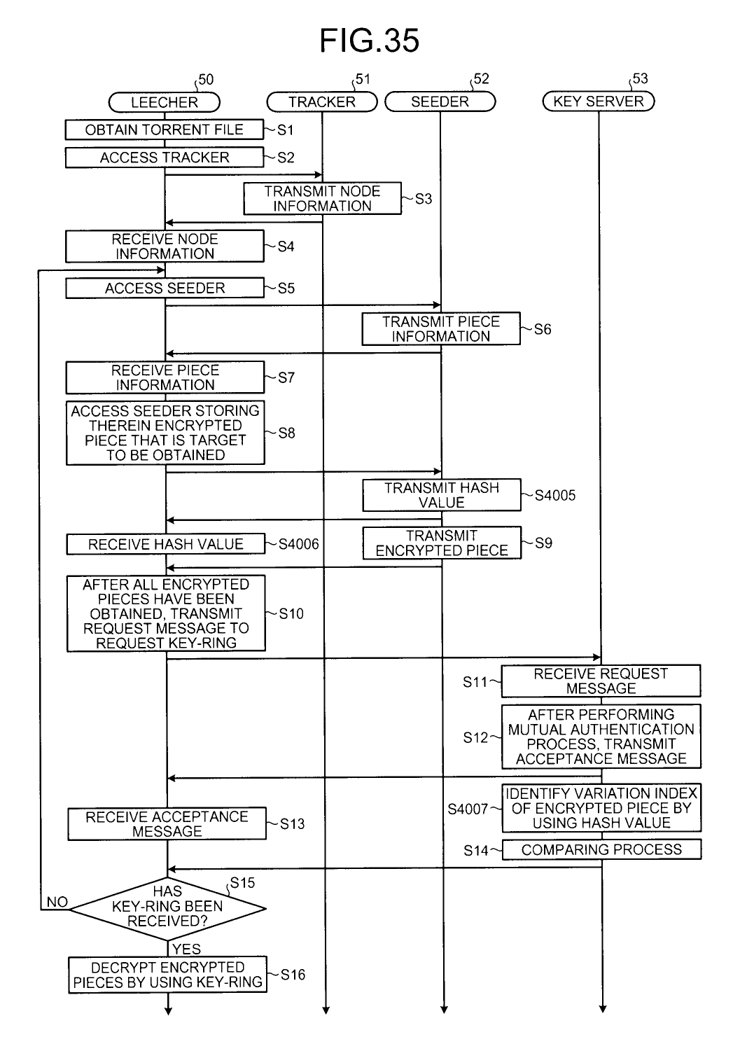

In the case where the seeder 52 transmits the hash value of the encrypted piece to the leecher 50, another arrangement is acceptable in which, instead of the leecher 50, the key server 53 identifies the variation index of the encrypted piece. In other words, it is acceptable if the process corresponding to Step S4002 is performed by the key server 53. FIG. 35 is a flowchart of a procedure in the content distributing process according to the present modification example. The processes performed at Steps S1 through S8 are the same as those according to the first embodiment. After the processes at Steps S4005 through S4006 have been performed, the leecher 50 transmits, at Step S10, a request message containing the hash value to the key server 53, as the request message for requesting the key ring that contains the decryption keys used for decrypting the encrypted pieces. When the hash value of the encrypted piece obtained by encrypting a piece Cj is expressed as Hj, the request message contains, for example, {(1,1), ((X,2),H2), . . . , ((N),HN)} as the index information. The index (1,1) contained in the index information indicates that the variation index “1” is identified with respect to the piece C1. The index ((X,2),H2) indicates that no variation index is identified but the hash value H2 is indicated with respect to the piece C2. The index ((N),HN) indicates that no variation index is identified, but the hash value HN is indicated with respect to the piece CN.

After that, at Step S11, in the case where the key server 53 has received the request message that contains the hash value as described above, after performing the process at Step S12, subsequently at Step S4007 the key server 53 identifies the variation index of the encrypted piece, by referring to the Torrent File as shown in FIG. 14 with respect to the index of which the hash value is indicated, in the same manner as at Step S4002.

In this configuration as described above, the leecher 50 is able to obtain the decryption keys used for decrypting the encrypting pieces, without the leecher 50 itself having to identify the variation indexes of the encrypted pieces.

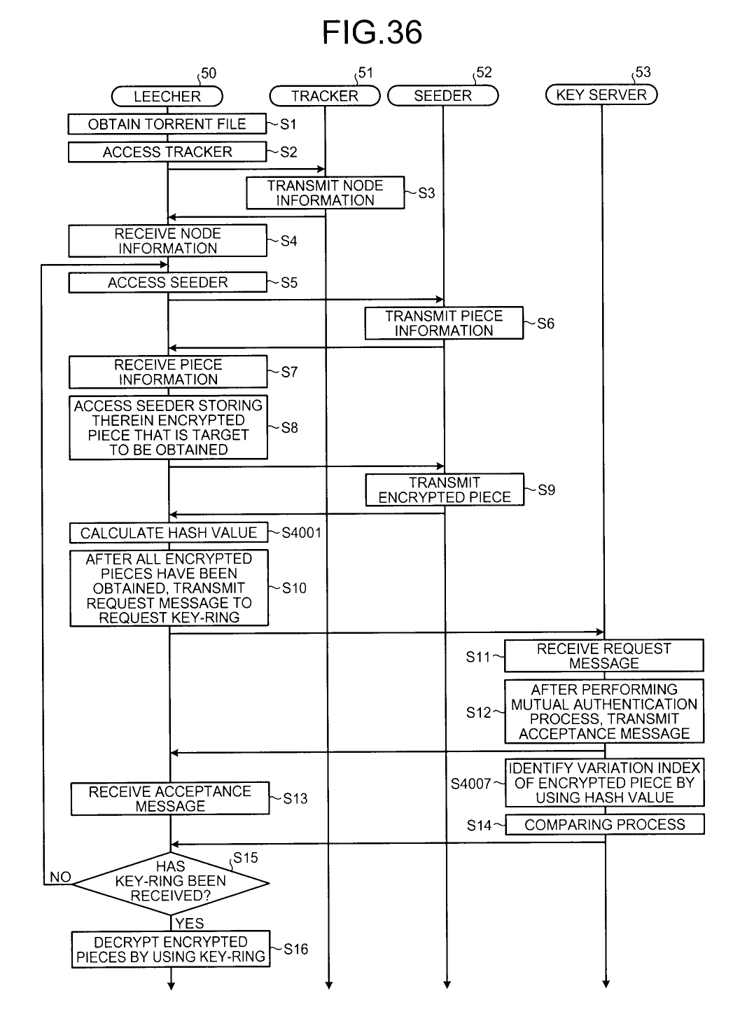

In the fourth embodiment described above, after the leecher 50 calculates the hash value of the encrypted piece, the leecher 50 performs the process of identifying the variation index of the encrypted piece; however, the present invention is not limited to this example. Another arrangement is acceptable in which the key server 53 performs this process. In that situation, the key server 53 obtains the Torrent File as shown in FIG. 14 in advance. FIG. 36 is a flowchart of a procedure in the content distributing process according to the present modification example. The processes performed at Steps S1 through S8 are the same as those according to the first embodiment. The process performed at Step S4001 is the same as the one according to the fourth embodiment. The processes performed at Steps S9 through S12 are the same as those according to the first embodiment. The processes performed at Step S4007 and thereafter are the same as the one according to one of the modification examples of the fourth embodiment described above.

In this configuration also, the leecher 50 is able to obtain the decryption keys used for decrypting the encrypted pieces, without the leecher 50 itself having to identify the variation indexes of the encrypted pieces.

Next, a fifth embodiment of the content distribution system according to the present invention will be explained. Parts of the fifth embodiment that are the same as any of the first through the fourth embodiments will be explained by using the same reference characters or will be omitted from the explanation.

According to the fifth embodiment, an example will be explained in which the leecher 50 requests an encrypted piece from the seeder 52 at a plurality of different times. In that situation, with respect to the one encrypted piece, the leecher 50 transmits a piece request (hereinafter, a “partial data request”) to request partial data (hereinafter, a “sub-piece”) that constitutes a part of the encrypted piece, from the seeder 52. The data length of each of the sub-pieces may be a predetermined length or may be a variable length. The number of sub-pieces that constitute each of the encrypted pieces is not limited. Each of the encrypted pieces may be constituted with a predetermined number of sub-pieces or may be constituted with a variable number of sub-pieces. The data length of each of the sub-pieces and the total number of sub-pieces that constitute each of the encrypted pieces may be specified in the content distribution system as initial values or may be specified in advance in the Torrent File. In the following section, it is assumed that the file information contained in the Torrent File includes the data length of each of the encrypted pieces, but does not necessarily have to include the hash values.

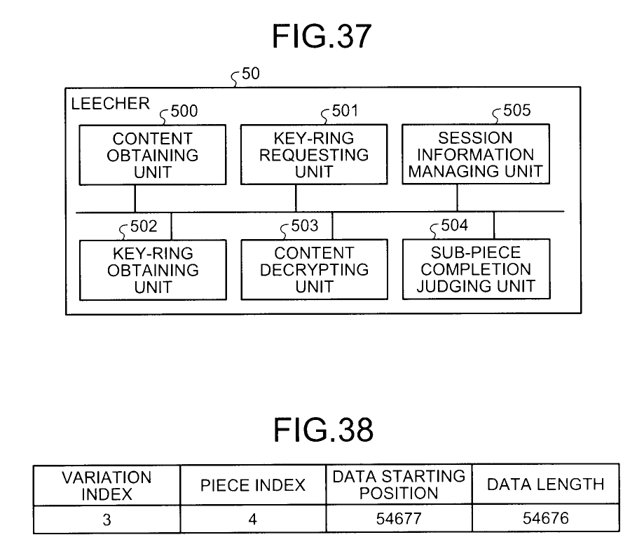

FIG. 37 is an exemplary functional diagram of the leecher 50 according to the fifth embodiment. The leecher 50 includes a sub-piece completion judging unit 504 and a session information managing unit 505, in addition to the content obtaining unit 500, the key ring requesting unit 501, the key ring obtaining unit 502, and the content decrypting unit 503 described above. It is assumed that, with respect to each of the encrypted pieces, the leecher 50 is able to request the entirety of the data thereof or the sub-pieces. The former situation is similar to the first embodiment described above. Thus, the latter situation will be explained below.

When transmitting a piece request to the seeder 52, the content obtaining unit 500 according to the fifth embodiment judges whether the data of the encrypted piece that is the target to be obtained has partially been obtained already. In the case where the content obtaining unit 500 has judged that the data has partially been obtained already, the content obtaining unit 500 generates a partial data request and transmits the generated partial data request to the seeder 52. The partial data request indicates, for example, a set (i,j) made up of a specified piece index and a specified variation index that specify the encrypted piece that is the target to be obtained and that has partially been obtained as well as sub-piece specifying information that specifies a sub-piece that constitutes partial data of the encrypted piece that has partially been obtained already. The sub-piece specifying information specifies a data range of the partial data (i.e., the sub-piece) of the encrypted piece that has partially been obtained already. The data range is specified by using, for example, an offset value expressed with a number of bytes or the like that indicates the starting position of the sub-piece, an offset value expressed with a number of bytes or the like that indicates the ending position of the sub-piece, the data length of the sub-piece, or a combination of any of these. FIG. 38 is a drawing of an example of a data structure of the piece request according to the fifth embodiment. In FIG. 38, the partial data request indicates a set made up of a specified piece index and a specified variation index, as well as the starting position and the data length of the sub-piece that serve as the sub-piece specifying information. The partial data request indicates that, of the data of the encrypted piece E(K(3,4))[C4] that corresponds to the index (3,4), the data having a data range of which the starting position is in the 54677th byte counted from the head position (i.e., the 0th byte) and that has a data length of 54676 bytes from the starting position is specified as the sub-piece that is the target to be obtained.

When transmitting a piece request to the seeder 52, in the case where the content obtaining unit 500 has judged the data of the encrypted piece that is the target to be obtained has not partially been obtained (i.e., none of the data of the encrypted piece has been obtained yet), the content obtaining unit 500 generates a piece request as described in the first embodiment and transmits the generated piece request to the seeder 52.

When the content obtaining unit 500 has obtained an encrypted piece or a sub-piece, the sub-piece completion judging unit 504 performs a completion judging process of judging whether the entirety of the data of the received encrypted piece or the encrypted piece partially constituted with the received sub-piece has already been obtained. The completion judging process is performed based on, for example, the data length or a data length calculated from the head position and the ending position of the partial data within the encrypted piece. In the present example, the sub-piece completion judging unit 504 performs the completion judging process by referring to an obtained amount indicated in session information (explained later) and the data length contained in the Torrent File. In the case where the sub-piece completion judging unit 504 has judged that, with respect to the encrypted piece that is the target of the judging process, the entirety of the data has already been obtained, and if the encrypted piece is constituted with a plurality of sub-pieces, the sub-piece completion judging unit 504 performs a completing process of completing the encrypted piece by putting together all the sub-pieces that constitute the encrypted piece.

On the contrary, in the case where the sub-piece completion judging unit 504 has judged that, with respect to the encrypted piece that is the target of the judging process, the entirety of the data has not yet been obtained, the sub-piece completion judging unit 504 refers to the session information (explained later), accesses the seeder 52 that has transmitted the one or more sub-pieces that constitute the encrypted piece, and transmits a partial data request to the seeder 52 via the content obtaining unit 500 to request one of the sub-pieces that have not yet been obtained (hereinafter, am “unobtained sub-piece”) among the sub-pieces that constitute the encrypted piece. The sub-piece completion judging unit 504 attempts to obtain the unobtained sub-piece via the content obtaining unit 500 in this manner. For example, the sub-piece completion judging unit 504 repeatedly performs the process of obtaining an unobtained sub-piece from the seeder 52 until all the sub-pieces that constitute the encrypted piece have been obtained.

The session information managing unit 505 generates the session information used for requesting again one of the unobtained sub-pieces from the seeder 52 that has previously transmitted the one or more of the sub-pieces and stores the generated session information therein. The session information indicates, for example, seeder identifying information and an obtained amount. The seeder identifying information is information that identifies the seeder 52 that has previously transmitted the one or more of the sub-pieces. The seeder identifying information may be, for example, the IP address and the port number of the seeder 52, the MAC address of the seeder 52, the subscriber's ID as described above, or a combination of any of these. The obtained amount indicates the amount of data of the encrypted piece that has already been obtained. The obtained amount may be, for example, a data length calculated from the head position of the data and the ending position of the obtained partial data within the encrypted piece, a total of the data lengths of the sub-pieces that have already been obtained among the sub-pieces that constitute the encrypted piece, or the number of sub-pieces that have already been obtained.

The seeder 52 reads the sub-piece that has been requested in the partial data request out of an external storage device and transmits the read sub-piece to the leecher 50. In the case where the seeder 52 has received the partial data request as shown in FIG. 38, the seeder 52 transmits the data having the specified data range, out of the encrypted piece corresponding to the specified piece index and the specified variation index indicated in the partial data request.

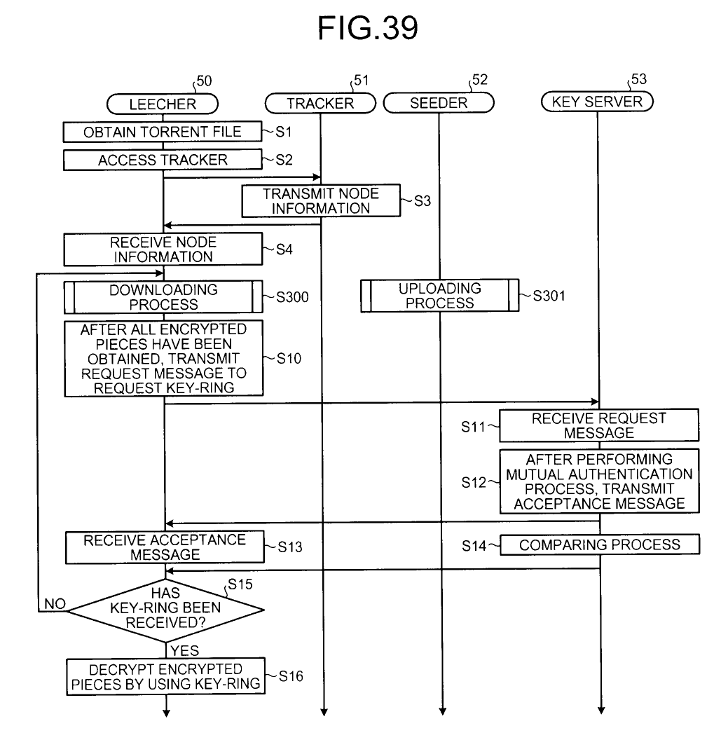

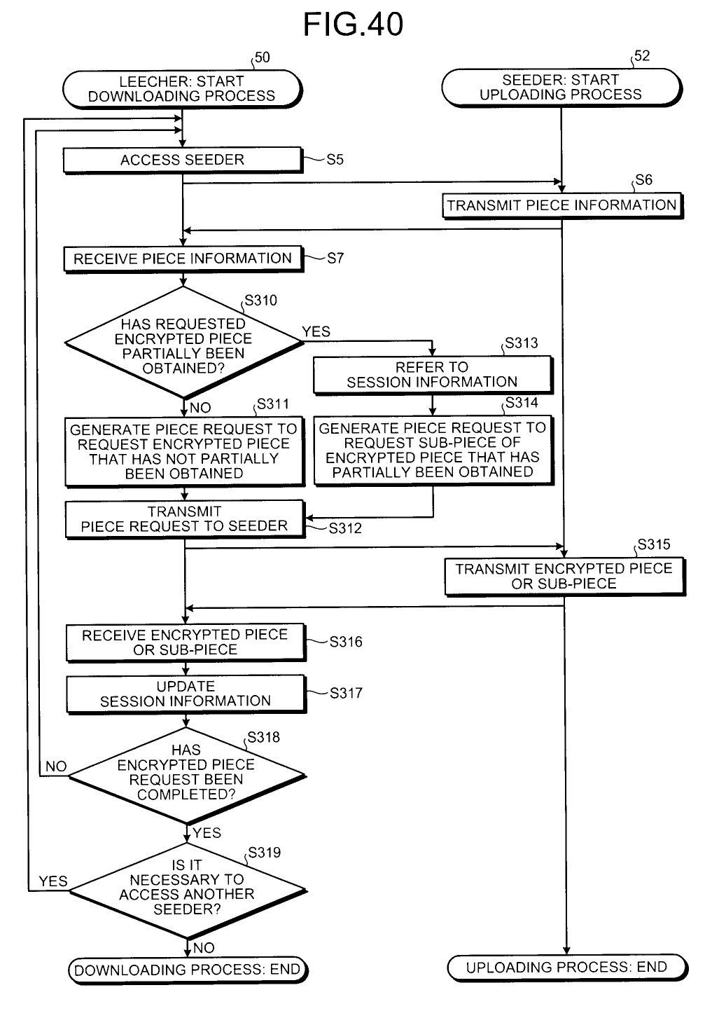

Next, a procedure in a content distributing process performed in the content distribution system according to the fifth embodiment will be explained, with reference to FIG. 39. The processes performed at Steps S1 through S4 are the same as those according to the first embodiment. At Step S300, the leecher 50 performs a downloading process to download the encrypted piece. On the other hand, the seeder performs an uploading process to upload the encrypted piece at Step S301. FIG. 40 is a flowchart of a detailed procedure in the downloading process and the uploading process. The processes performed at Steps S5 through S7 are the same as those according to the first embodiment. When transmitting a piece request to the seeder 52, the leecher 50 judges, at Step S310, whether the data of the encrypted piece that is the target to be obtained has partially been obtained already. In the case where the leecher 50 has judged that the data has partially been obtained already (Step S310: Yes), the leecher 50 refers to the seeder identifying information contained in the session information (Step S313) and identifies the seeder 52 that has previously transmitted one or more of sub-pieces that constitute the encrypted piece that is the target to be obtained. The leecher 50 further generates a partial data request as shown in FIG. 38 as a piece request (Step S314) and transmits the generated partial data request to the seeder 52 (Step S312). On the contrary, in the case where the leecher 50 has judged that the data of the encrypted piece that is the target to be obtained has not partially been obtained (i.e., none of the data of the encrypted piece has been obtained yet) (Step S310: No), the leecher 50 generates a piece request as explained in the description of the first embodiment (Step S311) and transmits the generated piece request to the seeder 52 (Step S312).

On the other hand, when the seeder 52 has received the piece request transmitted at Step S312, the seeder 52 reads the encrypted piece or the sub-piece that corresponds to the piece request out of an external storage device and transmits the encrypted piece or the sub-piece that has been read to the leecher 50 (Step S315). When the leecher 50 has received the encrypted piece or the sub-piece (Step S316), the leecher 50 updates the obtained amount in the session information (Step S317). After that, the leecher 50 judges whether the piece request has been completed (Step S318). In the present example, in the case where the leecher 50 has received a sub-piece at Step S312, the leecher 50 compares the obtained amount indicated in the session information with the data length contained in the Torrent File, with respect to the encrypted piece that is partially constituted with the sub-piece. In the case where the obtained amount and the data length match, the leecher 50 judges that the entirety of the data of the encrypted piece has been obtained and judges that the piece request has been completed (Step S318: Yes). After that the leecher 50 performs the completing process of completing the encrypted piece by putting together all the sub-pieces that constitute the encrypted piece. Subsequently, the leecher 50 judges whether the leecher 50 should receive another encrypted piece by accessing another seeder 52 (Step S319). In the case where the result of the judging process is in the affirmative, the process returns to Step S5 where the leecher 50 accesses another seeder 52. On the contrary, in the case where the result of the judging process at Step S319 is in the negative, the process ends.

On the other hand, in the case where the obtained amount indicated in the session information and the data length contained in the Torrent File do not match at Step S318, the leecher 50 judges that the entirety of the data of the encrypted piece has not yet been obtained and that the piece request has not been completed (Step S318: No). In that situation, the process returns to Step S5 where the leecher 50 refers to the session information and accesses again the seeder 52 that has previously transmitted one or more of the sub-pieces that constitute the encrypted piece. In the processes thereafter, the leecher 50 generates a partial data request for requesting one of the unobtained sub-piece among the sub-pieces that constitute the encrypted piece and transmits the generated partial data request to the seeder 52. The leecher 50 repeatedly performs the process of obtaining an unobtained sub-piece from the seeder 52, until all the sub-pieces that constitute the encrypted piece have been obtained.

After performing the process at Step S311, in the case where the leecher 50 receives an encrypted piece at Step S316, there is a possibility that the leecher 50 may not be able to receive the entirety of the data of the encrypted piece for some reason. In that situation also, like the example in which the leecher 50 receives a sub-piece at Step S315, the leecher 50 judges, at Step S318, whether the piece request has been completed by comparing the obtained amount indicated in the session information with the data length contained in the Torrent File. In the case where the leecher 50 has judged that the piece request has not been completed, the process returns to Step S5 where the leecher 50 refers to the session information and accesses again the seeder 52 that has transmitted the encrypted piece. In the processes thereafter, the leecher 50 generates a partial data request for requesting the unobtained part of the data of the encrypted piece (treated in the same manner as an unobtained sub-piece) and transmits the generated partial data request to the seeder 52. The processes performed thereafter are the same as those described above. On the other hand, in the case where the leecher 50 has judged at Step S318 that the piece request has been completed in one receiving process, the leecher 50 performs the process at Step S319 described above.

Returning to the description of FIG. 39, when the leecher 50 has obtained the entirety of the data for all of the encrypted pieces that respectively correspond to the pieces constituting the content and that constitute the encrypted content, the leecher 50 performs the processes at Step S10 and thereafter, in the same manner as described in the first embodiment.

In the configuration described above, the leecher 50 is able to obtain the necessary data with respect to the encrypted piece that has partially been obtained by the leecher 50. Thus, the leecher is able to complete each of the encrypted pieces more quickly. Because the leecher 50 is able to share each of the encrypted pieces with other leechers, the level of distribution efficiency is expected to improve.

In the fifth embodiment described above, an arrangement is acceptable in which, when the seeder 52 transmits a sub-piece, the seeder 52 transmits a part of the data of the sub-piece, instead of the entirety of the data of the sub-piece requested in the partial data request. Another arrangement is acceptable in which the seeder 52 transmits information that identifies the sub-piece, together with the sub-piece transmitted to the leecher 50. It is acceptable if the information that identifies the sub-piece is information that is similar to or the same as the information used for specifying a sub-piece described above. Further, in the case where a plurality of sub-pieces are transmitted all at once, even if the sub-pieces are to be serially arranged within one encrypted piece, an arrangement is acceptable in which the information for identifying each of the sub-pieces is transmitted together with the sub-pieces. Another arrangement is acceptable in which information showing how many sub-pieces are being transmitted is transmitted together with the sub-pieces.

Further, yet another arrangement is acceptable in which, in the case where the piece request has requested the entirety of the data of an encrypted piece, the seeder 52 transmits information indicating that, instead of sub-pieces, the entirety of the data of the encrypted piece is to be transmitted, together with the encrypted piece.

In addition, yet another arrangement is acceptable in which, when the seeder 52 has received, from the leecher 50, a piece request (hereinafter, the “new piece request”) requesting an encrypted piece or a sub-piece, the seeder 52 rejects or suspends the request in the new piece request depending on the data amount of an encrypted piece or a sub-piece of which the transmission has not been completed and that had previously been requested in another piece request (hereinafter, the “previous piece request”) that was received before the new piece request was received. More specifically, for example, an arrangement is acceptable in which the seeder 52 counts the number of encrypted pieces or sub-pieces of which the transmission is ongoing and has not yet been completed and that had been requested in the previous piece request or the number of previous piece requests of which the transmissions have not yet been completed. In the case where the counted value is equal to or larger than a threshold value, the seeder 52 rejects the request in the new piece request. Alternatively, another arrangement is acceptable in which the seeder 52 suspends the request in the new piece request until the seeder 52 has completed some or all of the ongoing transmissions so that the number of encrypted pieces or sub-pieces that are being transmitted in response to the previous piece request that is currently processed becomes smaller than a threshold value.

Further, yet another arrangement is acceptable in which, every time the leecher 50 has obtained an encrypted piece or a sub-piece, the leecher 50 transmits a message to the seeder 52 to inform the seeder 52 of the obtainment. Yet another arrangement is acceptable in which, as information for identifying the encrypted piece or the sub-piece, the message contains a set (i,j) made up of the specified piece index and the specified variation index as well as information specifying the sub-piece and/or a hash value. Yet another arrangement is acceptable in which, when the leecher 50 has completed an encrypted piece by using the obtained sub-pieces, the leecher 50 transmits a message to the seeder 52 to inform the seeder 52 of the completion. Yet another arrangement is acceptable in which, as the information for identifying the encrypted piece, the message contains a set (i,j) made up of the specified piece index and the specified variation index and/or a hash value.

In the fifth embodiment described above, another arrangement is acceptable in which the partial data request further contains flag information indicating that this request is a partial data request. Yet another arrangement is acceptable in which one partial data request requests a plurality of sub-pieces. In that situation, yet another arrangement is acceptable in which the partial data request indicates, for each of the plurality of sub-pieces, a set (i,j) made up of a specified piece index and a specified variation index as well as information specifying the sub-piece. The plurality of sub-pieces requested in one partial data request may be sub-pieces that are to be serially arranged in one encrypted piece or may be sub-pieces that are not to be serially arranged in one encrypted piece. Further, it is also acceptable if the sub-pieces are such sub-pieces that are respectively a part of mutually different encrypted pieces that are decrypted to become mutually different pieces. On the other hand, yet another arrangement is acceptable in which the seeder 52 transmits, to the leecher 50, at least one of the plurality of sub-pieces that are requested in a partial data request.

Further, yet another arrangement is acceptable in which, to specify an encrypted piece that has partially been obtained, the partial data request indicates at least a specified piece index j, instead of the set (i,j) made up of the specified piece index and the specified variation index. In that situation, yet another arrangement is acceptable in which, when the seeder 52 has received such a partial data request, the seeder 52 inquires of the leecher 50 about the specified variation index that specifies the encrypted piece that has partially been obtained and information specifying the sub-piece and obtains these types of information so that the seeder 52 is able to identify the sub-piece that is the target to be transmitted and to transmit the identified sub-piece to the leecher 50. With this arrangement, it is possible to improve the tolerance level of the seeder 52 against attacks.

Yet another arrangement is acceptable in which the partial data request indicates a hash value calculated through a hash calculation by using the encrypted piece that has partially been obtained, so that the encrypted piece that has partially been obtained and that is the target to be obtained is specified by the hash value. In that situation, the seeder 52 obtains, in advance, the Torrent File that contains the file information including the hash value of each of the encrypted pieces. Thus, by referring to the Torrent File, the seeder 52 is able to identify the encrypted piece that has partially been obtained and that has been specified by the hash value indicated in the partial data request.

In the fifth embodiment described above, another arrangement is acceptable in which each of the encrypted piece is configured in advance so as to be divided into a predetermined number of sub-pieces and a data number (hereinafter, the “sub-piece index”) is assigned to each of the sub-pieces in advance. In this configuration, it is acceptable to use the sub-piece index as the sub-piece specifying information contained in the partial data request. In that situation, the file information contained in the Torrent File is configured so as to indicate the total number of sub-pieces that constitute the encrypted piece. Further, another arrangement is acceptable in which the sub-piece completion judging unit 504 included in the leecher 50 performs the completion judging process by using the number of sub-pieces that have been obtained by the leecher 50 with respect to an encrypted piece and the number of sub-pieces indicated in the file information contained in the Torrent File with respect to the encrypted piece.

In the fifth embodiment described above, another arrangement is acceptable in which the Torrent File contains a hash value calculated by using each of the sub-pieces.

In the case where the file information contained in the Torrent File includes a hash value calculated through a hash calculation process by using each of the encrypted pieces, another arrangement is acceptable in which the sub-piece completion judging unit 504 included in the leecher 50 performs the completion judging process in the following manner: With regard to the encrypted piece that is the target of the judging process, the sub-piece completion judging unit 504 calculates a hash value of the sub-pieces that have been put together, and if the calculated hash value and the hash value of the encrypted piece contained in the Torrent File match, the sub-piece completion judging unit 504 judges that the entirety of the data of the encrypted piece has been obtained.

In the fifth embodiment described above, another arrangement is acceptable in which, when transmitting the partial data request to the seeder 52, the content obtaining unit 500 included in the leecher 50 transmits, to the seeder 52, the leecher identification information for identifying the leecher 50, so that the seeder 52 is able to identify the leecher 50.

In the fifth embodiment described above, in the case where the result of the judging process at Step S318 is in the negative, another arrangement is acceptable in which, the leecher 50 transmits the partial data request for requesting the unobtained sub-piece to another seeder 52 storing therein the encrypted piece, instead of transmitting the partial data request to the seeder 52 that has previously transmitted one or more of the sub-pieces.

Further, in the case where the leecher 50 is not able to receive the unobtained sub-piece that partially constitutes the encrypted piece from the seeder 52 that has previously transmitted one or more of the sub-pieces that constitute the encrypted piece, another arrangement is acceptable in which the leecher 50 transmits the partial data request to the seeder 52 after a predetermined period of time has elapsed. Yet another arrangement is acceptable in which the leecher 50 transmits the partial data request to another seeder 52, or transmits a piece request that is different from the partial data request to the seeder 52 or another seeder 52.

In other words, in the explanation above, in the case where it has been judged that the entirety of the data of the encrypted piece that is the target of the judging process has not been obtained, the leecher 50 repeatedly performs the process of obtaining, from the seeder 52, one of the unobtained sub-pieces among the sub-pieces that constitute the encrypted piece, until all the sub-pieces that constitute the encrypted piece have been obtained; however, it is acceptable to configure the leecher 50 so as not to perform this process.

In addition, in the case where it has been judged that the entirety of the data of the encrypted piece that is the target of the judging process has not been obtained, another arrangement is acceptable in which the leecher 50 does not attempt to obtain the unobtained sub-pieces, but discards the obtained sub-pieces for the encrypted piece, so that the leecher 50 starts the process all over again to obtain the encrypted piece, with respect to the piece obtained by decrypting the encrypted piece.

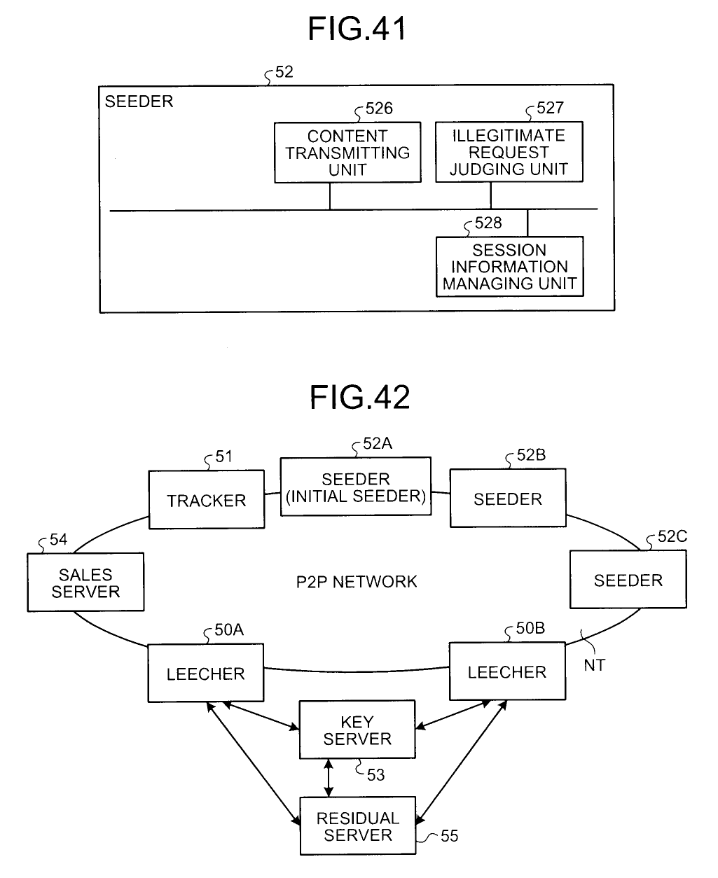

At Step S313 described above, another arrangement is acceptable in which the seeder 52 judges whether the piece request transmitted from the leecher 50 is illegitimate so that the seeder 52 is able to reject the transmission of the encrypted piece of the sub-piece according to the result of the judging process. FIG. 41 is an exemplary functional diagram of the seeder 52 according to the present modification example. The seeder 52 includes a content transmitting unit 526, an illegitimate request judging unit 527, and a session information managing unit 528. When the leecher 50 has accessed the seeder 52, the content transmitting unit 526 transmits piece information to the leecher 50. The content transmitting unit 526 also receives a piece request from the leecher 50 and transmits an encrypted piece or a sub-piece to the leecher 50 according to the piece request and the result of the judging process performed by the illegitimate request judging unit 527.

The session information managing unit 528 stores therein session information used for managing a session related to the transmission of an encrypted piece or a sub-piece. The session information is stored in correspondence with the leecher identification information used for identifying the leecher 50 to which the encrypted piece or the sub-piece is to be transmitted. The session information contains the piece index and the variation index of the encrypted piece or the encrypted piece that is partially constituted with the sub-piece as well as the amount of transmitted data. When the content transmitting unit 526 receives a piece request from the leecher 50, the content transmitting unit 526 also receives the leecher identification information. The obtained amount indicates the amount of data of the encrypted piece that has already been obtained. The obtained amount may be, for example, a data length calculated from the head position of the data and the ending position of the obtained partial data within the encrypted piece, a total of the data lengths of the sub-pieces that have already been obtained among the sub-pieces that constitute the encrypted piece, or the number of sub-pieces that have already been obtained.

The illegitimate request judging unit 527 judges whether the piece request received by the content transmitting unit 526 from the leecher 50 is illegitimate. In the present example, the starting position of the data and the data length are used as the sub-piece specifying information indicated in the partial data request, which is a type of piece request. In addition, a starting position (hereinafter, the “judging position”) that can be specified only if a predetermined condition is satisfied is determined in advance as a predetermined value. The predetermined condition is, for example, that it has been confirmed that one leecher 50 is not attempting to collect more encrypted pieces than a predetermined number, the encrypted pieces each being obtained by encrypting mutually the same piece, or that it has been confirmed that one leecher 50 is not attempting to collect more of the same encrypted piece than a predetermined number, or that both of these have been confirmed. It is possible to judge whether such a predetermined condition is satisfied by referring to the session information described above. It is possible to judge whether one leecher 50 (i.e., the same one) is attempting to collect the encrypted pieces by judging whether the leecher identification information received from the leecher 50 is the same as the leecher identification information indicated in the session information. It is possible to judge whether the encrypted pieces are each obtained by encrypting mutually the same piece by judging whether the piece index specified in the piece request received from the leecher 50 is the same as the piece index indicated in the session information.

In the case where the predetermined condition is satisfied, the illegitimate request judging unit 527 judges that the piece request received by the content transmitting unit 526 from the leecher 50 is not illegitimate. On the contrary, in the case where the predetermined condition is not satisfied, the illegitimate request judging unit 527 judges whether the piece request is illegitimate by judging whether the starting position indicated in the partial data request that has been received, as a piece request, by the content transmitting unit 526 from the leecher 50 is the same as the judging position. For example, the head position (e.g., “0”) of the data of the encrypted piece is used as the judging position. In this situation, it is judged whether the starting position indicated in the partial data request is the head position (i.e., “0”). In the case where the result of the judging process is in the affirmative, it means that the leecher 50 is requesting the data from the head position of the data of the encrypted piece by transmitting the partial data request, unlike the example explained in the first embodiment where the leecher 50 transmits the piece request when none of the data has been obtained yet. Thus, this action is judged to be illegitimate.

In the configuration described above, in the case where the illegitimate request judging unit 527 has judged that the piece request is illegitimate, the content transmitting unit 526 rejects the piece request that is requesting the transmission of the encrypted piece or the sub-piece and will not transmit the encrypted piece or the sub-piece to the leecher 50. In that situation, the content transmitting unit 526 may or may not transmit, to the leecher 50, a message indicating that the request for requesting the transmission of the encrypted piece or the sub-piece has been rejected. On the contrary, in the case where the illegitimate request judging unit 527 has judged that the piece request is not illegitimate, the content transmitting unit 526 transmits the encrypted piece or the sub-piece requested in the piece request to the leecher 50.

On the other hand, every time the leecher 50 transmits a piece request to the seeder 52, the leecher 50 transmits the leecher identification information thereof to the seeder 52. In the case where the seeder 52 has judged that the transmitted piece request is illegitimate or where some failure has occurred, the leecher 50 is not able to receive the encrypted piece or the sub-piece from the seeder 52. In that situation, an arrangement is acceptable in which the leecher 50 starts the process all over again from any of the steps before Step S315 in FIG. 40. Another arrangement is acceptable in which the leecher 50 judges that it is not possible to receive the encrypted piece from the seeder 52, for example, if the number of times the leecher's attempt to obtain the encrypted piece failed has exceeded a predetermined value or if the period of time that has elapsed since the leecher 50 started the process to obtain the encrypted piece has exceeded a predetermined length. Yet another arrangement is acceptable in which the seeder 52 transmits a rejection message to the leecher 50 to indicate that the request has been judged to be illegitimate or that some failure has occurred. It is acceptable for the leecher 50 to judge that it is not possible to receive the encrypted piece from the seeder 52 when having received such a rejection message. In the case where the leecher 50 has judged that it is not possible to receive the encrypted piece from the seeder 52, the leecher 50 connects to another seeder 52 and attempts to obtain the encrypted piece.

Further, yet another arrangement is acceptable in which the seeder 52 suspends the piece request from the leecher 50, without transmitting the rejection message to the leecher 50. In that situation, an arrangement is acceptable in which the seeder 52 transmits the rejection message to the leecher 50 after a predetermined period has elapsed or the seeder 52 forces the connection with the leecher 50 to be terminated.

As long as the illegitimate request judging unit 527 is able to judge that a piece request in which an attacking intention of the leecher 50 is suspected is illegitimate, any other processes besides the examples described above are acceptable. The judging position is not limited to the one described above, either. It is also acceptable to judge whether a piece request is illegitimate by judging whether the starting position is before or after the judging position, instead of judging whether the starting position is the same as the judging position.

In the case where the sub-piece index as explained in one of the modification examples of the fifth embodiment is used, it is acceptable to use a value of the sub-piece index as a judging index, instead of the judging position. For example, it is acceptable to configure the value of the sub-piece index of the sub-piece positioned at the head of an encrypted piece so as to be used as the judging index (i.e., the predetermined value). It is also acceptable if the judging position and the judging index are each a variable value, instead of a predetermined value.

Next, a sixth embodiment of the content distribution system according to the present invention will be explained. Parts of the sixth embodiment that are the same as any of the first through the fifth embodiments will be explained by using the same reference characters or will be omitted from the explanation.

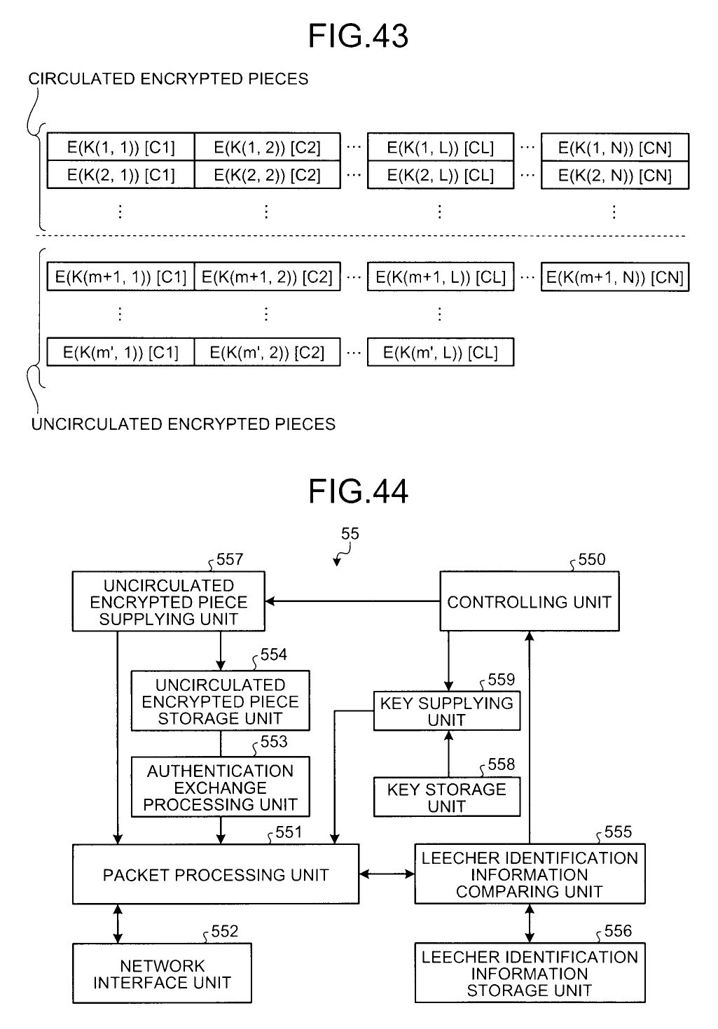

FIG. 42 is a diagram of the content distribution system according to the sixth embodiment. The configuration of the content distribution system according to the sixth embodiment is different from the configurations of the content distribution systems according to the first through the fifth embodiment in the following: The content distribution system according to the sixth embodiment further includes a residual server 55 that is connected to the leecher 50 and to the key server 53. The residual server 55 stores therein encrypted pieces (hereinafter, the “uncirculated encrypted pieces”) that are separately provided as encrypted pieces each of which is to be transmitted in correspondence with the leecher 50. The uncirculated encrypted pieces are obtained by encrypting pieces C1 to CL (where 1<L≦N) among the pieces C1 to CN that constitute the content. It should be noted, however, that the uncirculated encrypted pieces are encrypted pieces obtained by encrypting the pieces C1 to CL with encryption keys that are different from the encryption keys used for encrypting the encrypted pieces (hereinafter, the “circulated encrypted pieces”) that have been stored, after being encrypted, in at least the initial seeder 52A and are transmitted and received via the P2P network NT. FIG. 43 is a drawing of an example of the circulated encrypted pieces and the uncirculated encrypted pieces. In FIG. 43, the encrypted pieces E(K(i,j))[Cj] corresponding to i and j that satisfy “1≦i≦m and 1≦j≦N” are the circulated encrypted pieces, whereas the encrypted pieces E(K(i,j))[Cj] corresponding to i and j that satisfy “m+1≦i≦m′ and 1≦j≦L” are the uncirculated encrypted pieces. The number of circulated encrypted pieces and the number of uncirculated encrypted pieces are not limited to the examples shown in FIG. 43. The file information contained in the Torrent File according to the sixth embodiment includes information indicating what pieces are the circulated encrypted pieces, but does not include information indicating what pieces are the uncirculated encrypted pieces.

In this configuration described above, the leecher 50 transmits a piece request (hereinafter, the “special piece request) to the residual server 55 to request an uncirculated encrypted piece. In this situation, the leecher 50 puts the leecher identification information for identifying the leecher 50 into the special piece request and transmits the special piece request. In this situation, it is assumed that the piece index j of the uncirculated encrypted piece requested by the leecher 50 is specified in advance as an initial value for each of the leechers 50. It is acceptable if the initial value is randomly selected from the values of j that satisfy 1≦j≦L. An arrangement is acceptable in which the initial value of the piece index j is specified in advance in the program executed by the leecher 50, or notified by another node to the leecher 50, or determined by the leecher 50 in advance. When the leecher 50 has received the uncirculated encrypted piece E(K(i,j))[Cj] from the residual server 55, the leecher 50 transmits a request message to the residual server 55 to request the decryption key for decrypting the uncirculated encrypted piece.

The hardware configuration of the residual server 55 is substantially the same as the hardware configuration of each of the apparatuses such as the leechers 50 explained in the description of the first embodiment. Next, various types of functions that are realized in the hardware configuration described above when the CPU of the residual server 55 executes the various types of programs stored in the storage devices or the external storage devices will be explained. FIG. 44 is an exemplary functional diagram of the residual server 55. The residual server 55 includes a controlling unit 550, a packet processing unit 551, a network interface unit 552, an authentication exchange processing unit 553, an uncirculated encrypted piece storage unit 554, a leecher identification information storage unit 556, a leecher identification information comparing unit 555, an uncirculated encrypted piece supplying unit 557, a key storage unit 558, and a key supplying unit 559.

The controlling unit 550 controls the entirety of the residual server 55 and also intermediates instructions from the leecher identification information comparing unit 555 to the key supplying unit 559. The packet processing unit 551 packetizes various types of data to be transmitted to external apparatuses such as the leecher 50 and forwards the packet to the network interface unit 552. The packet processing unit 551 also obtains data, based on packets forwarded from the network interface unit 552. The network interface unit 552 controls communication with external apparatuses, transmits the packetized data forwarded from the packet processing unit 551 to the external apparatuses, and forwards the packets received from the external apparatuses to the packet processing unit 551.

The uncirculated encrypted piece storage unit 554 stores therein the uncirculated encrypted pieces. The leecher identification information storage unit 556 stores therein leecher identification information of the leechers 50 to which the residual server 55 transmitted uncirculated encrypted pieces in the past. The leecher identification information comparing unit 555 judges whether the leecher identification information storage unit 556 stores therein leecher identification information transmitted from the leecher 50 and determines whether the uncirculated encrypted piece should be transmitted according to the result of the judging process. According to the result of the determining process performed by the leecher identification information comparing unit 555, when the uncirculated encrypted piece supplying unit 557 is instructed, via the controlling unit 550, to transmit the uncirculated encrypted piece that is the target to be transmitted, the uncirculated encrypted piece supplying unit 557 reads the uncirculated encrypted piece from the uncirculated encrypted piece storage unit 554 and transmits the read uncirculated encrypted piece to the leecher 50.

The authentication exchange processing unit 553 receives the special piece request from the leecher 50 via the network interface unit 552 and performs a mutual authentication process with the leecher 50. After the authentication process has been performed, the authentication exchange processing unit 553 transmits an acceptance message to leecher 50 to indicate that the request has been accepted. The key storage unit 558 is provided in, for example, an external storage device such as an HDD and stores therein the decryption keys used for decrypting the uncirculated encrypted pieces, respectively. As explained above, each of the decryption keys is expressed as, for example, K(i,j) (where m+1≦i≦m′ and 1≦j≦L are satisfied). The key supplying unit 559 receives the request message for requesting the decryption key for decrypting the uncirculated encrypted piece, reads the decryption key from the key storage unit 558 in response to the request message, and transmits the read decryption key to the leecher 50 via the network interface unit 552.

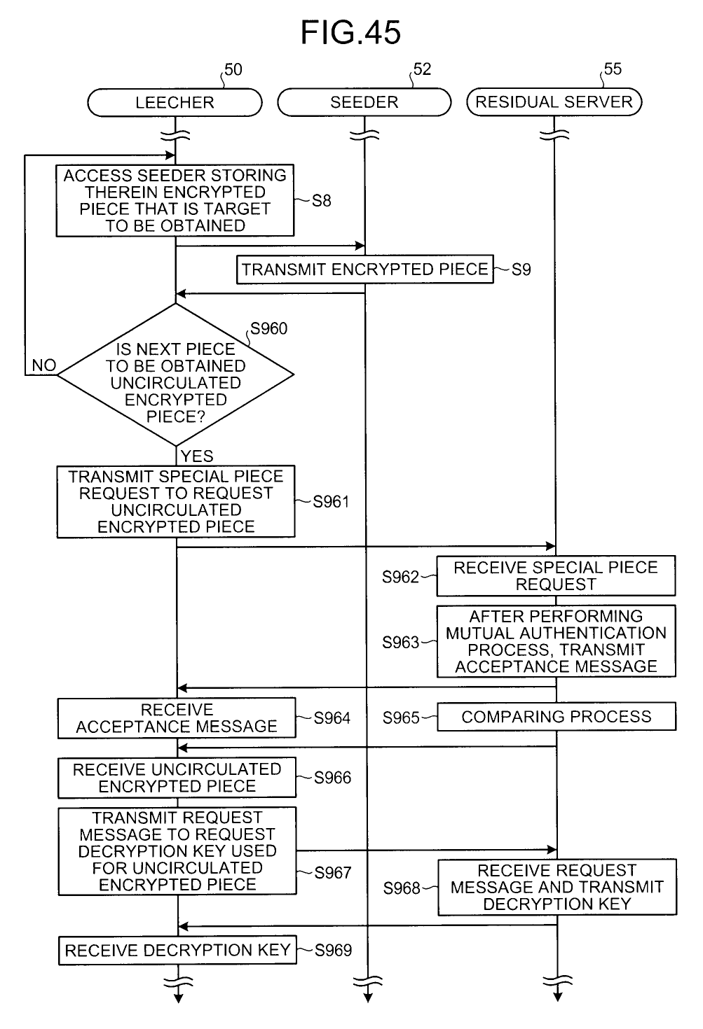

Next, a procedure in a content distributing process performed in the content distribution system according to the sixth embodiment will be explained, with reference to FIG. 45. The processes performed at Steps S1 through S7 are the same as those according to the first embodiment and are therefore omitted from the drawing. The processes performed at Steps S8 through S9 are also the same as those in the first embodiment. After the process at Step S9 has been performed, when the leecher 50 has received a circulated encrypted piece from the seeder 52, the leecher 50 judges, at Step S960, whether the next piece to be obtained is an uncirculated encrypted piece. In the case where the leecher 50 has obtained the circulated encrypted pieces corresponding to the pieces among the pieces C1 to CN other than the piece identified with the piece index j that is specified in advance for the uncirculated encrypted piece, the result of the judging process is in the affirmative. In that situation, at Step S961, the leecher 50 transmits a special piece request to the residual server 55, the special piece request containing the leecher identification information for identifying the leecher 50 and requesting the uncirculated encrypted piece. On the contrary, in the case where the result of the judging process at Step S960 is in the negative, the process returns to Step S8, and the leecher 50 accesses the seeder 52 and attempts to obtain a circulated encrypted piece obtained by encrypting a piece among the pieces C1 to CN that has not yet been obtained.

On the other hand, when the residual server 55 has received the special piece request (Step S962), the residual server 55 performs a mutual authentication process with the leecher 50. After the mutual authentication process has been performed, the residual server 55 transmits an acceptance message to the leecher 50 to indicate that the special piece request has been accepted (Step S963). When the leecher 50 has received the acceptance message from the residual server 55 (Step S964), the leecher 50 waits for the transmission of the uncirculated encrypted piece from the residual server 55. At Step S965, the residual server 55 performs a comparing process described below with regard to the special piece request.

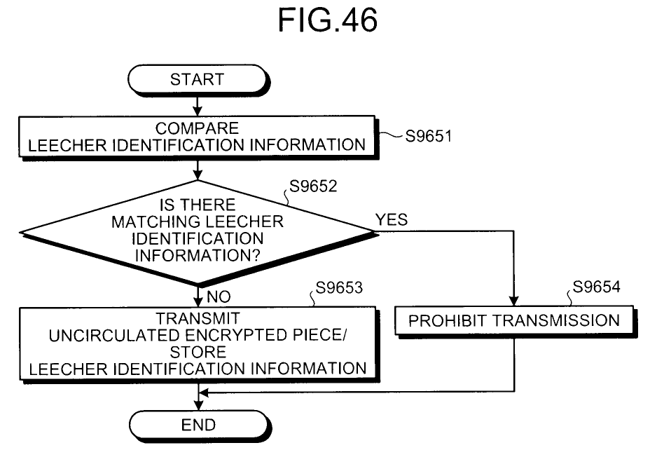

FIG. 46 is a flowchart of a procedure in the comparing process performed by the residual server 55 according to the sixth embodiment. The leecher identification information comparing unit 555 included in the residual server 55 compares the leecher identification information contained in the piece request with the leecher identification information stored in the leecher identification information storage unit 556 (Step S9651) and judges whether the leecher identification information storage unit 556 has already stored therein the same leecher identification (Step S9652). In the case where the leecher identification information comparing unit 555 has judged that the leecher identification information storage unit 556 does not store therein the same leecher identification information, the leecher identification information comparing unit 555 determines that the uncirculated encrypted piece E(K(i,j))[Cj] corresponding to the piece index j that has been specified in advance should be transmitted. After that, the leecher identification information comparing unit 555 instructs, via the controlling unit 550, the uncirculated encrypted piece supplying unit 557 to transmit the uncirculated encrypted piece to the leecher 50. Also, the leecher identification information comparing unit 555 stores the leecher identification information into the leecher identification information storage unit 556. The uncirculated encrypted piece supplying unit 557 reads the uncirculated encrypted piece of which the transmission has been instructed by the leecher identification information comparing unit 555 via the controlling unit 550, out of the uncirculated encrypted piece storage unit 554 and transmits the read uncirculated encrypted piece to the leecher 50 via the network interface unit 552 (Step S9653). In the case where there are a plurality of uncirculated encrypted pieces E(K(i,j))[Cj] corresponding to the piece index j that has been specified in advance for the leecher 50, in other words, in the case where there are two or more variation indexes i, the residual server 55 selects an arbitrary value as the variation index i and determines the uncirculated encrypted piece that is the target to be transmitted.

On the other hand, in the case where the leecher identification information comparing unit 555 has judged at Step S9652 that the leecher identification information storage unit 556 stores therein the same leecher identification information, in other words, in the case where the residual server 55 transmitted the uncirculated encrypted piece to the leecher 50 in the past, the leecher identification information comparing unit 555 determines that the uncirculated encrypted piece should not be transmitted and instructs, via the controlling unit 550, the uncirculated encrypted piece supplying unit 557 that the transmission of the uncirculated encrypted piece to the leecher 50 is prohibited (Step S9654).

The following explanation is based on an assumption that the uncirculated encrypted piece has been transmitted at Step S9653. Returning to the description of FIG. 45, in that situation, when the leecher 50 has received the uncirculated encrypted piece (Step S966), the leecher 50 transmits a request message to the residual server 55 to request the decryption key for decrypting the uncirculated encrypted piece (Step S967). When the residual server 55 has received the request message, the residual server 55 reads the decryption key from an external storage device and transmits the read decryption key to the leecher 50, in response to the request message (Step S968). The leecher 50 then receives the decryption key from the residual server 55 (Step S969). The procedure in the processes thereafter is omitted from the drawing. At Step S10 shown in FIG. 12, the leecher 50 transmits a request message to the key server 53 to request the key ring containing the decryption keys used for decrypting the circulated encrypted pieces that have been obtained by the leecher 50. After that, the processes at Steps S11 through S16 shown in FIG. 12 are performed in the content distribution system, in the same manner as described in the first embodiment.

In the configuration described above, it is possible to keep secret which one among the pieces C1 to CN is obtained by decrypting the uncirculated encrypted piece. Thus, it is possible to inhibit such an attack where the piece obtained by decrypting the uncirculated encrypted piece and the decryption keys used for decrypting the circulated encrypted pieces obtained by encrypting the other pieces are disclosed so that the content is illegitimately used.

In the sixth embodiment described above, the piece index j of the uncirculated encrypted piece E(K(i,j))[Cj] (where “m+1≦i≦m′ and 1≦j≦L are satisfied) requested by the leecher 50 in the special piece request is specified in advance; however, the piece index j does not necessarily have to be specified in advance. In that situation, an arrangement is acceptable in which the special piece request contains information that specifies the piece index of the uncirculated encrypted piece that is the target to be obtained, or the special piece request contains sequence information indicating the sequence of the indexes of the circulated encrypted pieces that have already been obtained.

In the case where the special piece request is configured so as to contain the sequence information, another arrangement is acceptable in which the residual server 55 stores the set made up of the leecher identification information and the sequence information contained in the special piece request into the leecher identification information storage unit 556 so that the comparing process is performed at Step S965 by using the set made up of the leecher identification information and the sequence information.

Further, it is acceptable if the subject that determines the piece index j of the uncirculated encrypted piece to be transmitted to the leecher 50 is the residual server 55, the key server 53, the seeder 52, or any other communication apparatus.

Furthermore, the piece index j of the uncirculated encrypted piece transmitted to the leecher 50 may have an arbitrary value or may have a value that is incremented according to the order in which special piece requests are received by the residual server 55. Also, in the case where a content index is assigned to the content, it is acceptable if the piece index j has a value that is calculated with a hash function by using a number of pieces of information such as the content index, the node information, and the leecher identification information. The subject that determines the piece index j of the uncirculated encrypted piece to be transmitted to the leecher 50 is able to determine the piece index j by obtaining such pieces of information from the leecher 50 in advance.

In terms of the timing, another arrangement is acceptable in which, after the special piece request has been transmitted from the leecher 50 to the residual server 55, it is determined which uncirculated encrypted piece is to be transmitted to the leecher 50.

It is acceptable for the leecher 50 to request a plurality of uncirculated encrypted pieces in the special piece request. Also, another arrangement is acceptable in which the number of uncirculated encrypted pieces that the leecher 50 is able to obtain is different for each of the leechers 50.

Yet another arrangement is acceptable in which the piece index j of the uncirculated encrypted piece obtained by leecher 50 is specified in such a manner that the piece index j is different for each of the leechers 50. In other words, it is acceptable for the residual server 55 to transmit the uncirculated encrypted pieces to the leechers 50, respectively, in such a manner that the piece obtained by decrypting the uncirculated encrypted piece is different for each of the leechers 50.

Further, yet another arrangement is acceptable in which the set made up of a piece index j and a variation index i of the uncirculated encrypted piece obtained by the leecher 50 is specified in such a manner that the set is different for each of the leechers 50. In other words, it is acceptable for the residual server 55 to transmit the uncirculated encrypted pieces to the leechers 50, respectively, in such a manner that the uncirculated encrypted piece is different for each of the leechers 50.

In the sixth embodiment described above, the residual server 55 arbitrarily determines the variation index i of the uncirculated encrypted piece E(K(i,j))[Cj] (where m+1≦i≦m′ and 1≦j≦L are satisfied) to be transmitted to the leecher 50; however, another arrangement is acceptable in which the variation index i has a fixed value or a value that is incremented according to the order in which special piece requests are received by the residual server 55. Also, in the case where a content index is assigned to the content, it is acceptable if the variation index i has a value that is calculated with a hash function by using a number of pieces of information such as the content index, the node information, and the leecher identification information. Further, it is acceptable if the value of the variation index of the uncirculated encrypted piece is determined either before or after the value of the piece index j of the uncirculated encrypted piece has been determined. Another arrangement is acceptable in which the variation index i of the uncirculated encrypted piece to be transmitted to the leecher 50 is determined in such a manner that the level of dispersion in the distribution of the number of the leechers 50 to which the uncirculated encrypted pieces are distributed becomes small.

In the sixth embodiment described above, the file information contained in the Torrent File obtained by the leecher 50 at Step S1 contains no information indicating what pieces are the uncirculated encrypted pieces. Thus, there is a possibility that the leecher 50 may obtain a circulated encrypted piece for each of the pieces C1 to CN. In that situation, an arrangement is acceptable in which, when the leecher 50 requests the circulated encrypted pieces from the seeder 52, the leecher 50 requests the encrypted pieces that correspond to the indexes other than the index that has been specified in advance as the piece index j of the uncirculated encrypted piece. Yet another arrangement is acceptable in which, if the leecher 50 has received, from the seeder 52, an encrypted piece that corresponds to the piece index j, the leecher 50 deletes the received encrypted piece.

At Step S9 shown in FIG. 45, when the seeder 52 transmits the encrypted piece to the leecher 50, another arrangement is acceptable in which the seeder 52 does not transmit, to the leecher 50, the circulated encrypted piece that is obtained by encrypting the piece corresponding to the index that has been specified in advance as the piece index of the uncirculated encrypted piece to be transmitted to the leechers 50.

In the sixth embodiment described above, in terms of the timing, the leecher 50 requests the uncirculated encrypted piece from the residual server 55 after the leecher 50 has obtained the circulated encrypted pieces for the pieces among the pieces C1 to CN other than the piece corresponding to the piece index j that has been specified in advance as the uncirculated encrypted piece; however, the present invention is not limited to this example. Another arrangement is acceptable in which the leecher 50 requests the uncirculated encrypted piece before the leecher 50 obtains the circulated encrypted pieces for the pieces C1 to CN respectively, or while the leecher 50 is obtaining the circulated encrypted pieces, or in parallel to the leecher 50's obtaining the circulated encrypted pieces.

In terms of the timing, it is acceptable for the leecher 50 to request the decryption key for decrypting the uncirculated encrypted piece from the residual server 55, after the leecher 50 has transmitted the request message to the key server 53 to request the key ring containing the decryption keys used for decrypting the circulated encrypted pieces obtained by the leecher 50 or in parallel to the leecher 50's transmitting the request message.

In the sixth embodiment described above, another arrangement is acceptable in which the request message transmitted by the leecher 50 to the residual server 55 to request the decryption key for decrypting the uncirculated encrypted piece contains at least one of the following, as the information for identifying the uncirculated encrypted piece for which the decryption key is to be used: the piece index and the variation index of the uncirculated encrypted piece; partial data of the uncirculated encrypted piece; a hash value of the partial data; a hash value of the uncirculated encrypted piece; and the identification information of the leecher 50. In this configuration, the residual server 55 reads, from the uncirculated encrypted piece storage unit 554, the decryption key for decrypting the uncirculated encrypted piece that is identified by using such contained information and transmits the read decryption key to the leecher 50.

In the sixth embodiment described above, the decryption key for decrypting the uncirculated encrypted piece is transmitted by the residual server 55; however, another arrangement is acceptable in which the key server 53 stores therein the decryption keys respectively used for decrypting the uncirculated encrypted pieces so that the leecher 50 requests, in the request message for requesting the key ring for the circulated encrypted pieces, the decryption key for decrypting the uncirculated encrypted piece that has been obtained by the leecher 50. In that situation, it is acceptable if the key server 53 is configured so as to transmit, in response to the request message, the decryption keys to the leecher 50, after the comparing process explained in the description of the first embodiment has been performed. Yet another arrangement is acceptable in which, instead of the key server 53, other communication apparatus stores therein the decryption keys used for decrypting the uncirculated encrypted pieces so that the other communication apparatus transmits the decryption keys to the leecher 50, in response to the request from the leecher 50.

In the sixth embodiment described above, the key storage unit 558 included in the residual server 55 stores therein the decryption key for decrypting the uncirculated encrypted piece; however, another arrangement is acceptable in which the residual server 55 does not include the key storage unit 558, and the uncirculated encrypted piece storage unit 554 stores therein the decryption key together with the uncirculated encrypted piece. At Step S9653, yet another arrangement is acceptable in which the uncirculated encrypted piece supplying unit 557 included in the residual server 55 reads the uncirculated encrypted piece of which the transmission has been instructed by the leecher identification information comparing unit 555 via the controlling unit 550 out of the uncirculated encrypted piece storage unit 554 and also reads the decryption key for decrypting the uncirculated encrypted piece, so that the uncirculated encrypted piece supplying unit 557 transmits the uncirculated encrypted piece and the decryption key to the leecher 50 via the network interface unit 552.

In the sixth embodiment described above, another arrangement is acceptable in which the residual server 55 further stores therein the circulated encrypted pieces, and the leecher 50 requests not only the uncirculated encrypted piece, but also the circulated encrypted pieces from the residual server 55. In that situation, in the case where the residual server 55 has judged at Step S9652 that the leecher identification information storage unit 556 does not store therein the same leecher identification information, the residual server 55 transmits, to the leecher 50, at least one of the uncirculated encrypted piece and the circulated encrypted piece that have been requested by the leecher 50.

In the first through the sixth embodiments described above, another arrangement is acceptable in which the key server 53 and the leecher 50 encrypt the data that is the target of the communication, after having performed the mutual authentication process. FIG. 28 is an exemplary diagram of a key server that is configured in this manner. The key server 53′ includes an encryption processing unit 538, in addition to the controlling unit 530, the packet processing unit 531, the network interface unit 532, the authentication and key exchange processing unit 533, the key storage unit 534, the sequence information storage unit 536, the sequence information comparing unit 535, and the key supplying unit 537 that are described above. The authentication and key exchange processing unit 533 performs the process to exchange an encryption key used for encrypting the data that is the target of the communication, with the leecher 50. The encryption processing unit 538 encrypts the data that is the target of the communication by using the encryption key exchanged by the authentication and key exchange processing unit 533 and transmits the encrypted data to the leecher 50 via the network interface unit 532.

In the first through the sixth embodiments described above, it is acceptable if the process of dividing the content into the pieces and the process of encrypting each of the pieces are performed by any of the tracker 51, the key server 53, and a server provided by the content creator. It is also assumed that the encrypted pieces are given to the seeder 52A (i.e., the initial seeder) by any of the tracker 51, the key server 53, and a reliable third party (e.g., a server provided by the content creator).

In the first through the sixth embodiments described above, an arrangement is acceptable in which the key server 53 itself issues and generates one or both of the encryption keys and the decryption keys. Yet another arrangement is acceptable in which the key server 53 obtains keys that have been issued or generated by the tracker 51 or a server provided by the content creator.

In the description above, each of all the pieces C1 to CN into which the content C has been divided is encrypted with a different one of the encryption keys; however, the present invention is not limited to this example. Another arrangement is acceptable in which two or more of the pieces are encrypted with mutually the same encryption key.

In the first through the sixth embodiments above, the number of trackers 51, the number of seeders 52, and the number of leechers 50 are not limited to the examples above.

In the description above, the sales server 54 is connected to the P2P network NT so that the leecher 50 obtains the Torrent File from the sales server 54; however, the sales server 54 does not necessarily have to be connected to the P2P network NT. Another arrangement is acceptable in which the leecher 50 obtains the Torrent File by, for example, reading the Torrent File recorded on a recording medium such as a CD-ROM.

Further, in the description above, the leecher 50 is connected to the key server 53 via the network; however, another arrangement is acceptable in which the leecher 50 is connected to the key server 53 via a dedicated line or via a proxy server, instead of via the network. With this arrangement, it is possible to enhance the management capability and to protect the key server, which is positioned at a stage subsequent to the proxy server, from a direct attack.

It is acceptable to combine a part or all of any of the first through the sixth embodiments. In the case where the second embodiment is combined with the third embodiment, it is a good idea to configure the seeder information, like the Torrent File, so as not to contain the information related to the specific encrypted piece stored in the key server 53.

In the first through the sixth embodiments described above, an arrangement is acceptable in which the program executed by the leecher 50 is stored in a computer connected to a network such as the Internet so that the program is provided as being downloaded via the network. Another arrangement is acceptable in which the various types of programs are provided as being recorded on a computer-readable recording medium such as a CD-ROM, a flexible disk (FD), a Compact Disk Recordable (CD-R), or a Digital Versatile Disk (DVD), in a file that is in an installable format or in an executable format. In that situation, the program is loaded into a main storage device (e.g., the RAM) when the leecher 50 reads and executes the program from the recording medium described above so that the constituent elements explained in the description of the functional configurations are generated in the main storage device. The same applies to the various types of programs implemented in the seeder 52, the various types of programs implemented in the key server 53, the various types of programs implemented in the tracker 51, and the various types of programs implemented in the residual server 55.

### OTHER MODES OF THE INVENTION 1

The communication apparatus according to claim 3, wherein the second receiving unit receives the either one of the first encrypted piece and the second encrypted piece for at least one of the pieces from among all of the first encrypted piece and the second encrypted piece indicated by the file information.

### OTHER MODES OF THE INVENTION 2

The communication apparatus according to claim 3 or 4, wherein

the second receiving unit includes:
a third receiving unit that accesses the other communication apparatus by using the received node information and receives, from the other communication apparatus, piece information that indicates one of (i) a correspondence relationship between the first encrypted piece stored in the other communication apparatus and the decryption key for decrypting the first encrypted piece and (ii) a correspondence relationship between the second encrypted piece stored in the other communication apparatus and the decryption key for decrypting the second encrypted piece; and
a fourth receiving unit that receives, from the other communication apparatus, the one of the first encrypted piece and the second encrypted piece, based on the file information, by using the received piece information.

### OTHER MODES OF THE INVENTION 3

The communication apparatus according to Other Modes of the Invention 2, wherein

the first receiving unit receives node information used for accessing a plurality of other communication apparatuses from the management server, and

in a case where the fourth receiving unit has failed to receive, by using the piece information, the one of the first encrypted piece and the second encrypted piece from the other communication apparatus, the third receiving unit accesses yet other communication apparatus by using the node information and receives the piece information from said yet other communication apparatus, and

the fourth receiving unit receives, from said yet other communication apparatus, the one of the first encrypted piece and the second encrypted piece, based on the file information, by using the piece information that has been received from said yet other communication apparatus.

### OTHER MODES OF THE INVENTION 4

The communication apparatus according to claim 7, wherein the content receiving unit includes a seventh receiving unit that receives, from the other communication apparatus, an arbitrary one of the first encrypted piece and the second encrypted piece that have been obtained by encrypting a piece other than the piece that has been encrypted so as to become the one of the first encrypted piece and the second encrypted piece specified in the received seeder information.

### OTHER MODES OF THE INVENTION 5

The communication apparatus according to claim 1, wherein

there are two or more second encrypted pieces, and the second encrypted pieces are generated by encrypting each of all the pieces with the second encryption key, and

the content receiving unit receives, for each of the pieces, one of the first encrypted piece and the second encrypted piece from the other communication apparatus.

### OTHER MODES OF THE INVENTION 6

The communication apparatus according to claim 1, wherein

the second encrypted piece is generated by encrypting one of the plurality of pieces with the second encryption key, and

the content receiving unit receives, for each of the pieces, one of the first encrypted piece and the second encrypted piece from the other communication apparatus.

### OTHER MODES OF THE INVENTION 7

The communication apparatus according to claim 5, wherein

the obtaining unit obtains, for each of the pieces, file information indicating one of (i) a correspondence relationship between a calculated value calculated through a predetermined calculation process by using the first encrypted piece and the decryption key for decrypting the first encrypted piece and (ii) a correspondence relationship between a calculated value calculated through a predetermined calculation process by using the second encrypted piece and the decryption key for decrypting the second encrypted piece,

the third receiving unit accesses the other communication apparatus and receives, from the other communication apparatus, piece information used for identifying the piece that corresponds to the one of the first encrypted piece and the second encrypted piece stored in the other communication apparatus,

the fourth receiving unit receives the one of the first encrypted piece and the second encrypted piece by using the received piece information,

the content receiving unit further includes a calculating unit that calculates a calculated value through the predetermined calculation process by using the received one of the first encrypted piece and the second encrypted piece, and

the key request transmitting unit transmits, to the key server, a request message for requesting the decryption key of which the correspondence relationship with the calculated value is indicated in the file information.

### OTHER MODES OF THE INVENTION 8

The communication apparatus according to claim 5, wherein

the obtaining unit obtains, for each of the pieces, file information indicating one of (i) a correspondence relationship between a calculated value calculated through a predetermined calculation process by using the first encrypted piece and the decryption key for decrypting the first encrypted piece and (ii) a correspondence relationship between a calculated value calculated through a predetermined calculation process by using the second encrypted piece and the decryption key for decrypting the second encrypted piece,

the third receiving unit accesses the other communication apparatus and receives, from the other communication apparatus, piece information used for identifying the piece that corresponds to the one of the first encrypted piece and the second encrypted piece stored in the other communication apparatus,

the fourth receiving unit receives, from the other communication apparatus, the one of the first encrypted piece and the second encrypted piece, based on the file information, by using the received piece information,

the content receiving unit further includes a calculated value receiving unit that receives, from the other communication apparatus, the calculated value calculated through the predetermined calculation process by using the one of the first encrypted piece and the second encrypted piece, and

the key request transmitting unit transmits, to the key server, a request message for requesting the decryption key of which the correspondence relationship with the calculated value is indicated in the file information.

### OTHER MODES OF THE INVENTION 9

The communication apparatus according to claim 5, wherein

the third receiving unit accesses the other communication apparatus and receives, from the other communication apparatus, piece information used for identifying the piece that corresponds to the one of the first encrypted piece and the second encrypted piece stored in the other communication apparatus,

the fourth receiving unit receives, from the other communication apparatus, the one of the first encrypted piece and the second encrypted piece, based on the file information, by using the received piece information,

the content receiving unit further includes a calculated value receiving unit that receives, from the other communication apparatus, the calculated value calculated through the predetermined calculation process by using the one of the first encrypted piece and the second encrypted piece, and

the key request transmitting unit transmits, to the key server, a request message for requesting the decryption key identified based on the calculated value.

### OTHER MODES OF THE INVENTION 10

The communication apparatus according to claim 12, further comprising a judging unit that judges, based on the data range specified in the partial data request, whether the partial data request is illegitimate, and

in a case where the partial data request has been judged to be illegitimate, the piece transmitting unit does not transmit, to the other communication apparatus, the data in the data range that has been specified in the partial data request.

### OTHER MODES OF THE INVENTION 11

The communication apparatus according to claim 13, wherein

the piece request transmitting unit transmits, to the communication server, the special piece request that is for requesting the one of the third encrypted piece obtained by encrypting the piece that has been assigned, in advance, to the communication apparatus and that contains the identification information.

### OTHER MODES OF THE INVENTION 12

The communication apparatus according to Other Modes of the Invention 10, wherein the content receiving unit receives, from the other communication apparatus, one of the first encrypted piece and the second encrypted piece for each of pieces among the pieces other than the piece that has been assigned, in advance, to the communication apparatus.

### OTHER MODES OF THE INVENTION 13

The communication apparatus according to claim 13, wherein

the piece request transmitting unit transmits, to the communication server, the special piece request that is for requesting one of the first encrypted piece, the second encrypted piece, and the third encrypted piece and that contains the identification information, and

the content receiving unit receives, from the other communication apparatus, the one of the first encrypted piece, the second encrypted piece, and the third encrypted piece that has been transmitted by the communication server in response to the special piece request.

### OTHER MODES OF THE INVENTION 14

The communication apparatus according to claim 13, further comprising:

a special key request transmitting unit that transmits, to the communication server, a special request message for requesting a decryption key for decrypting the received third encrypted piece; and

a special key receiving unit that receives, from the communication server, the decryption key that has been requested in the special request message.

### OTHER MODES OF THE INVENTION 15

The communication apparatus according to claim 15, further comprising a judging unit that judges, based on the data range specified in the partial data request, whether the partial data request is illegitimate, wherein

in a case where the partial data request has been judged to be illegitimate, the transmitting unit does not transmit, to the other communication apparatus, the data in the data range that has been specified in the partial data request.

### OTHER MODES OF THE INVENTION 16

The communication apparatus according to claim 15, wherein the partial data request specifies, as the data range, at least one of a starting position of the data, an ending position of the data, and a data length from the starting position of the data, within the one of the first encrypted piece and the second encrypted piece.

### OTHER MODES OF THE INVENTION 17

The communication apparatus according to claim 15, wherein

the one of the first encrypted piece and the second encrypted piece is configured so as to be divided into a predetermined number of sections of data, and a data number is assigned to each of the sections of data in advance, and

the partial data request specifies, as the data range, one or more of the data numbers assigned to the sections of data.

### OTHER MODES OF THE INVENTION 18

The communication apparatus according to claim 15, wherein the judging unit judges whether the partial data request is illegitimate by judging whether the data range specified in the partial data request is a predetermined value.

### OTHER MODES OF THE INVENTION 19

The communication apparatus according to claim 15, wherein

the one of the first encrypted piece and the second encrypted piece is kept in correspondence with a piece index used for identifying one of the pieces and a variation index used for identifying the one of the first encrypted piece and the second encrypted piece that corresponds to the piece, and

the request receiving unit receives the partial data request in which the piece index and the variation index are used to specify the one of the first encrypted piece and the second encrypted piece of which the part of the data is requested in the partial data request.

### OTHER MODES OF THE INVENTION 20

The communication apparatus according to claim 15, wherein the request receiving unit receives the partial data request in which a calculated value calculated through a predetermined calculation process by using the one of the first encrypted piece and the second encrypted piece is used for specifying the one of the first encrypted piece and the second encrypted piece of which the part of the data is requested in the partial data request.

### OTHER MODES OF THE INVENTION 21

The communication apparatus according to claim 16, further comprising a rejection transmitting unit that, in a case where the transmitting unit does not transmit the data requested in the first piece request, transmits a rejection message to the other communication apparatus.

### OTHER MODES OF THE INVENTION 22

The communication apparatus according to claim 14, wherein

in a case where the transmitting unit has received a first piece request but has not completed a transmission of a part or all of data requested in a second piece request that had been received before the first piece request was received, and an amount of data of which the transmission has not been completed is equal to or larger than a threshold value, the transmitting unit suspends a transmission of data requested in the first piece request, and

after the transmitting unit has transmitted a part or all of the data of which the transmission has not been completed in response to the second piece request, and the amount of the data of which the transmission has not been completed becomes smaller than the threshold value, the transmitting unit transmits a part or all of the data requested in the first piece request.

### OTHER MODES OF THE INVENTION 23

The key server according to claim 19, comprising a second storage unit stores therein pieces of sequence information each of which indicates a combination of the decryption keys, first identification information for identifying the communication apparatus, and number-of-times values each of which indicates how many times a corresponding one of the combinations of the decryption keys has been transmitted to the communication apparatus, while keeping these pieces of information in correspondence with one another, wherein

with respect to the decryption keys that have been requested in the request message, the receiving unit receives the index information and the first identification information for identifying the communication apparatus, from the communication apparatus, and

the determining unit determines that the decryption keys should be transmitted in a case where the second storage unit stores therein a piece of sequence information indicating a combination of the decryption keys that is same as the combination indicated in the index information, and also the number-of-times value stored in the second storage unit in correspondence with the piece of sequence information and the first identification information is equal to or smaller than a predetermined value.

### OTHER MODES OF THE INVENTION 24

The key server according to claim 20, further comprising a third storage unit that stores therein a specific encrypted piece obtained by encrypting a specific piece among the pieces, wherein

in the case where the determining unit has determined that the decryption keys should be transmitted, the key transmitting unit reads the specific encrypted piece from the third storage unit and transmits the read specific encrypted piece to the communication apparatus.

### OTHER MODES OF THE INVENTION 25

The key server according to OTHER MODES OF THE INVENTION 24, wherein in the case where the determining unit has determined that the decryption keys should be transmitted, the key transmitting unit reads, from the first storage unit, the decryption keys that are requested in the request message and each of which is used for decrypting the one of the encrypted piece and the second encrypted piece for a different one of the pieces and reads, from the first storage unit, the decryption key for decrypting one of specific encrypted pieces that is kept in correspondence with the communication apparatus, the specific encrypted pieces each having been obtained by encrypting a specific piece that constitutes a part of the content and is different from the pieces and having been kept into correspondence with the other communication apparatus and the communication apparatus, and the key transmitting unit transmits the read decryption keys to the communication apparatus.

### OTHER MODES OF THE INVENTION 26

The key server according to claim 17, further comprising a replacement identifying unit that, in a case where the determining unit has determined that the decryption keys should not be transmitted, identifies a combination of the decryption keys that is different from the combination indicated in pieces of sequence information stored in a second storage unit, wherein

in the case where the determining unit has determined that the decryption keys should not be transmitted, the key transmitting unit transmits the replacement index information that indicates the identified combination.

### OTHER MODES OF THE INVENTION 27

The key server according to claim 17, further comprising:

an obtaining unit that obtains, for each of the pieces, file information indicating one of (i) a correspondence relationship between a calculated value calculated through a predetermined calculation process by using the first encrypted piece and the decryption key for decrypting the first encrypted piece and (ii) a correspondence relationship between a calculated value calculated through a predetermined calculation process by using the second encrypted piece and the decryption key for decrypting the second encrypted piece, wherein

the receiving unit receives, from the communication apparatus, the request message that contains the calculated value calculated through the predetermined calculation process by using the one of the first encrypted piece and the second encrypted piece, and

the determining unit includes:
an identifying unit that identifies the decryption key of which the correspondence relationship with the calculated value contained in the request message is indicated in the file information; and
a first determining unit that determines whether the decryption keys should be transmitted, based on a combination of the decryption keys that includes the identified decryption key.

### OTHER MODES OF THE INVENTION 28

The communication server according to claim 26, further comprising:

a third storage unit that stores therein decryption keys used for decrypting the third encrypted pieces;

a second receiving unit that receives, from the communication apparatus, a request message for requesting one of the decryption keys; and

a second transmitting unit that transmits the one of the decryption keys requested in the request message to the communication apparatus.

### OTHER MODES OF THE INVENTION 29

A content distribution system in which a communication apparatus that receives a plurality of pieces that constitute a part of content, at least other communication apparatus, a management server that stores therein node information used for accessing the other communication apparatus, and a key server communicate with one another,

a plurality of first encrypted pieces are generated by encrypting the plurality of pieces each with a first encryption key,

one or more second encrypted pieces are generated by encrypting one or more of the plurality of pieces each with a second encryption key,

for each of the pieces, the first encryption key is different from the second encryption key,

the communication apparatus comprises:
an access information receiving unit that receives the access information from the management server;
a content receiving unit that accesses said at least other communication apparatus by using the received node information and receives, for each of the pieces, one of the first encrypted piece and the second encrypted piece from the other communication apparatus;
a first transmitting unit that transmits, to a key server storing therein decryption keys, a request message for requesting the decryption keys each of which is used for decrypting the one of the first encrypted piece and the second encrypted piece that has been received by the content receiving unit for a different one of the pieces; and
a key receiving unit that receives the decryption keys that have been provided by the key server in response to the request message, and

the key server comprises:
a receiving unit that receives the request message from the communication apparatus;
a first storage unit that stores therein the decryption keys;
a determining unit that determines whether the decryption keys should be transmitted, based on a combination of the decryption keys that has been requested in the request message; and
a key transmitting unit that, in a case where the determining unit has determined that the decryption keys should be transmitted, reads the decryption keys requested in the request message out of the first storage unit and transmits the read decryption keys to the communication apparatus.

### OTHER MODES OF THE INVENTION 30

A communication method implemented by a communication apparatus that comprises a content receiving unit, a transmitting unit, and a key receiving unit and that receives a plurality of pieces that constitute a part of content, wherein

a plurality of first encrypted pieces are generated by encrypting the plurality of pieces each with a first encryption key,

one or more second encrypted pieces are generated by encrypting one or more of the plurality of pieces each with a second encryption key,

for each of the pieces, the first encryption key is different from the second encryption key,

the content receiving unit receives, for each of the pieces, one of the first encrypted piece and the second encrypted piece from other communication apparatus, and

the transmitting unit transmits, to a key server storing therein decryption keys, a request message for requesting the decryption keys each of which is used for decrypting a corresponding one of the encrypted pieces, and

the key receiving unit receives the decryption keys that have been provided by the key server in response to the request message.

### OTHER MODES OF THE INVENTION 31

A communication method implemented by a key server that comprises a receiving unit, a determining unit, a key transmitting unit, and a storage unit storing therein decryption keys and that communicates with a communication apparatus that receives a plurality of pieces that constitute a part of content, wherein

a plurality of first encrypted pieces are generated by encrypting the plurality of pieces each with a first encryption key,

one or more second encrypted pieces are generated by encrypting one or more of the plurality of pieces each with a second encryption key,

for each of the pieces, the first encryption key is different from the second encryption key,

the communication apparatus receives, for each of the pieces, one of the first encrypted piece and the second encrypted piece from other communication apparatus,

the receiving unit receives, from the communication apparatus, a request message for requesting decryption keys each of which is used for decrypting the one of the first encrypted piece and the second encrypted piece for a different one of the pieces,

the determining unit determines whether the decryption keys should be transmitted, based on a combination of the decryption keys that has been requested in the request message, and

in a case where the determining unit has determined that the decryption keys should be transmitted, the key transmitting unit reads the decryption keys corresponding to the combination requested in the request message out of the storage unit and transmits the read decryption keys to the communication apparatus.

### OTHER MODES OF THE INVENTION 32

A communication method implemented by a management server that comprises a selecting unit, a transmitting unit, and a storage unit and that communicates with a communication apparatus that receives a plurality of pieces that constitute a part of content, wherein

a plurality of first encrypted pieces are generated by encrypting the plurality of pieces each with a first encryption key,

one or more second encrypted pieces are generated by encrypting one or more of the plurality of pieces each with a second encryption key,

for each of the pieces, the first encryption key is different from the second encryption key,

the communication apparatus receives, for each of the pieces, one of the first encrypted piece and the second encrypted piece from other communication apparatus,

the storage unit stores therein connection destination information used for accessing the other communication apparatus,

the selecting unit selects, for at least one of the pieces, the one of the first encrypted piece and the second encrypted piece that have been obtained by encrypting said at least one of the pieces, and

the transmitting unit reads the connection destination information used for accessing the other communication apparatus out of the storage unit and transmits, to the communication apparatus, the read connection destination information and seeder information specifying the one of the first encrypted piece and the second encrypted piece that has been selected.

### OTHER MODES OF THE INVENTION 33

A communication method implemented by a communication server that comprises a first storage unit, a second storage unit, a first receiving unit, and a first transmitting unit and that communicates with a communication apparatus that receives a plurality of pieces that constitute a part of content, wherein

a plurality of first encrypted pieces are generated by encrypting the plurality of pieces each with a first encryption key,

one or more second encrypted pieces are generated by encrypting one or more of the plurality of pieces each with a second encryption key,

one or more third encrypted pieces are generated by encrypting one or more of the plurality of pieces each with a third encryption key,

for each of the pieces, the first encryption key, the second encryption key, and the third encryption key are different from one another,

the communication apparatus receives, for each of the pieces, one of the first encrypted piece and the second encrypted piece from other communication apparatus,

the first storage unit stores therein the third encrypted pieces,

in a case where one of the third encrypted pieces has been transmitted to the communication apparatus, the second storage unit stores therein identification information for identifying the communication apparatus,

the first receiving unit receives, from the communication apparatus, a special piece request that is for requesting the one of the third encrypted pieces and contains the identification information for identifying the communication apparatus, and

in a case where the second storage unit does not store therein the identification information contained in the special piece request, the first transmitting unit reads the one of the third encrypted pieces from the first storage unit and transmits the read third encrypted piece to the communication apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus that receives a plurality of pieces constituting a part of content, the communication apparatus comprises:
a content receiving unit that receives either one of a first encrypted piece and a second encrypted piece for each of the pieces from other communication apparatus, a plurality of first encrypted pieces are encrypted the pieces with a first encryption key, the second encrypted piece is encrypted at least one of the pieces with a second encryption key, and the first encryption key and the second encryption key for encrypting a same piece are different from each other;
a key request transmitting unit that transmits a request message for requesting a decryption key for decrypting the either one of the first encrypted piece and the second encrypted piece to a key server; and
a key receiving unit that receives the decryption key from the key server in response to the request message.

2. The communication apparatus according to claim 1, further comprising an obtaining unit that obtains file information indicating all or a part of the either one of the first encrypted piece and the second encrypted piece for each of the pieces, wherein
the content receiving unit receives the either one of the first encrypted piece and the second encrypted piece from the other communication apparatus based on the file information.

3. The communication apparatus according to claim 2, wherein the content receiving unit includes
a first receiving unit that receives node information for accessing other communication apparatus that stores at least one of the first encrypted piece and the second encrypted piece from a management server, and
a second receiving unit that accesses the other communication apparatus by using the node information, and receives the either one of the first encrypted piece and the second encrypted piece from the other communication apparatus based on the file information.

4. The communication apparatus according to claim 3, wherein
the obtaining unit further obtains first access information used for accessing the management server, and
the first receiving unit accesses the management server by using the obtained first access information and receives the node information.

5. The communication apparatus according to claim 2, wherein the content receiving unit includes
a first receiving unit that receives piece information indicating either one of a correspondence relationship between the first encrypted piece and the decryption key for decrypting the first encrypted piece and a correspondence relationship between the second encrypted piece and the decryption key for decrypting the second encrypted piece from the other communication apparatus, and
a second receiving unit that receives the either one of the first encrypted piece and the second encrypted piece based on the file information by using the piece information.

6. The communication apparatus according to claim 1, wherein
the key request transmitting unit transmits index information indicating a combination of decryption keys respectively corresponding to the pieces and requested in the request message to the key server, and
the key receiving unit receives the decryption keys from the key server in response to the request message.

7. The communication apparatus according to claim 1, wherein the content receiving unit includes
a first receiving unit that receives seeder information specifying the either one of the first encrypted piece and the second encrypted piece from a management server, and
a second receiving unit that receives the either one of the first encrypted piece and the second encrypted piece by accessing other communication apparatus that stores the either one of the first encrypted piece and the second encrypted piece specified by the seeder information.

8. The communication apparatus according to claim 1, wherein
the content receiving unit receives a specific encrypted piece that is obtained by encrypting a specific piece, which constitutes a part of the content and is different from the pieces, from at least one of the key server, a management server, and other server,
the key request transmitting unit transmits a request message for requesting a decryption key for decrypting the specific encrypted piece to the key server, and
the key receiving unit receives the decryption key for decrypting the specific encrypted piece from the key server in response to the request message.

9. The communication apparatus according to claim 1, wherein
a specific encrypted piece is obtained by encrypting a specific piece, which constitutes a part of the content and is different from the pieces, being associated with other communication apparatus and the communication apparatus,
the content receiving unit receives the specific encrypted piece associated with the communication apparatus from at least one of other communication apparatus that stores the specific encrypted piece, the key server, a management server, and other server,
the key request transmitting unit transmits a request message for requesting a decryption key for decrypting the specific encrypted piece to the key server, and
the key receiving unit receives all or a part of decryption keys for decrypting the specific encrypted piece from the key server in response to the request message.

10. The communication apparatus according to claim 1, further comprising a decrypting unit that decrypts the either one of the first encrypted piece and the second encrypted piece by using the decryption key for each of the pieces.

11. The communication apparatus according to claim 5, wherein
in the decryption key, a piece index for identifying each of the pieces and a variation index for identifying the either one of the first encrypted piece and the second encrypted piece for each piece are associated with each other,
the obtaining unit obtains the file information indicating the piece index and the variation index for each of the pieces,
the first receiving unit accesses the other communication apparatus and receives the piece information indicating the piece index for identifying a piece corresponding to the either one of the first encrypted piece and the second encrypted piece from the other communication apparatus,
the second receiving unit receives the either one of the first encrypted piece and the second encrypted piece based on the file information by using the piece information from the other communication apparatus,
the content receiving unit further includes a variation receiving unit that receives variation index information indicating the variation index corresponding to the piece index of the either one of the first encrypted piece and the second encrypted piece from the other communication apparatus, and
the key request transmitting unit transmits the request message for requesting the decryption key identified by the piece index and the variation index to the key server.

12. The communication apparatus according to claim 1, further comprising:
a storage unit that stores therein the either one of the first encrypted piece and the second encrypted piece for each of the pieces;
a request receiving unit that receives a piece request for requesting all or a part of data of the either one of the first encrypted piece and the second encrypted piece from other communication apparatus; and
a piece transmitting unit that transmits the all or the part of the data requested in the piece request to the other communication apparatus, wherein
the request receiving unit receives a partial data request that specifies a data range of the part of the data as the piece request for requesting the part of the data, and
the piece transmitting unit transmits data in the data range specified in the partial data request to the other communication apparatus.

13. The communication apparatus according to claim 1, wherein
a third encrypted piece is generated by encrypting at least one of the pieces with a third encryption key,
the first encryption key, the second encryption key, and the third encryption key for encrypting a same piece are different from one another,
the communication apparatus further comprises a piece request transmitting unit that transmits a special piece request for requesting the third encrypted piece and containing identification information for identifying the communication apparatus to a communication server, and
the content receiving unit receives the third encrypted piece from the communication server in response to the special piece request.

14. A communication apparatus that receives a plurality of pieces constituting a part of content, the communication apparatus comprises:
a storage unit that stores therein either one of a first encrypted piece and a second encrypted piece for each of the pieces, a plurality of first encrypted pieces is generated by encrypting the pieces with a first encryption key, the second encrypted piece is generated by encrypting at least one of the pieces with a second encryption key and the first encryption key and the second encryption key for encrypting a same piece are different from each other;
a request receiving unit that receives a piece request for requesting all or a part of data of the either one of the first encrypted piece and the second encrypted piece from other communication apparatus; and
a transmitting unit that transmits the all or the part of the data requested in the piece request to the other communication apparatus.

15. The communication apparatus according to claim 14, wherein
the request receiving unit receives a partial data request that specifies a data range of the part of the data as the piece request for requesting the part of the data, and
the transmitting unit transmits data in the data range specified in the partial data request to the other communication apparatus.

16. The communication apparatus according to claim 14, wherein upon receiving a first piece request if a transmission of all or a part of data requested in a second piece request received before receiving the first piece request is not completed and an amount of untransmitted data is equal to or larger than a threshold, the transmitting unit does not transmit data requested in the first piece request.

17. A key server that communicates with a communication apparatus that receives a plurality of pieces constituting a part of content, the key server comprises:
a receiving unit that receives a request message for requesting a decryption key for decrypting the either one of a first encrypted piece and a second encrypted piece for each of the pieces from the communication apparatus, a plurality of first encrypted pieces is generated by encrypting the pieces with a first encryption key, a second encrypted piece is generated by encrypting at least one of the pieces with a second encryption key, the first encryption key and the second encryption key for encrypting a same piece are different from each other, and the communication apparatus receives either one of the first encrypted piece and the second encrypted piece from other communication apparatus for each of the pieces;
a first storage unit that stores therein the decryption key;
a determining unit that determines whether to transmit the decryption key based on a combination of decryption keys requested in the request message; and
a key transmitting unit that, when the determining unit determines to transmit the decryption key, reads decryption keys in the combination requested in the request message from the first storage unit, and transmits the decryption keys to the communication apparatus.

18. The key server according to claim 17, further comprising a second storage unit that stores therein sequence information indicating a combination of decryption keys transmitted for each of the pieces, wherein
the determining unit determines whether to transmit the decryption key based on whether the sequence information indicating the combination of the decryption keys requested in the request message is stored in the second storage unit.

19. The key server according to claim 17, wherein
the receiving unit receives index information indicating the combination of the decryption keys requested in the request message from the communication apparatus, and
the determining unit determines whether to transmit the decryption key based on the combination of the decryption keys indicated by the index information.

20. The key server according to claim 17, wherein when the determining unit determines to transmit the decryption key, the key transmitting unit reads the decryption key requested in the request message for decrypting the either one of the first encrypted piece and the second encrypted piece for each of the pieces and a decryption key for decrypting a specific encrypted piece obtained by encrypting a specific piece, which constitutes a part of the content and is different from the pieces, from the first storage unit, and transmits the decryption keys to the communication apparatus.

21. A management server that communicates with a communication apparatus that receives a plurality of pieces constituting a part of content, the management server comprises:
a first storage unit that stores therein connection destination information for accessing the other communication apparatus, the communication apparatus receives either one of a first encrypted piece and a second encrypted piece for each of the pieces from other communication apparatus, a plurality of first encrypted pieces is generated by encrypting the pieces with a first encryption key, a second encrypted piece is generated by encrypting at least one of the pieces with a second encryption key, and the first encryption key and the second encryption key for encrypting a same piece are different from each other;
a selecting unit that selects the either one of a first encrypted piece and a second encrypted piece obtained by encrypting at least one of the pieces; and
a transmitting unit that reads the connection destination information from the first storage unit, and transmits the connection destination information and seeder information specifying selected either one of the first encrypted piece and the second encrypted piece to the communication apparatus.

22. The management server according to claim 21, wherein the seeder information contains either one of index information indicating a correspondence relationship between a selected first encrypted piece and the decryption key for decrypting the first encrypted piece and index information indicating a correspondence relationship between a selected second encrypted piece and the decryption key for decrypting the second encrypted piece.

23. The management server according to claim 21, further comprising a second storage unit that stores therein information indicating whether the seeder information is transmitted to the communication apparatus for either one of a correspondence relationship between the first encrypted piece and the decryption key for decrypting the first encrypted piece and a correspondence relationship between the second encrypted piece and the decryption key for decrypting the second encrypted piece, wherein
the selecting unit selects the either one of the first encrypted piece and the second encrypted piece for which the information indicating that the seeder information is not transmitted to the communication apparatus is stored in the second storage unit.

24. The management server according to claim 21, further comprising an assigning unit that uniquely assigns a specific encrypted piece obtained by encrypting a specific piece, which constitutes a part of the content and is different from the pieces, to at least one of the other communication apparatus and the communication apparatus.

25. The management server according to claim 21, wherein
for the either one of the first encrypted piece and the second encrypted piece corresponding to each of the pieces, the first storage unit stores therein either one of a correspondence relationship between the first encrypted piece and the decryption key for decrypting the first encrypted piece in association with the connection destination information for accessing the other communication apparatus that stores therein the first encrypted piece and a correspondence relationship between the second encrypted piece and the decryption key for decrypting the second encrypted piece in association with the connection destination information for accessing the other communication apparatus that stores therein the second encrypted piece,
the selecting unit selects the either one of the first encrypted piece and the second encrypted piece that are obtained by encrypting at least one of the pieces, and identifies the other communication apparatus that stores therein selected either one of the first encrypted piece and the second encrypted piece by referring to the connection destination information stored in the first storage unit in correspondence with the selected either one of the first encrypted piece and the second encrypted piece, and
the transmitting unit puts the connection destination information of an identified other communication apparatus into the seeder information, and transmits the seeder information to the communication apparatus.

26. A communication apparatus that receives a plurality of pieces constituting a part of content, the communication server comprises:
a first storage unit that stores therein a third encrypted piece;
a second storage unit that, when the third encrypted piece is transmitted to the communication apparatus, stores therein identification information for identifying the communication apparatus;
a first receiving unit that receives a special piece request for requesting the third encrypted piece and contains the identification information for identifying the communication apparatus from the communication apparatus; and
a first transmitting unit that, when the identification information contained in the special piece request is not stored in the second storage unit, reads the third encrypted piece from the first storage unit, and transmits the third encrypted piece to the communication apparatus, wherein
a plurality of first encrypted pieces is generated by encrypting the pieces with a first encryption key, a second encrypted piece is generated by encrypting at least one of the pieces with a second encryption key, the third encrypted piece is generated by encrypting at least one of the pieces with a third encryption key, the first encryption key, the second encryption key, and the third encryption key for encrypting a same piece are different from one another, the communication apparatus receives either one of the first encrypted piece and the second encrypted piece from other communication apparatus for each of the pieces.

27. The communication server according to claim 26, wherein when the identification information contained in the special piece request is not stored in the second storage unit, the first transmitting unit reads the third encrypted piece from the first storage unit, and transmits the third encrypted piece to the communication apparatus such that a piece to be decrypted is different for each communication apparatus.

28. The communication server according to claim 26, wherein
the first storage unit further stores therein at least one of the first encrypted piece and the second encrypted piece,
the first receiving unit receives a piece request for requesting the first encrypted piece, the second encrypted piece, and the third encrypted piece and containing identification information for identifying the communication apparatus from the communication apparatus, and
when the identification information contained in the special piece request is not stored in the second storage unit, the first transmitting unit reads the first encrypted piece, the second encrypted piece, and the third encrypted piece requested in the special piece request from the first storage unit, and transmits the first transmitting unit reads the first encrypted piece, the second encrypted piece the communication apparatus.

29. A computer-readable recording medium that stores therein a computer program for a communication apparatus that receives a plurality of pieces constituting a part of content, the computer program when executed causes a computer to execute:
receiving either one of a first encrypted piece and a second encrypted piece from other communication apparatus for each of the pieces, a plurality of first encrypted pieces is generated by encrypting the pieces with a first encryption key, a second encrypted piece is generated by encrypting at least one of the pieces with a second encryption key, the first encryption key and the second encryption key for encrypting a same piece are different from each other;
transmitting a request message for requesting a decryption key for decrypting the either one of the first encrypted piece and the second encrypted piece to a key server; and
receiving the decryption key from the key server in response to the request message.
